(19) United States
(12) Patent Application Publication
(10) Pub. No.: US 2020/0234939 A1
(43) Pub. Date: Jul. 23, 2020

(54) MASS SPECTROMETER COMPONENTS INCLUDING PROGRAMMABLE ELEMENTS AND DEVICES AND SYSTEMS USING THEM

(71) Applicants: Tak Shun Cheung, Woodbridge (CA); Chui Ha Wong, Woodbridge (CA); William Fisher, Woodbridge (CA); Hamid Badiei, Woodbridge (CA)

(72) Inventors: Tak Shun Cheung, Woodbridge (CA); Chui Ha Wong, Woodbridge (CA); William Fisher, Woodbridge (CA); Hamid Badiei, Woodbridge (CA)

(21) Appl. No.: 16/711,674

(22) Filed: Dec. 12, 2019

Related U.S. Application Data
(60) Provisional application No. 62/779,419, filed on Dec. 13, 2018.

(51) Int. Cl. H01J 49/02; H01J 49/40; H01J 49/06

(52) U.S. Cl. CPC H01J 49/022; H01J 49/061; H01J 49/067; H01J 49/40

(57) ABSTRACT

Certain configurations of mass spectrometer components are described herein that comprise one or more mass spectrometer programmable elements. In some instances, the mass spectrometer programmable element can be configured as an electrode that can function independently of any underlying substrate or component. Ion guides, lenses, ion switches, mass analyzers and other components of a mass spectrometer are described which comprise one or more mass spectrometer programmable elements.

### PRIORITY APPLICATION

This application is related to, and claims priority to and the benefit of, U.S. Provisional Application No. 62/779,419 filed on Dec. 13, 2018, the entire disclosure of which is hereby incorporated herein by reference for all purposes.

### TECHNOLOGICAL FIELD

Certain embodiments described herein are directed to mass spectrometer programmable elements. More particularly, certain configurations described herein are directed to mass spectrometer components that can be individually programmed to provide a desired feature or result.

### BACKGROUND

Mass spectrometers can be used to analyze ions based on differences in mass-to-charge ratios for different ions. Mass spectrometers include various components that can perform different functions.

### SUMMARY

Certain aspects, features, embodiments and configurations are described in reference to mass spectrometer programmable elements (MSPE's). While the exact configuration of the mass spectrometer programmable element may vary, the mass spectrometer programmable element generally comprises at least one programmable element which can be controlled separately from, e.g., independently of, an underlying component or substrate to which the programmable element is coupled.

In one aspect, a mass spectrometer component comprises a substrate and at least one mass spectrometer programmable element, e.g., at least one programmable electrode, disposed on the substrate. In some examples, the at least one programmable electrode is electrically decoupled from the substrate. In some instances, the at least one programmable electrode is configured to provide an electric field within a space that is configured to receive an ion. In certain examples, the substrate of the mass spectrometer component is configured as a skimmer cone, and the skimmer cone comprises the at least one programmable electrode disposed on a surface of the skimmer cone. In other examples, the substrate of the mass spectrometer component is configured as a sampling cone, and the sampling cone comprises the at least one programmable electrode disposed on a surface of the sampling cone. In some embodiments, the substrate of the mass spectrometer component is configured as one ion pole of an ion deflector, and the one pole comprises the at least one programmable electrode disposed on a surface of the ion pole. In other examples, the substrate of the mass spectrometer component is configured as a lens, and the lens comprises the at least one programmable electrode disposed on a surface of the lens. In further examples, the substrate of a mass spectrometer component is configured as a rod of a collision-reaction cell, and the rod comprises the at least one programmable electrode disposed on a surface of the rod. In some configurations, the substrate of the mass spectrometer component is configured as a mass analyzer comprising at least one rod set, wherein one rod of the at least one rod set comprises the at least one programmable electrode disposed on a surface of the one rod. In other configurations, the substrate of the mass spectrometer component is configured as a lens of a time of flight analyzer, and the lens comprises the at least one programmable electrode disposed of a surface of the lens. In some embodiments, the substrate of the mass spectrometer component is configured as an ion trap, and the ion trap comprises the at least one programmable electrode disposed on a surface of the ion trap. In other embodiments, the substrate of the mass spectrometer component is configured as a planar ion guide comprising the at least one programmable electrode.

In certain examples, the substrate of the mass spectrometer component is configured as an induction device, and the induction device comprises the at least one programmable electrode disposed on a surface of the induction device. In other examples, the substrate of the mass spectrometer component is configured as a torch, and the torch comprises the at least one programmable electrode disposed on a surface of the torch.

In some examples, the substrate of the mass spectrometer component is configured as an injector, and the injector comprises the at least one programmable electrode disposed on an outer surface of the injector. In other embodiments, the substrate of the mass spectrometer component is configured as a nebulizer, and the nebulizer comprises the at least one programmable electrode disposed on a surface of the nebulizer. In certain embodiments, the substrate of the mass spectrometer component is configured as a spray chamber, and the spray chamber comprises the at least one programmable electrode disposed on a surface of the spray chamber.

In certain examples, the substrate of the mass spectrometer component is configured as a drift tube comprising the at least one programmable electrode disposed on a surface of a focusing ring of the drift tube.

In some examples, the mass spectrometer component further comprises an additional MSPE, e.g., an additional programmable electrode, disposed on the substrate and electrically decoupled from the substrate. In some configurations, the at least one programmable electrode and the additional programmable electrode are together configured to provide an electric field within the space that is configured to receive the ion.

In some examples where two or more MSPE's are present, the substrate of the mass spectrometer component is configured as a skimmer, and the skimmer cone comprises the at least one programmable electrode and the additional programmable electrode each disposed on a surface of the skimmer cone. In other examples where two or more MSPE's are present, the substrate of the mass spectrometer component is configured as a sampling cone, and the sampling cone comprises the at least one programmable electrode and the additional programmable electrode each disposed on a surface of the sampling cone. In additional examples where two or more MSPE's are present, the substrate of the mass spectrometer component is configured as one pole of an ion deflector, and the one pole comprises the at least one programmable electrode and the additional programmable electrode each disposed on a surface of the one pole. In certain embodiments where two or more MSPE's are present, the substrate of the mass spectrometer component is configured as a lens, and the lens comprises the at least one programmable electrode and the additional programmable electrode each disposed on a surface of the lens. In other embodiments where two or more MSPE's are present, the substrate of the mass spectrometer component is configured as one rod of a collision-reaction cell, and the one rod comprises the at least one programmable electrode and the additional programmable electrode each disposed on a surface of the one rod. In certain embodiments where two or more MSPE's are present, the substrate of the mass spectrometer component is configured as a mass analyzer comprising at least one rod set, wherein one rod of the at least one rod set comprises the at least one programmable electrode and the additional programmable electrode each disposed on a surface of the one rod. In some embodiments where two or more MSPE's are present, the substrate of the mass spectrometer component is configured as a lens of a time of flight analyzer, and the lens comprises the at least one programmable electrode and the additional programmable electrode each disposed on a surface of the lens. In other examples where two or more MSPE's are present, the substrate of the mass spectrometer component is configured as an ion trap, and the ion trap the at least one programmable electrode and the additional programmable electrode each disposed on a surface of the ion trap. In certain configurations where two or more MSPE's are present, the substrate of the mass spectrometer component is configured as a planar ion guide comprising the at least one programmable electrode and the additional programmable electrode.

In certain examples where two or more MSPE's are present, the substrate of the mass spectrometer component is configured as an induction device, and the induction device comprises the at least one programmable electrode and the additional programmable electrode each disposed on a surface of the induction device. In some examples where two or more MSPE's are present, the substrate of the mass spectrometer component is configured as a torch, and the torch comprises the at least one programmable electrode and the additional programmable electrode each disposed on a surface of the torch.

In other examples where two or more MSPE's are present, the substrate of the mass spectrometer component is configured as an injector, and the injector comprises the at least one programmable electrode and the additional programmable electrode each disposed on an outer surface of the injector. In certain configurations where two or more MSPE's are present, the substrate of the mass spectrometer component is configured as a nebulizer, and the nebulizer comprises the at least one programmable electrode and the additional programmable electrode each disposed on a surface of the nebulizer. In some configurations where two or more MSPE's are present, the substrate of the mass spectrometer component is configured as a spray chamber, and the spray chamber comprises the at least one programmable electrode and the additional programmable electrode each disposed on a surface of the spray chamber. In other configurations where two or more MSPE's are present, the substrate of the mass spectrometer component is configured as a drift tube comprising the at least one programmable electrode and the additional programmable electrode each disposed on a surface of a focusing ring of the drift tube.

In other instances, the mass spectrometer component may comprise a MSPE array, e.g., an electrode array comprising a plurality of separate and individually programmable electrodes, each disposed on the substrate. In some examples, the at least one programmable electrode is an electrode of the electrode array and is configured to provide the electric field within the space that is configured to receive the ion.

In some examples where an MSPE array is present, the substrate of the mass spectrometer component is configured as a skimmer cone, and the skimmer cone comprises at least one programmable electrode disposed on a surface of the skimmer cone. In other examples where an MSPE array is present, the substrate of the mass spectrometer component is configured as a sampling cone, and the sampling cone comprises the at least one programmable electrode disposed on a surface of the sampling cone. In further examples where an MSPE array is present, the substrate of the mass spectrometer component is configured as one ion pole of an ion deflector, and the one pole comprises the at least one programmable electrode disposed on a surface of the ion pole. In some examples where an MSPE array is present, the substrate of the mass spectrometer component is configured as a lens, and the lens comprises the at least one programmable electrode disposed on a surface of the lens. In other examples where an MSPE array is present, the substrate of a mass spectrometer component is configured as a rod of a collision-reaction cell, and the rod comprises the at least one programmable electrode disposed on a surface of the rod. In certain configurations where an MSPE array is present, the substrate of the mass spectrometer component is configured as a mass analyzer comprising at least one rod set, wherein one rod of the at least one rod set comprises the at least one programmable electrode disposed on a surface of the one rod. In some configurations where an MSPE array is present, the substrate of the mass spectrometer component is configured as a lens of a time of flight analyzer, and the lens comprises the at least one programmable electrode disposed of a surface of the lens. In other configurations where an MSPE array is present, the substrate of the mass spectrometer component is configured as an ion trap, and the ion trap comprises the at least one programmable electrode disposed on a surface of the ion trap. In certain examples where an MSPE array is present, the substrate of the mass spectrometer component is configured as a planar ion guide comprising the at least one programmable electrode.

In certain configurations where an MSPE array is present, the substrate of the mass spectrometer component is configured as an induction device, and the induction device comprises the at least one programmable electrode disposed on a surface of the induction device. In some configurations where an MSPE array is present, the substrate of the mass spectrometer component is configured as a torch, and the torch comprises the at least one programmable electrode disposed on a surface of the torch.

In additional configurations where an MSPE array is present, the substrate of the mass spectrometer component is configured as an injector and the injector comprises the at least one programmable electrode disposed on an outer surface of the injector. In certain examples where an MSPE array is present, the substrate of the mass spectrometer component is configured as a nebulizer, and the nebulizer comprises the at least one programmable electrode disposed on a surface of the nebulizer. In other examples where an MSPE array is present, the substrate of the mass spectrometer component is configured as a spray chamber, and the spray chamber comprises the at least one programmable electrode disposed on a surface of the spray chamber.

In some examples, the electrode array comprises a plurality of planar electrodes of about the same thickness.

In other examples, the electrode array comprises a plurality of electrodes arranged in layers of different heights with respect to a surface of the substrate.

In some embodiments, the electrode array comprises a plurality of electrodes arranged in circumferential rings around a surface of the substrate. In additional examples, the plurality of electrodes arranged in the circumferential rings comprise different sized electrodes. In some examples, the electrodes in a first circumferential ring are electrically coupled to each other through a resistor network.

In another aspect, a mass spectrometer component comprises a programmable substrate and at least one MSPE, e.g., at least one programmable electrode, disposed on the programmable substrate. In some examples, the at least one programmable electrode is electrically decoupled from the programmable substrate, and wherein the at least one programmable electrode is configured to provide an electric field within a space that is configured to receive an ion.

In certain examples, the programmable substrate is configured to provide a convex surface upon application of a voltage to the programmable substrate. In other examples, the programmable substrate is configured to provide a concave surface upon application of a voltage to the programmable substrate. In some examples, the programmable substrate is configured to provide a convex surface upon application of a magnetic field to the programmable substrate. In certain embodiments, the programmable substrate is configured to provide a concave surface upon application of a magnetic field to the programmable substrate. In some examples, the programmable substrate is configured to provide a convex surface upon application of heat to the programmable substrate. In other instances, the programmable substrate is configured to provide a concave surface upon application of heat to the programmable substrate. In some examples, the programmable substrate is configured to provide a convex surface upon application of pressure to the programmable substrate. In other examples, the programmable substrate is configured to provide a concave surface upon application of pressure to the programmable substrate.

In further examples, the programmable substrate comprises a shape-memory polymer or a shape-memory alloy. In some examples, the programmable substrate comprises a dielectric elastomer.

In some configurations, the programmable substrate of the mass spectrometer component is programmed as a skimmer cone, and the skimmer cone comprises at least one MSPE, e.g., at least one programmable electrode, disposed on a surface of the skimmer cone. In other configurations, the programmable substrate of the mass spectrometer component is programmed as a sampling cone, and the sampling cone comprises at least one MSPE, e.g., at least one programmable electrode, disposed on a surface of the sampling cone. In certain examples, the programmable substrate of the mass spectrometer component is programmed as one ion pole of an ion deflector, and the one pole comprises at least one MSPE, e.g., at least one programmable electrode, disposed on a surface of the ion pole. In some embodiments, the programmable substrate of the mass spectrometer component is programmed as a lens, and the lens comprises at least one MSPE, e.g., at least one programmable electrode disposed on a surface of the lens. In certain examples, the programmable substrate of a mass spectrometer component is programmed as a rod of a collision-reaction cell, and the rod comprises at least one MSPE, e.g., at least one programmable electrode disposed on a surface of the rod. In other examples, the programmable substrate of the mass spectrometer component is programmed as one rod of a mass analyzer comprising at least one rod set, wherein the one rod of the at least one rod set comprises at least one MSPE, e.g. at least one programmable electrode disposed on a surface of the one rod. In some embodiments, the programmable substrate of the mass spectrometer component is programmed as a lens of a time of flight analyzer, and the lens comprises at least on MSPE, e.g., at least one programmable electrode disposed of a surface of the lens. In other examples, the programmable substrate of the mass spectrometer component is configured as an ion trap, and the ion trap comprises at least one MSPE, e.g., at least one programmable electrode disposed on a surface of the ion trap.

In other embodiments, the programmable substrate of the mass spectrometer component is programmed as an induction device, and the induction device comprises at least one MSPE, e.g., at least one programmable electrode disposed on a surface of the induction device. In some examples, the programmable substrate of the mass spectrometer component is programmed as a torch, and the torch comprises at least one MSPE, e.g., at least one programmable electrode disposed on a surface of the torch.

In other examples, the substrate of the mass spectrometer component is programmed as an injector, and the injector comprises at least one MSPE, e.g., at least one programmable electrode, disposed on an outer surface of the injector. In certain embodiments, the substrate of the mass spectrometer component is programmed as a nebulizer, and the nebulizer comprises at least one MSPE, e.g., at least one programmable electrode disposed on a surface of the nebulizer. In other examples, the substrate of the mass spectrometer component is programmed as a spray chamber, and the spray chamber comprises at least one MSPE, e.g., at least one programmable electrode disposed on a surface of the spray chamber. In other examples, the programmable substrate of the mass spectrometer component is programmed as a focusing ring of a drift tube, and the drift tube comprises the at least one programmable electrode disposed on a surface of the drift tube. In some examples, the substrate of the mass spectrometer component is programmed as a planar ion guide comprising at least one MSPE, e.g., at least one programmable electrode.

In other instances, the mass spectrometer component comprises at least one additional MSPE, e.g., at least one additional programmable electrode, disposed on the programmable substrate and electrically decoupled from the programmable substrate, wherein the at least one programmable electrode and the at least one additional programmable electrode are together configured to provide an electric field within the space that is configured to receive the ion.

In some embodiments, the programmable substrate of the mass spectrometer component is programmed as a skimmer, and the skimmer cone comprises the at least one programmable electrode and the additional programmable electrode each disposed on a surface of the skimmer cone. In other embodiments, the programmable substrate of the mass spectrometer component is programmed as a sampling cone, and the sampling cone comprises the at least one programmable electrode and the additional programmable electrode each disposed on a surface of the sampling cone.

In certain examples, the programmable substrate of the mass spectrometer component is programmed as one pole of an ion deflector, and the one pole comprises the at least one programmable electrode and the additional programmable electrode each disposed on a surface of the one pole. In some examples, the programmable substrate of the mass spectrometer component is programmed as a lens, and the lens comprises the at least one programmable electrode and the additional programmable electrode each disposed on a surface of the lens. In some embodiments, the programmable substrate of the mass spectrometer component is programmed as one rod of a collision-reaction cell, and the one rod comprises the at least one programmable electrode and the additional programmable electrode each disposed on a surface of the one rod. In other embodiments, the programmable substrate of the mass spectrometer component is programmed as one rod of a mass analyzer comprising at least one rod set, wherein the one rod of the at least one rod set comprises the at least one programmable electrode and the additional programmable electrode each disposed on a surface of the one rod. In other examples, the programmable substrate of the mass spectrometer component is programmed as a lens of a time of flight analyzer, and the lens comprises the at least one programmable electrode and the additional programmable electrode each disposed on a surface of the lens. In certain examples, the programmable substrate of the mass spectrometer component is programmed as an ion trap, and the ion trap the at least one programmable electrode and the additional programmable electrode each disposed on a surface of the ion trap. In other instances, the programmable substrate of the mass spectrometer component is programmed as a planar ion guide comprising the at least one programmable electrode and the additional programmable electrode.

In some examples, the programmable substrate of the mass spectrometer component is programmed as an induction device, and the induction device comprises the at least one programmable electrode and the additional programmable electrode each disposed on a surface of the induction device. In other examples, the programmable substrate of the mass spectrometer component is programmed as a torch, and the torch comprises the at least one programmable electrode and the additional programmable electrode each disposed on a surface of the torch.

In certain embodiments, the programmable substrate of the mass spectrometer component is programmed as an injector, and the injector comprises the at least one programmable electrode and the additional programmable electrode each disposed on an outer surface of the injector. In some examples, the programmable substrate of the mass spectrometer component is programmed as a nebulizer, and the nebulizer comprises the at least one programmable electrode and the additional programmable electrode each disposed on a surface of the nebulizer. In certain examples, the programmable substrate of the mass spectrometer component is programmed as a spray chamber, and the spray chamber comprises the at least one programmable electrode and the additional programmable electrode each disposed on a surface of the spray chamber. In other examples, the programmable substrate of the mass spectrometer component is programmed as a focusing ring of a drift tube, and the drift tube comprises the at least one programmable electrode and the additional programmable electrode each disposed on a surface of the drift tube.

In certain embodiments, a mass spectrometer component comprising a programmable substrate may comprise an electrode array comprising a plurality of separate and individually programmable electrodes each disposed on the programmable substrate, wherein the at least one programmable electrode is an electrode of the electrode array and is configured to provide the electric field within the space that is configured to receive the ion. In certain examples, the electrode array comprises a plurality of planar electrodes of about a same thickness. In other examples, the electrode array comprises a plurality of planar electrodes of a different thickness. In some embodiments, the electrode array comprises a plurality of electrodes arranged in layers of different heights with respect to a surface of the programmable substrate. In certain examples, the electrode array comprises a plurality of electrodes arranged in circumferential rings around a surface of the programmable substrate. In other examples, the plurality of electrodes arranged in the circumferential rings comprises different sized electrodes. In some embodiments, the electrodes in a first circumferential ring are electrically coupled to each other through a resistor network. In certain examples, electrodes in adjacent circumferential rings are programmed with different voltages. In some examples, electrodes in a circumferential ring are programmed with different voltages. In other examples, electrodes of the electrode array are individually programmed with a DC voltage.

In another aspect, a mass spectrometer skimmer cone configured to receive ions from an ionization source fluidically coupled to the mass spectrometer skimmer cone is described. In some examples, the mass spectrometer skimmer cone comprises a tapered member comprising a distal aperture configured to receive the ions from the ionization source and provide the received ions to a downstream component, the skimmer cone comprising at least one programmable electrode on a surface of the tapered member and electrically decoupled from the surface of the tapered member, and wherein the at least one programmable electrode is configured to provide an electric field within a space between the skimmer cone and the ionization source.

In certain examples, the tapered member comprises a programmable substrate. In other examples, the skimmer cone comprises at least one additional programmable electrode disposed on the surface of the tapered member. In some embodiments, the skimmer cone comprises an array of programmable electrodes disposed on the surface of the tapered member. In some examples, the skimmer cone comprises an insulating material disposed between the programmable electrode and the surface.

In an additional aspect, a mass spectrometer sampling interface configured to receive ions is described. In some examples, the mass spectrometer sampling interface comprises a housing comprising a sampling inlet, the housing comprising at least one programmable electrode on an incident surface of the housing and electrically decoupled from the incident surface of the housing, and wherein the at least one programmable electrode is configured to provide an electric field adjacent to the incident surface of the mass spectrometer sampling interface.

In some embodiments, the housing comprises a programmable substrate. In other embodiments, at least one additional programmable electrode is disposed on the incident surface. In certain examples, an array of programmable electrodes is disposed on the incident surface. In some examples, an insulating material is disposed between the programmable electrode and the incident surface.

In another aspect, an ion guide comprises a first multipole comprising a plurality of separate poles, wherein at least one pole of the first multipole comprises a programmable electrode on a surface of the at least one pole, wherein the programmable electrode is electrically decoupled from the at least one pole, the first multipole having a first opening and a second opening fluidically coupled to the first opening, wherein the programmable electrode is configured to provide an electric field within a space formed by the plurality of separate poles, and wherein the electric field is effective to alter a first trajectory of ions entering the first multipole through the first opening to a second trajectory to permit the ions of the second trajectory to exit the first multipole through the second opening.

In certain examples, each of the plurality of separate poles comprises a plurality of programmable electrodes disposed on a surface of each of the plurality of separate poles, and wherein a DC voltage provided to the electrodes of each of the plurality of separate poles is effective to provide a DC electric field within the space formed by the plurality of separate poles. In some embodiments, each of the plurality of separate poles comprises a non-conductive substrate. In other examples, each of the plurality of separate poles is electrically decoupled from the plurality of programmable electrodes through an insulating material. In some examples, each electrode of a circumferential electrode ring on the one pole is electrically coupled to each other through a resistor network. In certain embodiments, an insulating material is disposed between the surface of the at least one pole and the programmable electrode. In other embodiments, a linear array of programmable electrodes is disposed on the surface of the at least one pole. In some examples, an insulating material is disposed between each electrode of the linear array of programmable electrodes and the surface of the at least one pole.

In some examples, a power source is electrically coupled to the programmable electrode. In other examples, the power source is configured to provide one or more of a DC voltage, an AC voltage, and an RF voltage.

In another aspect, a cell configured to fluidically couple to an ionization source at an entrance aperture to receive ions into the cell and configured to provide ions from the cell through an exit aperture fluidically coupled to a mass analyzer is disclosed. In some examples, the cell comprises a gas inlet configured to receive a gas in a collision mode to pressurize the cell and configured to receive a reaction gas in a reaction mode, the cell further comprising a rod set, wherein at least one rod of the rod set comprises a programmable electrode on a surface of the at least one rod of the rod set, and wherein the programmable electrode is electrically decoupled from the at least one rod.

In certain examples, the programmable electrode is configured to provide a DC electric field within a space formed by the rod set when a DC voltage is provided to the programmable electrode. In other examples, each rod of the rod set comprises a plurality of programmable electrodes disposed on a surface of each rod, and wherein a DC voltage provided to the electrodes on each rod is effective to provide the DC electric field within the space formed by the rod set. In some embodiments, an insulating material is present between the programmable electrode and the at least one rod. In other examples, the at least one rod is configured as a programmable substrate.

In an additional aspect, an ion lens comprises a planar substrate comprising a first surface and a second surface, and a programmable electrode on the first surface of the planar substrate and electrically decoupled from the first surface of the planar substrate, and wherein the programmable electrode is configured to provide an electric field within a space that is configured to receive an ion.

In some examples, the planar substrate is configured as a printed circuit board. In other examples, the programmable electrode is an etched electrode on the printed circuit board. In some embodiments, an insulating material is present between the programmable electrode and the first surface. In other examples, the ion lens comprises an additional programmable electrode on the first surface. In some examples, each of the programmable electrode and the additional programmable electrode are configured as a ring electrode. In certain embodiments, an insulating material is present between each ring electrode and the first surface. In some examples, the ion lens comprises a third programmable electrode on the first surface. In some examples, an insulating material between each of the three ring electrodes and the first surface. In other examples, the ion lens comprises a power source electrically coupled to at least one ring electrode. In some embodiments, the ion lens comprises a first resistor configured to electrically couple the programmable electrode and the additional programmable electrode. In other examples, the ion lens comprises a second resistor configured to electrically couple the additional programmable electrode and the third programmable electrode. In some embodiments, the first resistor and second resistor are selected so a voltage provided to the third programmable electrode is greater than a voltage provided to the programmable electrode. In other embodiments, the first resistor and second resistor are selected so a voltage provided to the programmable electrode is greater than a voltage provided to the third programmable electrode. In some examples, the power source is configured to provide one or more of a DC voltage, an AC voltage and an RF voltage.

In another aspect, a time of flight device comprises a flight tube, and a lens assembly comprising a plurality of independent lenses disposed in the flight tube, wherein at least one lens of the lens assembly comprises a programmable electrode electrically decoupled from a substrate of the at least one lens, and wherein the programmable electrode is configured to provide an electric field within a space of the lens assembly that is configured to receive an ion.

In certain examples, the lens comprising the programmable electrode is positioned proximate to a detector. In other examples, the at least one lens further comprises at least one additional programmable electrode. In some examples, the at least one lens further comprises a programmable electrode array. In other examples, a second lens of the lens assembly comprises at programmable electrode. In some embodiments, each lens of the lens assembly comprises a programmable electrode. In other examples, an insulating material is present between the programmable electrode and the at least one lens. In some examples, the at least one lens is configured as a programmable substrate. In other embodiments, a power source is electrically coupled to the programmable electrode. In some examples, the power source is configured to provide one or more of a DC voltage, an AC voltage and an RF voltage to the programmable electrode.

In an additional aspect, a reflectron comprises a plurality of independent and substantially parallel lenses positioned in a housing, wherein at least one lens comprises a programmable electrode on a planar surface of the at least one ion lens, wherein the programmable electrode is electrically decoupled from the planar surface of the at least one lens, and wherein the programmable electrode is configured to provide an electric field within a space between lenses of the reflectron.

In some embodiments, the lens comprising the programmable electrode is positioned proximate to a detector. In some examples, the at least one lens further comprises at least one additional programmable electrode. In other embodiments, the at least one lens further comprises a programmable electrode array. In certain examples, a second lens of the lens assembly comprises at programmable electrode. In some embodiments, each lens of the lens assembly comprises a programmable electrode. In certain instances, an insulating material is present between the programmable electrode and the at least one lens. In other examples, the at least one lens is configured as a programmable substrate. In some embodiments, a power source is electrically coupled to the programmable electrode. In other examples, the power source is configured to provide one or more of a DC voltage, an AC voltage and an RF voltage to the programmable electrode.

In another aspect, a mass analyzer comprises a plurality of rods each positioned substantially parallel to each other, wherein at least one rod comprises a programmable electrode on a surface of the at least one rod, wherein the programmable electrode is electrically decoupled from the at least one rod, and wherein the programmable electrode is configured to provide an electric field within a space formed by the positioned rods.

In certain examples, the plurality of rods are arranged as a quadrupole, and wherein the at least one rod of the quadrupole comprises the programmable electrode on a surface. In other examples, the mass analyzer comprises a second programmable electrode on a surface of a second rod of the quadrupole. In other instances, the mass analyzer comprises a third programmable electrode on a surface of a third rod of the quadrupole. In further examples, the mass analyzer comprises a fourth programmable electrode on a surface of a fourth rod of the quadrupole. In some examples, the mass analyzer comprises a power source electrically coupled to each of the programmable electrode, the second programmable electrode, the third programmable electrode and the fourth programmable electrode. In further instances, the mass analyzer comprises an insulating material present between each of the programmable electrode and the at least one rod, between the second programmable electrode and the second rod, between the third programmable electrode and the third rod and between the fourth programmable electrode and the fourth rod. In some embodiments, each rod of the quadrupole is configured as a programmable substrate. In other examples, each rod comprises a shape memory polymer or a shape memory alloy. In some examples, the mass analyzer comprises at least one additional programmable electrode on the at least one rod.

In another aspect, a dipole ion guide comprises a first set of electrodes disposed on a first substrate, and a second set of electrodes disposed on a second substrate spatially separated from the first substrate, wherein each electrode of the first set is independently programmable and wherein each electrode of the second set is independently programmable, wherein the first set and the electrodes of the second set are configured to provide an electric field within a space between the spatially separated electrodes to guide an ion between the first substrate and the second substrate.

In certain configurations, a central electrode of the first set of electrodes and a central electrode of the second set of electrodes are each programmed to trap the ion within the dipole ion guide. In some embodiments, the central electrode of the first set of electrodes and the central electrode of the second set of electrodes are each programmed with an RF voltage. In other embodiments, wherein electrodes adjacent to the central electrode of the first set of electrodes and electrodes adjacent to the central electrode of the second set of electrodes are programmed to be more positively charged. In other examples, a central electrode of the first set of electrodes and a central electrode of the second set of electrodes are each programmed with differential RF and DC voltages to filter ions provided to the dipole ion guide. In some embodiments, each of the first substrate and the second substrate is configured as a programmable substrate. In further examples, the first set of electrodes is configured as an array of linear electrodes. In some examples, the second set of electrodes is configured as an array of linear electrodes. In further embodiments, the dipole ion guide comprises a power source electrically coupled to each of the first set of electrodes and the second set of electrodes. In some instances, the power source is configured to provide one or more of a DC voltage, an AC voltage, an RF voltage or combinations thereof.

In another aspect, an ion switch comprises a first ion guide fluidically coupled to a first ion source, the first ion guide comprising a first substrate spatially positioned from a second substrate, wherein each of the first substrate and the second substrate of the first ion guide comprise a respective set of electrodes, wherein each respective set of electrodes is electrically decoupled from its respective substrate, and wherein the electrodes on the first substrate and the electrodes on the second substrate are configured to provide an electric field within a space between the spatially separated first and second substrates. The ion switch may also comprise a second ion guide fluidically coupled to a second ion source, the second ion guide comprising a third substrate spatially positioned from a fourth substrate, wherein each of the third substrate and the fourth substrate of the first ion guide comprise a respective set of electrodes, wherein each respective set of electrodes is electrically decoupled from its respective substrate, and wherein the electrodes on the third substrate and the electrodes on the fourth substrate are configured to provide an electric field within a space between the spatially separated third and fourth substrates. The ion switch may also comprise a processor configured to provide a first respective voltage to each of the first ion guide and the second ion guide to provide an ion output from the first ion guide in a first mode of the ion switch and block an ion output from the second ion guide in the first mode of the ion switch, and wherein the processor is configured to provide a second respective voltage to each of the first ion guide and the second ion guide to block an ion output from the first ion guide in a second mode of the ion switch and provide an ion output from the second ion guide in the second mode of the ion switch.

In certain examples, a central electrode of the first set of electrodes of the first ion guide and a central electrode of the second set of electrodes of the first ion guide are each programmed to trap the ion within the first ion guide. In other examples, the central electrode of the first of the first set of electrodes on the first substrate of the first ion guide and the central electrode of the second set of electrodes on the second substrate of the first ion guide are each programmed with an RF voltage. In some embodiments, a central electrode of a first set of electrodes on the third substrate of the second ion guide and a central electrode of a second set of electrodes on the fourth substrate of the second ion guide are each programmed to trap the ion within the second ion guide. In other examples, the central electrode of a first set of electrodes on the third substrate of the second ion guide and the central electrode of a second set of electrodes on the fourth substrate of the second ion guide are each programmed with an RF voltage. In certain embodiments, electrodes adjacent to the central electrode of the first set of electrodes of the first ion guide and electrodes adjacent to the central electrode of the second set of electrodes of the first ion guide are programmed to be more positively charged. In other examples, a central electrode of the first set of electrodes of the first ion guide and a central electrode of the second set of electrodes of the first ion guide are each programmed with differential RF and DC voltages to filter ions provided to the ion switch. In some examples, each of the first substrate and the second substrate of the first ion guide is configured as a programmable substrate. In other examples, a first set of electrodes on the first substrate of the first ion guide and a second set of electrodes on the second substrate of the first ion guide are each configured as an array of linear electrodes. In other examples, a first set of electrodes on the third substrate and the second set of electrodes on the fourth substrate of the second ion guide are each configured as an array of linear electrodes.

Additional aspects, features, configurations and examples are described in more detail below.

### BRIEF DESCRIPTION OF THE SEVERAL VIEWS OF THE DRAWINGS

Certain illustrative representations, configurations and forms of a mass spectrometer programmable element are described with reference to the accompanying figures in which:

FIG. 1A is a block diagram of a mass spectrometer, in accordance with certain embodiments;

FIG. 1B is a block diagram of a mass spectrometer comprising an ion source with a mass spectrometer programmable element, in accordance with certain embodiments;

FIG. 1C is a block diagram of a mass spectrometer comprising a mass analyzer with a mass spectrometer programmable element, in accordance with certain embodiments;

FIG. 1D is a block diagram of a mass spectrometer comprising a detector with a mass spectrometer programmable element, in accordance with certain embodiments;

FIG. 1E is a block diagram of a mass spectrometer comprising an ion source with a mass spectrometer programmable element and a mass analyzer with a mass spectrometer programmable element, in accordance with certain embodiments;

FIG. 1F is a block diagram of a mass spectrometer comprising an ion source with a mass spectrometer programmable element and a detector with a mass spectrometer programmable element, in accordance with certain embodiments;

FIG. 1G is a block diagram of a mass spectrometer comprising a mass analyzer with a mass spectrometer programmable element and a detector with a mass spectrometer programmable element, in accordance with certain embodiments;

FIG. 1H is a block diagram of a mass spectrometer comprising an ion source with a mass spectrometer programmable element, a mass analyzer with a mass spectrometer programmable element, and a detector with a mass spectrometer programmable element, in accordance with certain embodiments;

FIG. 2A is an illustration showing a generalized mass spectrometer programmable element, in accordance with certain configurations;

FIG. 2B is an illustration showing two mass spectrometer programmable elements configured as electrodes, in accordance with certain configurations;

FIG. 2C is an illustration showing three mass spectrometer programmable elements configured as electrodes, in accordance with certain examples;

FIG. 2D is an illustration showing a mass spectrometer programmable element configured as a ring electrode, in accordance with certain embodiments;

FIG. 2E is an illustration showing a mass spectrometer programmable element configured as a square electrode, in accordance with certain embodiments;

FIG. 2F is an illustration showing a mass spectrometer programmable element configured as a triangular electrode, in accordance with certain embodiments;

FIG. 2G is an illustration showing two mass spectrometer programmable elements each configured as ring electrodes, in accordance with certain embodiments;

FIG. 2H is another illustration showing two mass spectrometer programmable elements each configured as ring electrodes, in accordance with certain embodiments;

FIG. 2I an illustration showing mass spectrometer programmable elements configured as an electrode array, in accordance with certain embodiments;

FIG. 2J an illustration showing mass spectrometer programmable elements configured with different heights, in accordance with certain embodiments;

FIG. 2K an illustration showing stacked mass spectrometer programmable elements, in accordance with certain examples;

FIGS. 3A and 3B are illustrations of a programmable substrate, in accordance with some examples;

FIGS. 4A, 4B and 4C show various layers of a mass spectrometer component comprising at least one mass spectrometer programmable element, in accordance with certain embodiments;

FIG. 5 is an illustration showing a generalized mass spectrometer system comprising a sample introduction device, in accordance with some configurations;

FIG. 6 is an illustration showing a nebulizer comprising a mass spectrometer programmable element, in accordance with certain configurations;

FIG. 7 is one illustration of a spray chamber comprising a mass spectrometer programmable element, in accordance with certain configurations;

FIG. 8A is a block diagram showing a generalized schematic of an inductively coupled plasma ion source, in accordance with some examples;

FIG. 8B is an illustration of an ion source showing an induction device comprising a mass spectrometer programmable element, in accordance with some examples;

FIG. 9 is an illustration of an ion source showing a torch comprising a mass spectrometer programmable element, in accordance with some examples;

FIG. 10 is an illustration of an ion source showing an interface comprising a mass spectrometer programmable element, in accordance with some examples;

FIG. 11 is an illustration of an inductively coupled plasma ion source comprising a finned induction coil comprising a mass spectrometer programmable element, in accordance with some embodiments;

FIG. 12 is an illustration of an inductively coupled plasma ion source comprising plate electrodes at least one of which comprises a mass spectrometer programmable element, in accordance with certain examples;

FIG. 13 is an illustration of an inductively coupled plasma ion source comprising a cylindrical induction device comprising a mass spectrometer programmable element, in accordance with some embodiments;

FIG. 14 is an illustration of an electron ionization source comprising a mass spectrometer programmable element, in accordance with some examples;

FIG. 15 is an illustration of a chemical ionization source comprising a mass spectrometer programmable element, in accordance with certain examples;

FIG. 16 is an illustration of a field ionization source comprising a mass spectrometer programmable element, in accordance with some examples;

FIG. 17 is an illustration of a laser desorption ionization source comprising a mass spectrometer programmable element, in accordance with some examples;

FIG. 18 is an illustration of a spray ionization source comprising a mass spectrometer programmable element, in accordance with some examples;

FIG. 19 is an illustration of an interface comprising a mass spectrometer programmable element, in accordance with some examples;

FIG. 20 is another illustration of a system comprising an interface comprising a mass spectrometer programmable element, in accordance with some examples;

FIG. 21 is a general diagram showing some components present in a mass analyzer, in accordance with some examples;

FIG. 22 is an illustration of a lens comprising a mass spectrometer programmable element, in accordance with certain embodiments;

FIG. 23 is another illustration of a lens comprising a mass spectrometer programmable element, in accordance with certain examples;

FIG. 24 is an illustration of a lens comprising a mass spectrometer programmable element, in accordance with certain examples;

FIG. 25A is an illustration of an ion guide comprising a mass spectrometer programmable element, in accordance with certain embodiments;

FIG. 25B is an illustration of an ion guide comprising two mass spectrometer programmable elements, in accordance with certain embodiments;

FIG. 25C is an illustration of an ion guide comprising three mass spectrometer programmable elements, in accordance with certain embodiments;

FIG. 25D is an illustration of an ion guide comprising four mass spectrometer programmable elements, in accordance with certain embodiments;

FIG. 25E is an illustration of a dipolar ion guide comprising a plurality of mass spectrometer programmable elements, in accordance with certain embodiments;

FIG. 26 is an illustration of a collision cell (or collision/reaction cell) comprising one or more mass spectrometer programmable elements, in accordance with certain examples;

FIG. 27A is an illustration of a quadrupole mass analyzer comprising a mass spectrometer programmable element, in accordance with certain examples;

FIG. 27B is an illustration of a quadrupole mass analyzer comprising two mass spectrometer programmable elements, in accordance with certain examples;

FIG. 27C is an illustration of a quadrupole mass analyzer comprising three mass spectrometer programmable elements, in accordance with certain examples;

FIG. 27D is an illustration of a quadrupole mass analyzer comprising four mass spectrometer programmable elements, in accordance with certain examples;

FIG. 27E is an illustration of a dipole mass analyzer, in accordance with certain examples;

FIG. 28A is an illustration of a dual quadrupole mass analyzer where at least one of the quadrupoles comprises a mass spectrometer programmable element, in accordance with certain examples;

FIG. 28B another illustration of a dual quadrupole mass analyzer where at least one of the quadrupoles comprises a mass spectrometer programmable element, in accordance with certain examples;

FIG. 28C is an illustration of a dual quadrupole mass analyzer where both the quadrupoles comprise a mass spectrometer programmable element, in accordance with certain examples;

FIGS. 29A, 29B, 29C, 29D, 29E, 29F and 29G are illustrations of a triple quadrupole mass analyzer where at least one of the quadrupole mass analyzers comprises a mass spectrometer programmable element, in accordance with certain examples;

FIG. 30 is an illustration of a linear ion trap comprising a mass spectrometer programmable element, in accordance with certain examples;

FIG. 31A is an illustration of a time of flight device with a mass spectrometer programmable element, in accordance with certain examples;

FIG. 31B is an illustration of a reflectron where at least one lens of the reflectron comprises a mass spectrometer programmable element, in accordance with certain examples;

FIG. 32 is an illustration of an ion mobility drift tube comprising a mass spectrometer programmable element, in accordance with some examples;

FIG. 33 is an illustration of an electron multiplier detector where at least one dynode of the electron multiplier comprises a mass spectrometer programmable element, in accordance with certain examples;

FIG. 34 is an illustration of a Faraday cup detector comprising a mass spectrometer programmable element, in accordance with certain examples;

FIG. 35 is an illustration of a microchannel plate detector comprising a mass spectrometer programmable element, in accordance with certain examples;

FIGS. 36A, 36B, 36C, 36D, 36E, 36F, and 36G are block diagrams of an inductively coupled plasma ion source coupled to a mass analyzer and a detector, in accordance with some examples;

FIGS. 37A, 37B, 37C, 37D, 37E, 37F, and 37G are block diagrams of an ion source other than an inductively coupled plasma ion source that is coupled to a mass analyzer and a detector, in accordance with some examples;

FIG. 38 is an illustration of a gas chromatography device coupled to a mass spectrometer comprising a MS programmable element, in accordance with certain embodiments;

FIG. 39 is an illustration of a liquid chromatography device coupled to a mass spectrometer comprising a MS programmable element, in accordance with certain embodiments;

FIG. 40 is an illustration showing a lens comprising a programmable electrode with an adjustable surface potential, in accordance with some examples;

FIG. 41 is another illustration showing MS programmable elements with different voltages, in accordance with some embodiments;

FIG. 42 is an illustration showing electric fields of MS programmable elements with different voltages, in accordance with some embodiments;

FIG. 43A is an illustration of a conventional lens, and FIG. 43B is a simulation showing ion distribution in an opening of the lens of FIG. 43A, in accordance with some examples;

FIG. 44A is an illustration of a lens comprising three ring electrodes as MS programmable elements, and FIG. 44B is a simulation showing ion distribution in an opening of the lens of FIG. 44A, in accordance with some examples;

FIGS. 45A and 45B are intensity curves showing measurement of a lithium sample using a conventional lens (FIG. 45A) and a lens similar to the one shown in FIG. 44B (FIG. 45B), in accordance with certain embodiments;

FIGS. 46A and 46B are intensity curves showing measurement of a magnesium sample using a conventional lens (FIG. 46A) and a lens similar to the one shown in FIG. 44B (FIG. 46B), in accordance with certain embodiments;

FIGS. 47A and 47B are intensity curves showing measurement of an indium sample using a conventional lens (FIG. 47A) and a lens similar to the one shown in FIG. 44B (FIG. 47B), in accordance with certain embodiments;

FIGS. 48A and 48B are intensity curves showing measurement of a lead sample using a conventional lens (FIG. 48A) and a lens similar to the one shown in FIG. 44B (FIG. 48B), in accordance with certain embodiments;

FIGS. 49A and 49B are intensity curves showing measurement of a uranium sample using a conventional lens (FIG. 49A) and a lens similar to the one shown in FIG. 44B (FIG. 49B), in accordance with certain embodiments;

FIG. 50 is an illustration of an ion guide, in accordance with some embodiments;

FIG. 51 is an illustration of an ion multiplexer, in accordance with some examples;

FIG. 52 is another illustration of an ion multiplexer, in accordance with some examples;

FIG. 53 is an illustration of a lens stack, in accordance with certain configurations; and

FIG. 54 is an illustration of a system comprising an ion-on-demand system, in accordance with some examples.

It will be recognized by the person of ordinary skill in the art, given the benefit of this disclosure, that the components in the figures are provided merely for illustration purposes and are not necessarily the only representations which can be produced. The mass spectrometer programmable elements in the figures can adopt may different sizes, shapes, positions, orientations and arrangements, and the illustrative sizes, shapes, positions, orientations and arrangements shown in the figures are not required. In addition, the mass spectrometer programmable elements may be exaggerated or otherwise not drawn to scale to provide more user-friendly figures and to facilitate a better understanding of the technology described in this description.

### DETAILED DESCRIPTION

Many different illustrations of mass spectrometer (MS) programmable elements are discussed below to illustrate some of the various configurations the MS programmable elements may adopt. In some cases, a MS programmable element may take the form of a programmable electrode or other conductive device or devices. While reference is made to MS programmable elements being disposed, deposited or present on a surface of a substrate, the MS programmable elements may be disposed, deposited or present on two or more different surfaces of the same substrate or may be disposed at different areas, or in different configurations, on the same surface of a substrate. Further, different substrates with different MS programmable elements can be coupled to each other to provide a larger substrate that can function as a single component in a mass spectrometer. In some instances, the MS programmable elements may be modular and can couple to other modular MS programmable elements to provide a functioning component in a mass spectrometer.

In certain embodiments, the MS programmable elements described herein can function in different ways depending on the particular MS component which the MS programmable elements are present. In general, at least some portion of a MS programmable element is electrically conductive and can receive a suitable voltage, e.g., AC voltage, DC voltage, RF voltage, etc. from a power source, and provide an electric field, magnetic field or both into some space adjacent to or near the mass spectrometer component. The MS programmable elements and their shapes, geometries, positioning, etc. described herein are provided to illustrate some of the many different configurations and uses of MS programmable elements in mass spectrometer components. Other suitable uses and configurations will be readily selected by the skilled person in the art, given the benefit of this disclosure. The MS programmable element can generally function independently of any underlying substrate or MS component to which the MS programmable element is coupled.

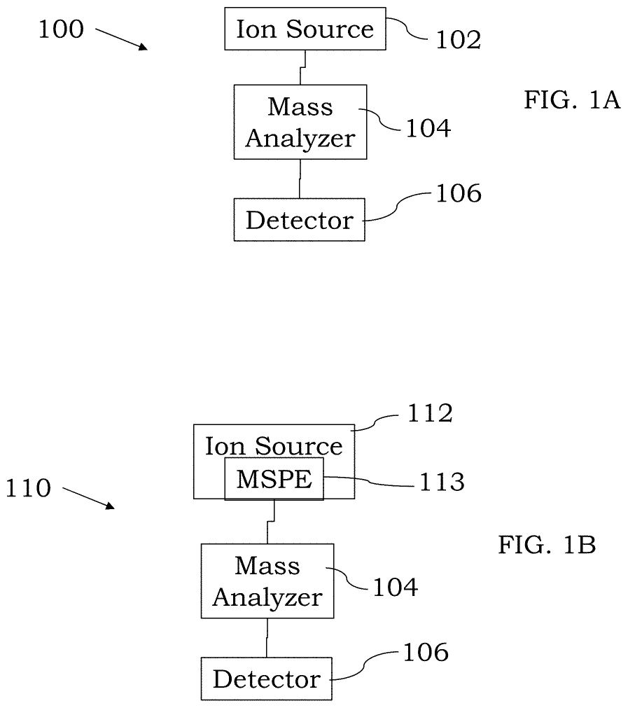

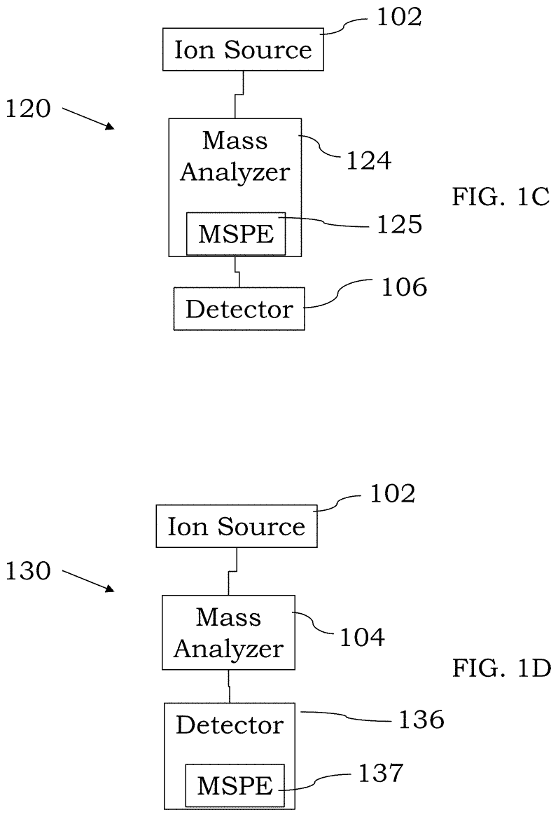

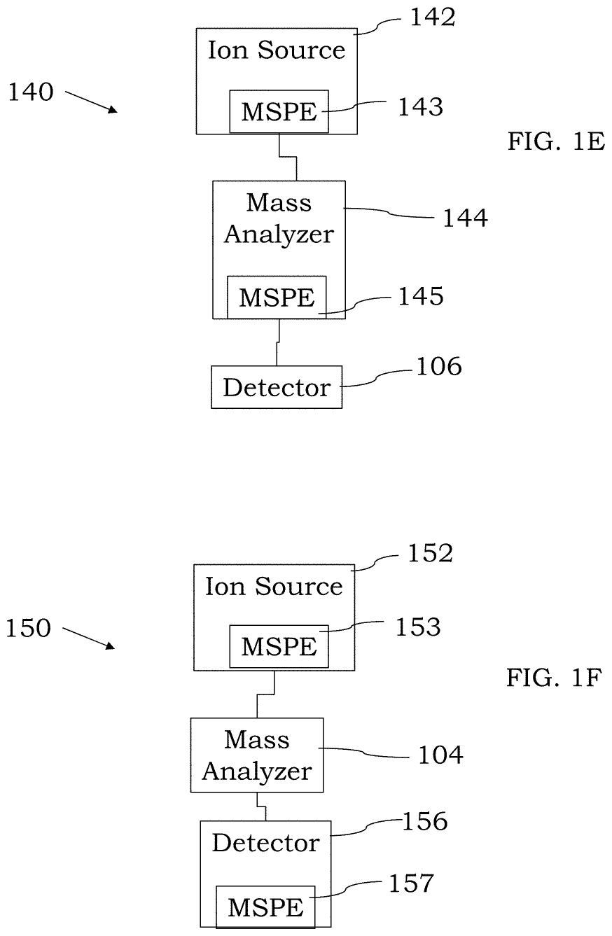

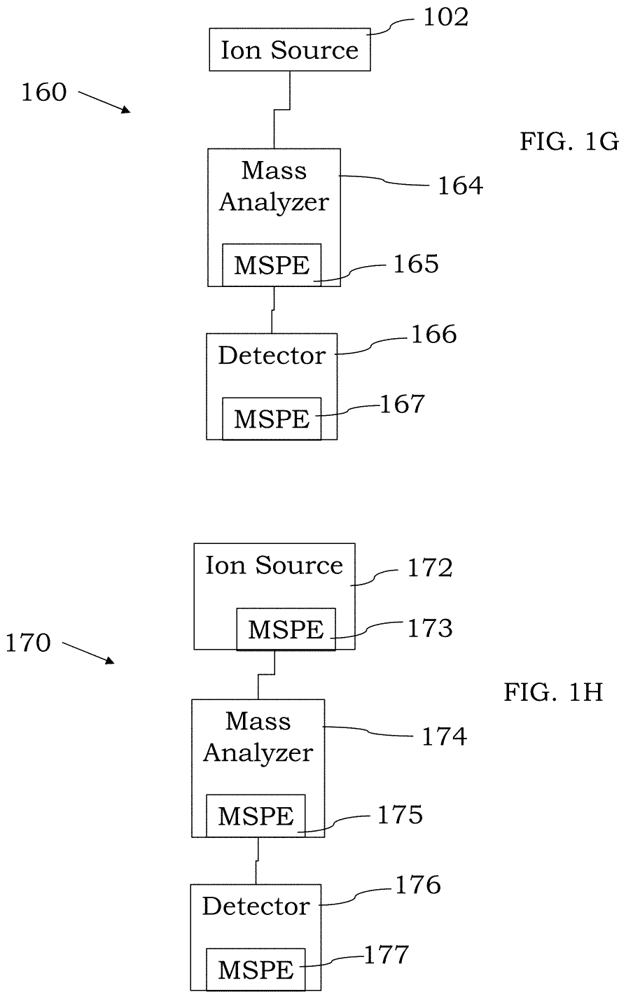

In some examples, a very general schematic of a mass spectrometer is shown in FIG. 1A. The mass spectrometer 100 comprises three stages including an ion source 102, a mass analyzer 104 fluidically coupled to the ion source 102 and a detector 106 fluidically coupled to the mass analyzer 104. As shown in FIG. 1B, in some configurations a mass spectrometer 110 may comprise an ion source 112 that comprises at least one MS programmable element (MSPE) 113. In other configurations, a mass spectrometer 120 may comprise a mass analyzer 124 comprising a MS programmable element 125 as shown in FIG. 1C. In additional configurations, a mass spectrometer 130 may comprise a detector 136 comprising a MS programmable element 137 as shown in FIG. 1D. In yet other configurations, a mass spectrometer 140 may comprise an ion source 142 comprising a MS programmable element 143 and a mass analyzer 144 comprising a MS programmable element 145 (see FIG. 1E). In additional configurations, a mass spectrometer 150 may comprise an ion source 152 comprising a MS programmable element 153 and a detector 156 comprising a MS programmable element 157 (see FIG. 1F). In further embodiments, a mass spectrometer 160 may comprise a mass analyzer 164 comprising a MS programmable element 165 and a detector 166 comprising a MS programmable element 167 (see FIG. 1G). In other instances, a mass spectrometer 170 may comprise an ion source 172 comprising a MS programmable element, a mass analyzer 174 comprising a MS programmable element 175 and a detector 176 comprising a MS programmable element 177 (see FIG. 1H). While a single MS programmable element is shown for illustration purposes, two or more MS programmable elements may be present as desired in any one or more of the stages shown in FIGS. 1A-1H.

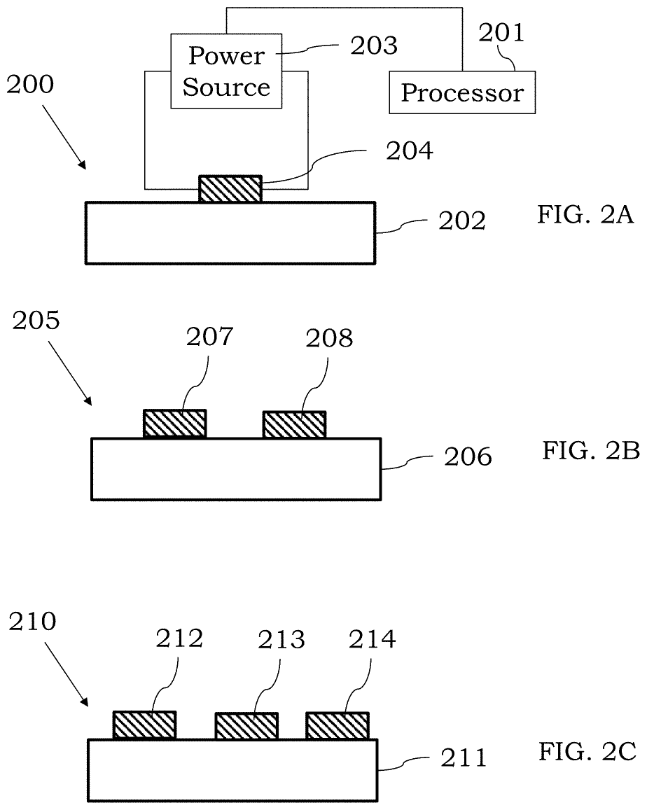

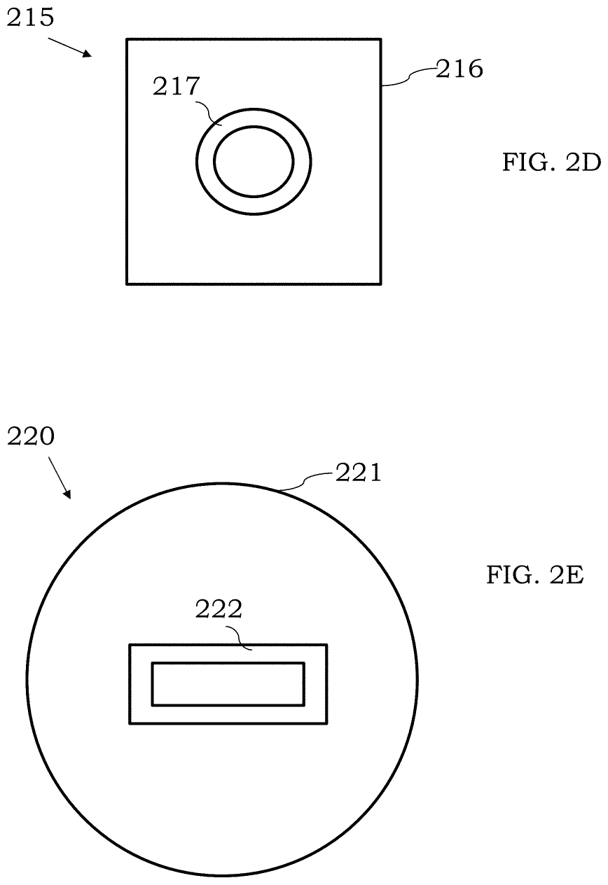

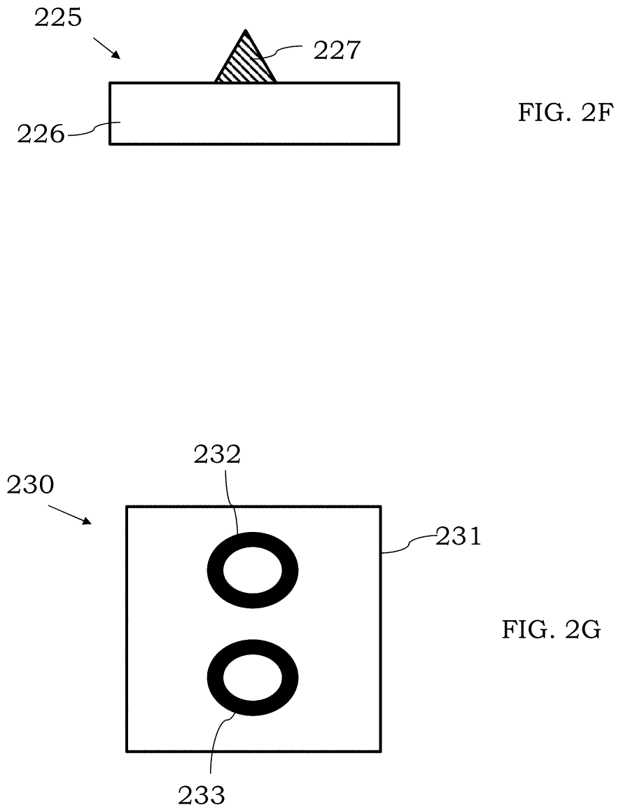

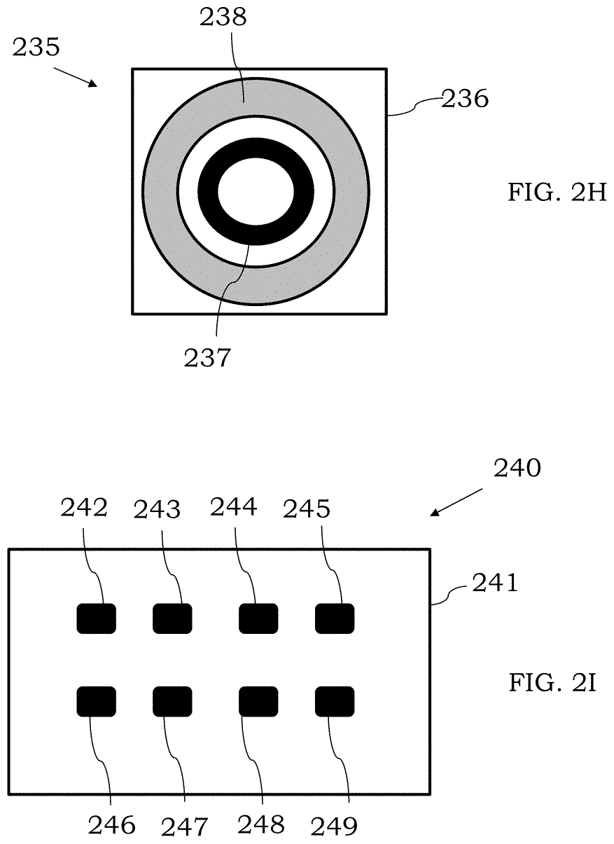

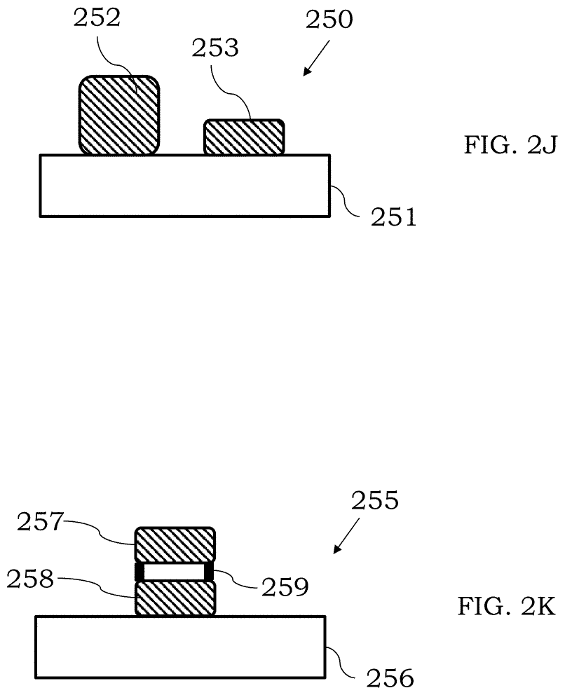

In certain embodiments, a mass spectrometer component comprising a MS programmable element can generally be distinguished from a mass spectrometer component lacking a MS programmable element due to the increased control and/or functionality provided by the presence of a MS programmable element. The MS programmable element is generally controllable separate from the underlying MS component or substrate to provide for additional tuning or control of that particular MS component comprising the MS programmable element. To provide a better understanding of the technology described herein, several general configurations of a mass spectrometer component comprising a MS programmable element are shown in FIGS. 2A-2K. Discussed below are some specific configurations of mass spectrometer components, e.g., sample introduction devices, induction devices, torches, lenses, ion guides, ion deflectors, collision cells, collision-reaction cells, mass analyzers, detectors, etc. comprising a MS programmable element. Any of the general configurations shown in FIGS. 2A-2K can be used in or with the specific mass spectrometer components, e.g., any of the configurations shown in FIGS. 2A-2K may be present in a sample introduction device, an induction device, a torch, a lens, an ion guide, an ion deflector, a collision cell, a collision-reaction cell, a mass analyzer, a detector, or other components of a mass spectrometer.

Referring now to FIG. 2A, a generalized mass spectrometer component 200 is shown that comprises a substrate 202 and a MS programmable element 204 disposed on the substrate 202. The MS programmable element 204 may take many forms and shapes and typically is designed to function and/or be controlled independently of the substrate 202. In some examples, the MS programmable element 204 comprises a conductive material so that the MS programmable element 204 can function as an electrode when a voltage is provided to the MS programmable element 204. The MS programmable element 204 and the substrate 202 are typically electrically decoupled from each other so a current does not flow between the substrate 202 and the MS programmable element 204. Various methods and materials to electrically decouple the MS programmable element 204 from the substrate 202 are discussed below and include the use of an insulating material, signal cancellation, and other means. In instances where the substrate 202 is non-conductive, the insulating material and/or active signal cancellation methods may not be present as current generally will not flow from the MS programmable element 204 to the substrate 202. The presence of the MS programmable element 204 permits the underlying substrate 202 to be produced from non-conductive materials and cheaper materials such as plastics, polymers and the like and permits formation of many different substrate shapes and configurations. For example, the substrate 202 itself may be a programmable substrate as discussed in more detail below. A power source 203 is shown as being electrically coupled to the MS programmable element 204 and may provide a voltage, current, radio frequencies or other signals to the MS programmable element 204. If desired, the power source 203 can also be electrically coupled to the substrate 202, or the substrate 202 may comprise its own respective power source separate from the power source 203. A processor 201 is electrically coupled to the power source 203 and/or the MSPE 204 to control the particular voltage or signals provided to the MSPE 204. In the other various illustrations of MSPE's described below, the power source and processor are omitted to increase the clarity of these figures, but a power source is typically also present to permit a voltage or other signal to be provided to the MSPE, the substrate or both, and a processor is also typically present in a system or device comprising the MSPE to control the various components of the system or device. For example, the MSPE may comprise its own respective processor or a processor present in a MS system may be used to control the MSPE.

In certain configurations, the mass spectrometer component may comprise two programmable mass spectrometer elements each configured as an electrode or otherwise capable of conducting a current. Referring to FIG. 2B, a mass spectrometer component 205 is shown that comprises a substrate 206, a first MS programmable element 207 configured as an electrode and a second MS programmable element 208 configured as an electrode. Each of the elements 207, 208 can be disposed on separate sites of the substrate 206 and may be present on the same surface of the substrate 206 or on different surfaces of the substrate 206 or may even be present on top of each other. In some examples, the MS programmable elements 207, 208 each comprises a conductive material (which can be the same or different) so that the MS programmable elements 207, 208 each can function as an electrode when a voltage is provided to the MS programmable elements 207, 208. In some instances, the elements 207, 208 are electrically coupled to each other, whereas in other instances, the elements 207, 208 are electrically decoupled from each other. In other examples, one or both of the elements 207, 208 can be electrically decoupled from the substrate 206. In instances where the substrate 206 is non-conductive, the insulating material and/or active signal cancellation methods may not be present as current generally will not flow from the MS programmable elements 207, 208 to the substrate 206. The presence of the MS programmable elements 207, 208 permits the underlying substrate 206 to be produced from non-conductive materials and cheaper materials such as plastics, polymers and the like and permits formation of many different substrate shapes and configurations. For example, the substrate 206 itself may be a programmable substrate as discussed in more detail below. While the elements 207, 208 are shown in FIG. 2B as generally having the same shape and dimensions, this configuration is not required as noted in more detail below.

In certain configurations, the mass spectrometer component may comprise three or more programmable mass spectrometer elements each configured as an electrode or otherwise capable of conducting a current. Referring to FIG. 2C, a mass spectrometer component 210 is shown that comprises a substrate 211, a first MS programmable element 212 configured as an electrode, a second MS programmable element 213 configured as an electrode, and a third MS programmable element 214 configured as an electrode. Each of the elements 212, 213, 214 can be disposed on separate sites of the substrate 210 and may be present on the same surface of the substrate 210 or on different surfaces of the substrate 210 or may even be present on top of each other. In some examples, the MS programmable elements 212, 213, 214 each comprises a conductive material (which can be the same or different) so that the MS programmable elements 212, 213, 214 each can function as an electrode when a voltage is provided to the MS programmable elements 212, 213, 214. In some instances, the elements 212, 213, 214 are electrically coupled to each other, whereas in other instances, the elements 212, 213, 214 are electrically decoupled from each other or at least two of the elements 212, 213, 214 are electrically decoupled from each other. In other examples, one, two or all of the elements 212, 213, 214 can be electrically decoupled from the substrate 210. In instances where the substrate 210 is non-conductive, the insulating material and/or active signal cancellation methods may not be present as current generally will not flow from the MS programmable elements 212, 213, 214 to the substrate 210. The presence of the MS programmable elements 212, 213, 214 permits the underlying substrate 210 to be produced from non-conductive materials and cheaper materials such as plastics, polymers and the like and permits formation of many different shapes and configurations. For example, the substrate 210 itself may be a programmable substrate as discussed in more detail below. While the elements 212, 213, 214 are shown in FIG. 2C as generally having the same shape and dimensions, this configuration is not required as noted in more detail below.

In certain examples, the MS programmable element can be configured as an electrode with many different shapes. Referring to FIG. 2D, a mass spectrometer component 215 is shown that comprises a substrate 216 and a MS programmable element 217 configured as a ring electrode disposed on the substrate 216. The MS programmable element 217 may take many forms and shapes and typically is designed to function and/or be controlled independently of the substrate 216. In some examples, the MS programmable element 217 comprises a conductive material so that the MS programmable element 217 can function as a ring electrode when a voltage is provided to the MS programmable element 217. The MS programmable element 217 and the substrate 216 are typically electrically decoupled from each other so a current does not flow between the substrate 216 and the MS programmable element 217. Various methods and materials to electrically decouple the MS programmable element 217 from the substrate 216 are discussed below and include the use of an insulating material, signal cancellation, and other means. In instances where the substrate 216 is non-conductive, the insulating material and/or active signal cancellation methods may not be present as current generally will not flow from the MS programmable element 217 to the substrate 216. The presence of the MS programmable element 217 permits the underlying substrate 216 to be produced from non-conductive materials and cheaper materials such as plastics, polymers and the like and permits formation of many different substrate shapes and configurations. For example, the substrate 216 itself may be a programmable substrate as discussed in more detail below.

Referring to FIG. 2E, a mass spectrometer component 220 is shown that comprises a substrate 221 and a MS programmable element 222 configured as a rectangular electrode disposed on the substrate 221. The MS programmable element 222 may take many forms and shapes, e.g., be square and comprise different heights, and typically is designed to function and/or be controlled independently of the substrate 221. In some examples, the MS programmable element 222 comprises a conductive material so that the MS programmable element 222 can function as a rectangular electrode when a voltage is provided to the MS programmable element 222. The MS programmable element 222 and the substrate 221 are typically electrically decoupled from each other so a current does not flow between the substrate 221 and the MS programmable element 222. Various methods and materials to electrically decouple the MS programmable element 222 from the substrate 221 are discussed below and include the use of an insulating material, signal cancellation, and other means. In instances where the substrate 221 is non-conductive, the insulating material and/or active signal cancellation methods may not be present as current generally will not flow from the MS programmable element 222 to the substrate 221. The presence of the MS programmable element 222 permits the underlying substrate 221 to be produced from non-conductive materials and cheaper materials such as plastics, polymers and the like and permits formation of many different substrate shapes and configurations. For example, the substrate 221 itself may be a programmable substrate as discussed in more detail below.

Referring to FIG. 2F, a mass spectrometer component 225 is shown that comprises a substrate 226 and a MS programmable element 227 configured as a triangular electrode disposed on the substrate 226. The MS programmable element 227 may take many forms and shapes, e.g., comprise different heights, and typically is designed to function and/or be controlled independently of the substrate 226. In some examples, the MS programmable element 227 comprises a conductive material so that the MS programmable element 227 can function as a triangular electrode when a voltage is provided to the MS programmable element 227. The MS programmable element 227 and the substrate 226 are typically electrically decoupled from each other so a current does not flow between the substrate 226 and the MS programmable element 227. Various methods and materials to electrically decouple the MS programmable element 227 from the substrate 226 are discussed below and include the use of an insulating material, signal cancellation, and other means. In instances where the substrate 226 is non-conductive, the insulating material and/or active signal cancellation methods may not be present as current generally will not flow from the MS programmable element 227 to the substrate 226. The presence of the MS programmable element 227 permits the underlying substrate 226 to be produced from non-conductive materials and cheaper materials such as plastics, polymers and the like and permits formation of many different substrate shapes and configurations. For example, the substrate 226 itself may be a programmable substrate as discussed in more detail below.

Referring to FIG. 2G, an illustration showing two mass spectrometer programmable elements each configured as ring electrodes is shown. A mass spectrometer component 230 is shown that comprises a substrate 231, a first MS programmable element 232 configured as a ring electrode disposed on the substrate 231, and a second MS programmable element 233 configured as a ring electrode disposed on the substrate 231. In this configuration, the elements 232, 233 are positioned beside each other. The MS programmable elements 232, 233 may each take many forms and shapes and typically are designed to function and/or be controlled independently of the substrate 231 and can be controlled independently of each other. In some examples, the MS programmable elements 232, 233 each comprises a conductive material so that the MS programmable elements 232, 233 can function as ring electrodes when a voltage is provided to the MS programmable elements 232, 233. The MS programmable elements 232, 233 and the substrate 231 are typically electrically decoupled from each other so a current does not flow between the substrate 231 and the MS programmable elements 232, 233. Various methods and materials to electrically decouple the MS programmable elements 232, 233 from the substrate 231 are discussed below and include the use of an insulating material, signal cancellation, and other means. In instances where the substrate 231 is non-conductive, the insulating material and/or active signal cancellation methods may not be present as current generally will not flow from the MS programmable elements 232, 233 to the substrate 231. The presence of the MS programmable elements 231, 232 permits the underlying substrate 231 to be produced from non-conductive materials and cheaper materials such as plastics, polymers and the like and permits formation of many different substrate shapes and configurations. For example, the substrate 231 itself may be a programmable substrate as discussed in more detail below.

Referring to FIG. 2H, another illustration showing two mass spectrometer programmable elements each configured as ring electrodes is shown. A mass spectrometer component 235 is shown that comprises a substrate 236, a first MS programmable element 237 configured as a ring electrode disposed on the substrate 236, and a second MS programmable element 238 configured as a ring electrode disposed on the substrate 236. In this configuration, the element 237 is shown as being positioned within the element 238. The MS programmable elements 237, 238 may each take many forms and shapes and typically are designed to function and/or be controlled independently of the substrate 236 and can be controlled independently of each other. In some examples, the MS programmable elements 237, 238 each comprises a conductive material so that the MS programmable elements 237, 238 can function as ring electrodes when a voltage is provided to the MS programmable elements 237, 238. The MS programmable elements 237, 238 and the substrate 236 are typically electrically decoupled from each other so a current does not flow between the substrate 236 and the MS programmable elements 237, 238. Various methods and materials to electrically decouple the MS programmable elements 237, 238 from the substrate 236 are discussed below and include the use of an insulating material, signal cancellation, and other means. In instances where the substrate 236 is non-conductive, the insulating material and/or active signal cancellation methods may not be present as current generally will not flow from the MS programmable elements 237, 238 to the substrate 236. The presence of the MS programmable elements 237, 238 permits the underlying substrate 236 to be produced from non-conductive materials and cheaper materials such as plastics, polymers and the like and permits formation of many different substrate shapes and configurations. For example, the substrate 236 itself may be a programmable substrate as discussed in more detail below.

FIG. 2I is an illustration showing mass spectrometer programmable elements configured as an electrode array. A mass spectrometer component 240 comprises a substrate 241 and MS programmable elements 242-249 each configured as a conductive element, e.g., an electrode, and each disposed at different areas on the substrate 241. The MS programmable elements 242-249 may each take many forms and shapes (which can be the same or can be different) and typically are designed to function and/or be controlled independently of the substrate 241 and can be controlled independently of each other. In some examples, the MS programmable elements 242-249 each comprises a conductive material (which can be the same or can be different) so that the MS programmable elements 242-249 can function as electrodes when a voltage is provided to the MS programmable elements 242-249. The MS programmable elements 242-249 and the substrate 241 are typically electrically decoupled from each other so a current does not flow between the substrate 241 and the MS programmable elements 242-249. Various methods and materials to electrically decouple the MS programmable elements 242-249 from the substrate 241 are discussed below and include the use of an insulating material, signal cancellation, and other means. In instances where the substrate 241 is non-conductive, the insulating material and/or active signal cancellation methods may not be present as current generally will not flow from the MS programmable elements 242-249 to the substrate 241. The presence of the MS programmable elements 242-249 permits the underlying substrate 241 to be produced from non-conductive materials and cheaper materials such as plastics, polymers and the like and permits formation of many different substrate shapes and configurations. For example, the substrate 241 itself may be a programmable substrate as discussed in more detail below. If desired, elements present in a row can be electrically coupled to each other or elements present in a column can be electrically coupled to each other. The columns and rows need not be arranged linearly as shown in FIG. 2I. In some embodiments, every other electrode (or some other grouping of electrodes) can be electrically coupled to each other. The exact number of elements present in each row and column can vary. In addition, different elements may have different shapes, heights or the like.

Referring to FIG. 2J, an illustration showing mass spectrometer programmable elements configured with different heights is shown. A mass spectrometer component 250 is shown that comprises a substrate 251, a first MS programmable element 252 configured as an electrode and a second MS programmable element 253 configured as an electrode. Each of the elements 252, 253 can be disposed on separate sites of the substrate 251 and may be present on the same surface of the substrate 251 or on different surfaces of the substrate 251 or may even be present on top of each other. In some examples, the MS programmable elements 252, 253 each comprises a conductive material (which can be the same or different) so that the MS programmable elements 252, 253 each can function as an electrode when a voltage is provided to the MS programmable elements 252, 253. The elements 252, 253 comprise different heights and, if desired, may comprise different shapes as well. In some instances, the elements 252, 253 are electrically coupled to each other, whereas in other instances, the elements 252, 253 are electrically decoupled from each other. In other examples, one or both of the elements 252, 253 can be electrically decoupled from the substrate 251. In instances where the substrate 251 is non-conductive, the insulating material and/or active signal cancellation methods may not be present as current generally will not flow from the MS programmable elements 252, 253 to the substrate 251. The presence of the MS programmable elements 252, 253 permits the underlying substrate 251 to be produced from non-conductive materials and cheaper materials such as plastics, polymers and the like and permits formation of many different substrate shapes and configurations. For example, the substrate 251 itself may be a programmable substrate as discussed in more detail below.

FIG. 2K is an illustration showing stacked mass spectrometer programmable elements. Where MS programmable elements are stacked, the MS programmable elements need not have the same shape or dimensions. Referring to FIG. 2K, a mass spectrometer component 255 is shown that comprises a substrate 256, a first MS programmable element 257 configured as an electrode and a second MS programmable element 258 configured as an electrode and stacked on the first programmable MS element 257. In some examples, the MS programmable elements 257, 258 each comprises a conductive material (which can be the same or different) so that the MS programmable elements 257, 258 each can function as an electrode when a voltage is provided to the MS programmable elements 257, 258. The elements 257, 258 comprise different heights and, if desired, may comprise different shapes as well. In some instances, the elements 257, 258 can be electrically coupled to each other, whereas in other instances, the elements 257, 258 are electrically decoupled from each other. For example, each of the elements 257, 258 can be separated from each other by an insulating material 259, air or can otherwise be electrically decoupled from each other. In other examples, one or both of the elements 257, 258 can be electrically decoupled from the substrate 256. In instances where the substrate 256 is non-conductive, the insulating material and/or active signal cancellation methods may not be present as current generally will not flow from the MS programmable elements 257, 258 to the substrate 256. The presence of the MS programmable elements 257, 258 permits the underlying substrate 256 to be produced from non-conductive materials and cheaper materials such as plastics, polymers and the like and permits formation of many different substrate shapes and configurations. For example, the substrate 256 itself may be a programmable substrate as discussed in more detail below. While two elements 257, 258 are shown as being stacked in FIG. 2K, more than two elements can be stacked as desired.

It will be recognized by the person of ordinary skill in the art, given the benefit of this disclosure, that FIGS. 2A-2K merely show some of the many different configurations where a MS programmable element can be disposed on a substrate to provide a MS component or be used with a MS component. Additional configurations of MS components that comprise a MS programmable element will be readily selected by the person of ordinary skill in the art, given the benefit of this disclosure.

Substrate Materials

In some embodiments, the substrates of the mass spectrometer components used herein can be produced from conductive or non-conductive materials depending on the particular function of that mass spectrometer component. In some embodiments, the substrate may comprise at least one metal, e.g., may comprise stainless steel, copper, silver, gold or other materials. In other examples, the substrates can be produced from materials which resist oxidation including aluminum, aluminum alloys, nickel-chromium alloys, lanthanides, actinides, titanium and other metals and non-metals which are generally non-reactive with oxygen or other materials introduced into the mass spectrometer. Where a conductive material is present in combination with a MS programmable element, a separate voltage (or common voltage) can be provided to the substrate and the MS programmable element so independently controllable electric fields (or magnetic fields) may be provided using the substrate and the MS programmable element. In other instances, the substrate material may comprise a polymeric material. For example, the presence of a MS programmable element can permit the substrate to be produced from non-conductive materials and any electric and/or magnetic fields which are present may be provided by the MS programmable element.

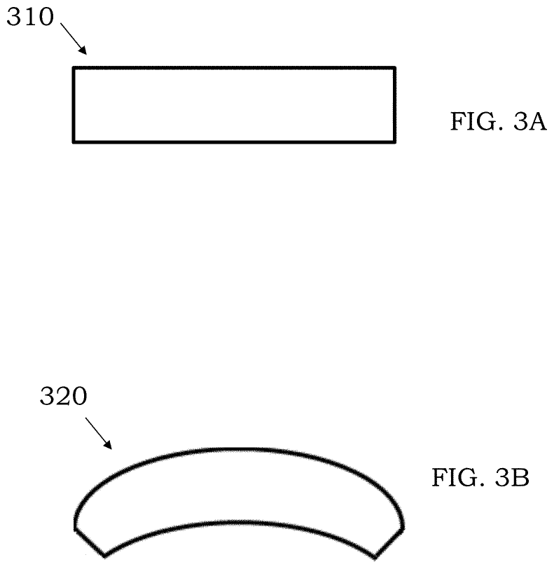

In some embodiments, the substrate itself may be programmable. A programmable substrate is a substrate whose shape, dimensions or properties can change upon application of a stimulus, e.g., a pressure change, a temperature change, application of a voltage, application of light, application of an electric field, application of a magnetic field, etc. In some examples, the substrate may comprise a shape memory material such as, for example, a shape memory polymer or a shape memory alloy which can receive a stimulus and alter the overall shape (and potentially the shape of the electric fields provided by the MS programmable element) of the mass spectrometer component. Illustrative shape memory polymers and shape memory alloys include, but are not limited to, copper-aluminum-nickel alloys, nickel-titanium alloys, iron-manganese silicon alloys, copper, zinc-aluminum alloys, copper-aluminum-nickel alloys, polyurethanes, polynorbornenes, polyethylene oxide based crosslinked shape memory polymers, polyethylene terephthalate crosslinked shape memory polymers, shape memory materials comprising cinnamic acid or cinnamylidene acetic acid, carbon nanotube composites, materials comprising carbon fibers, carbon black or nickel powder, materials comprising carbon nanoparticles, materials comprising magnetite nanoparticles, and other alloys and polymeric materials. Referring to FIGS. 3A and 3B, a programmable substrate is shown in a first state 310 at a first temperature. Upon heating of the programmable substrate, the substrate can alter its shape from the first state 310 to a second state or shape 320 (FIG. 3B). Application of the heat causes the substrate to deflect or bend and adopt a different shape, e.g. a non-planar shape, as shown in FIG. 3B. Depending on the type of material, the shape of the substrate may return to its state 310 upon cooling or may retain its shape 320 even after cooling. In some examples, the substrate shape can be convex, concave or take other forms after application of a voltage, heat, pressure, electric field, magnetic field or combinations thereof to the substrate.

In some examples, the shape memory materials such as, for example, shape memory polymers and shape memory alloys, may be one-way shape memory materials, e.g., one which will hold a particular its shape until a stimulus is provided, or a two-way shape memory material, e.g., one which remembers its original shape and automatically returns to its original shape when a stimulus is removed. In some examples where a shape memory material is present in a substrate, a stimulus from the MS programmable element itself can be used to alter the shape or the shape memory material, e.g., an electric field from the MSPE can be used as the stimulus.

In some embodiments, the substrate can function as a component of the mass spectrometer system and may be configured differently depending on the exact function that the component is intended to perform. The substrate generally is in contact with the MSPE, though as noted herein, intervening materials such as insulating materials or other materials can be present. The substrate and MSPE generally form an integral component that can provide a desired function in the system.

MS Programmable Element Materials and Production Methods

In certain embodiments, the MS programmable elements described herein can be produced using conductive and/or semi-conductive materials. For example, the MS programmable element materials may conduct a current and/or provide an electric field, magnetic field or both. In some examples, the MS programmable element may comprise at least one metal, e.g., may comprise stainless steel, copper, silver, gold or other materials. In other examples, the MS programmable element can be produced from materials which resist oxidation including aluminum, aluminum alloys, nickel-chromium alloys, lanthanides, actinides, titanium and other metals and non-metals which are generally non-reactive with oxygen or other materials introduced into the mass spectrometer. In other examples, the MS programmable element may comprise a shape memory material such as, for example, a shape memory polymer or a shape memory alloy which can receive a stimulus and alter its overall shape. Illustrative shape memory polymers and shape memory alloys that can be present in the MS programmable element include, but are not limited to, copper-aluminum-nickel alloys, nickel-titanium alloys, iron-manganese silicon alloys, copper, zinc-aluminum alloys, copper-aluminum-nickel alloys, polyurethanes, polynorbornenes, polyethylene oxide based crosslinked shape memory polymers, polyethylene terephthalate crosslinked shape memory polymers, shape memory materials comprising cinnamic acid or cinnamylidene acetic acid, carbon nanotube composites, materials comprising carbon fibers, carbon black or nickel powder, materials comprising carbon nanoparticles, materials comprising magnetite nanoparticles, and other alloys and polymeric materials.

In certain embodiments, the MS programmable element can be configured as a discrete electrode which can receive a voltage from a power source, e.g., a power source of the mass spectrometer or its own power source, and provide a field into (or adjacent to) some mass spectrometer component. In some embodiments, two or more MS programmable elements can function together to provide a field into some portion (or adjacent to some portion) of a mass spectrometer component. In other examples, three or more MS programmable elements can function together to provide a field into some portion (or adjacent to some portion) of a mass spectrometer component. The exact shape and arrangement of the MS programmable elements on any one surface of a mass spectrometer component may vary depending on the desired overall field shape or effect from the MS programmable element. MS programmable elements can be present on different surfaces of a substrate, at different heights, shapes, using different materials, etc.

In some examples, the MS programmable element can be produced using printed circuit board techniques to deposit or otherwise produce an electrode on a surface of a substrate. In other examples, the MS programmable elements can be vapor deposited, etched into a conductive layer of material, printed onto a substrate using suitable printing techniques such as three-dimensional printing or other techniques. The MS programmable elements are generally produced as individual elements, e.g., individual electrodes, on a surface of an underlying substrate, and can be electrically coupled to suitable power sources using interconnects or other suitable connections and couplings. Each MS programmable element can be controlled individually or can be controlled in groups of two or more if desired. Further, common or separate voltages can be provided to any of the MS programmable elements. In some examples, the MS programmable elements can be present as electrodes on a highly miniaturized integrated circuit, e.g., silicon IC, GaAs IC, SiGe IC, that is used with a substrate or placed on a substrate to function as a MS programmable element.

In certain examples, the exact voltage provided to the MS programmable elements may vary depending on the type of MSPE's which are present and the MS component that the MSPE's are present. In addition, the particular voltage provided may vary based on the size of any apertures which are present, e.g., a lens with a large aperture may use a higher voltage provided to the MSPE's to provide a desired effect. In some embodiments where a DC voltage is provided to the MSPE, the DC voltage may be about −1 kiloVolts to about +1 kiloVolts, e.g., about −100 Volts DC voltage to about +100 Volts DC voltage or about −50 Volts DC voltage to about +50 Volts DC voltage or about −10 Volts DC voltage to about +10 Volts DC voltage. Where an AC voltage is provided to the MSPE, the AC voltage may be about −2 kiloVolts to about +2 kiloVolts, e.g., about −500 Volts AC voltage to about +500 Volts AC voltage or about −100 Volts AC voltage to about +100 Volts AC voltage or about −50 Volts AC voltage to about +50 Volts AC voltage. Where a radio frequency (RF) voltage is provided to the MSPE, the RF voltage may be about −2 kilo Volts to about +2 kiloVolts, e.g., about −500 Volts RF voltage to about +500 Volts RF voltage or about −100 Volts RF voltage to about +100 Volts RF voltage or about −50 Volts RF voltage to about +50 Volts RF voltage. These voltages values are provided merely for illustration, and the skilled person will recognize, given the benefit of this disclosure, that voltages outside of these ranges could also be used depending on the particular configuration of the MS component comprises the MSPE.

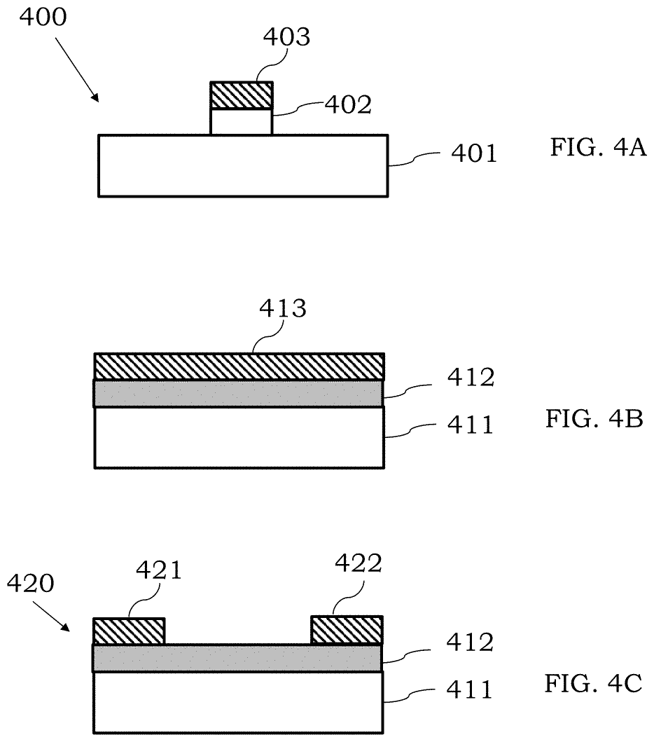

In producing the various MS programmable elements and substrates described herein various techniques can be used including printed circuit board production techniques, vapor deposition, etching, machining, lithography, three-dimensional printing, or other suitable techniques. The MSPE's and substrates can be produced using the same or different techniques. In one example, the MS programmable element may be present as a layer on a printed circuit board. Suitable electrical couplings can be present to electrically couple the MS programmable element to other interconnects present on the printed circuit board so a signal, e.g., a voltage, provided to the MS programmable element can be controlled by a processor present on the printed circuit board. In other instances, a mask may be disposed on a substrate and MS programmable elements can be vapor deposited on unmasked areas to form the MS programmable elements. Alternatively, and referring to FIGS. 4B and 4C, an entire layer of a conductive material 413 can be disposed on an insulating layer 413 on a substrate 411 and select areas may be etched away to provide a mass spectrometer component 420 comprising MS programmable elements 421, 422. In some examples, a conductive ink can be used to print the MS programmable elements on a surface of a substrate. Three-dimensional printing techniques can also be used to provide selected shapes and geometries for the MS programmable elements.

Electrical Decoupling

In certain embodiments, the MS programmable elements described herein can be electrically decoupled from the underlying substrate. Electrical decoupling may be achieved using materials, methods, devices, etc. In some examples, the electrical decoupling may be provided by including an insulating material between a MS programmable element and a substrate. Illustrative insulating materials are non-conductive materials such as, for example, glass, ceramics, rubber, elastomers, plastics such as polyvinyl chloride, paper, polytetrafluoroethylene, an air gap, a gas-filled gap (e.g., a gas other than ambient air) or other suitable insulating materials.

Referring to FIG. 4A, a MS programmable element 400 is shown that comprises a substrate 401, an insulating layer 402 and a MS programmable element 403 configured as an electrode disposed on the insulating layer 402. The insulating layer 402 can be disposed across an entire surface of the substrate 401 or only at areas where a MS programmable element 403 is present. The insulating layer 402 generally acts to prevent any current from passing between the substrate 401 and the MS programmable element 403 to permit independent voltages to be provided to the substrate 401 and the element 403 or to permit an independent voltage to only be provided to the MS programmable element 403. In producing the insulating layer 402, various techniques can be used including printed circuit board production techniques, vapor deposition, etching, machining, lithography, three-dimensional printing, or other suitable techniques. In one instance, the insulating layer may be present as a layer on a printed circuit board. Suitable electrical couplings can be present to electrically couple the MS programmable element to other interconnects present on the printed circuit board so a signal, e.g., a voltage, provided to the MS programmable element can be controlled by a processor present on the printed circuit board. In other instances, a mask may be disposed on a substrate, and an insulating layer can be vapor deposited on unmasked areas. In some examples, an insulating or non-conductive ink can be used to print the insulating layer on a surface of a substrate. Three-dimensional printing techniques can also be used to provide selected shapes and geometries for the insulating layer.

In some embodiments, active signal cancellation methods may be implemented to electrically decouple a MS programmable element from a substrate. For example, a transducer, magnetic field emitter or other suitable devices can be present to provide a signal to cancel out a voltage, RF signal or other signals so a signal provided to the substrate does not pass to the MS programmable element or vice versa. Without being bound by any one configuration, active signal cancellation may use a wave (or waveform) to cancel out a corresponding wave provided by the substrate, so the signal does not pass to the MS programmable substrate or vice versa. The waves provided by the signal cancellation device generally interferes with any signal from the substrate so the net wave or signal has zero amplitude or close to zero amplitude or intensity. In other instances, shielding may be present between the MS programmable element and the substrate so an electric or magnetic field from the substrate does not alter an electric or magnetic field provided by the MS programmable element. While electrical decoupling may be implemented in various configurations, if desired, the mass spectrometer component could be configured to provide a signal from a substrate to a MS programmable element. In such cases, the MS programmable element would be considered electrically coupled to the substrate.

Sample Introduction Devices

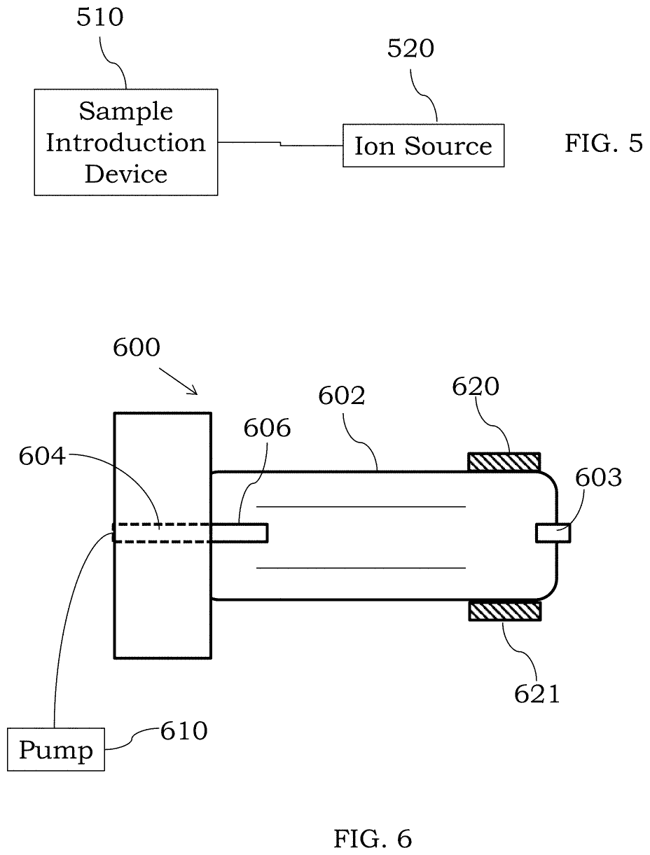

In certain embodiments, an MS programmable element can be present in or used with a sample introduction device. Without wishing to be bound by any one configuration, a sample introduction device generally is designed to introduce a liquid or gaseous sample into an ion source. A general schematic is shown in FIG. 5 where a sample introduction device 510 is fluidically coupled to an ion source 520 so that liquid or gaseous sample can be introduced into the ion source 520. The ion source 520 may comprise an inductively coupled plasma or ion sources other than an inductively coupled plasma, and illustrative ion sources are discussed in more detail below.

In some embodiments, the sample introduction device can be configured as a nebulizer as shown in FIG. 6. The nebulizer 600 can be configured as an induction nebulizer, a non-induction nebulizer or a hybrid of the two. For example, concentric, cross flow, entrained, V-groove, parallel path, enhanced parallel path, flow blurring and piezoelectric nebulizers can be used. In a simplified form, the nebulizer 600 comprises a tube or chamber 602 in which a sample is introduced through an inlet 606 or another tube 604. A gas may be introduced into the chamber 602 to entrain the introduced sample in the gas flow so the combination of gas and sample can be provided to an ion source through an outlet 603 of the tube 602. A pump 610 may be present and fluidically coupled to the nebulizer 600 to provide the sample into the chamber 602 through the inlet 606. The gas typically is introduced into the nebulizer 600 at a different port and can mix with the liquid sample before or after (or both) introduction of the liquid sample into the chamber 602. A first MS programmable element 620 and a second MS programmable element 621 are shown as being present. In some instances, an electric field can be provided by the elements 620, 621 to push charged analyte away from the walls of the chamber 602 and toward the outlet 603. The elements 620, 621 can be formed directly on (or be integral to) the chamber 602 so a user need not add the elements 620, 621 separately to provide a functioning nebulizer 600. While two elements 620, 621 are shown, fewer than two or more than two MS programmable elements may be present anywhere along the tube 602. If desired, a MS programmable element may also be present adjacent to or on the tube 604.

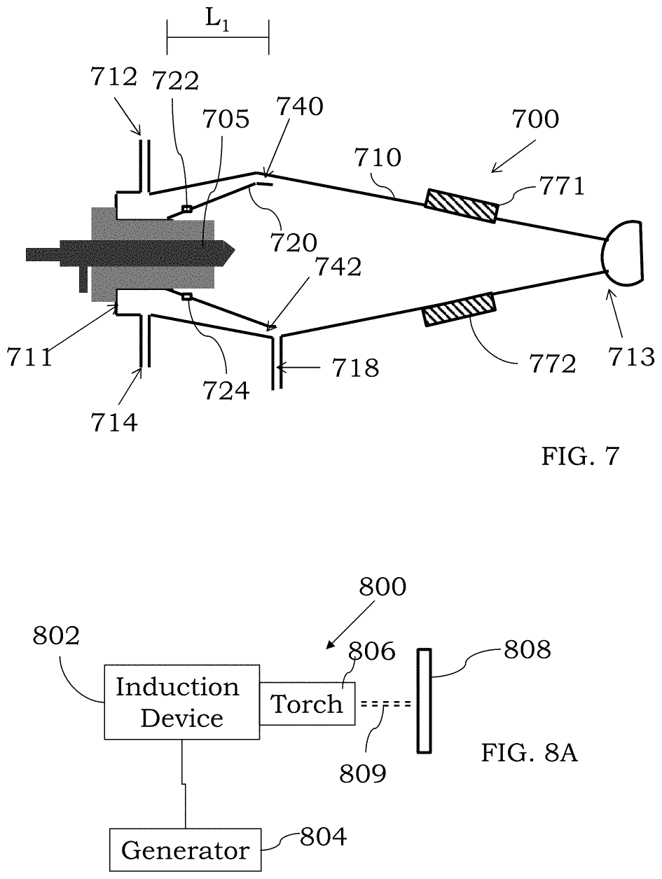

In certain embodiments, the sample introduction device can be configured as a spray chamber as shown in FIG. 7. The spray chamber generally comprises an outer chamber or tube 710 and an inner tube 720. The outer chamber 710 comprises dual makeup gas inlets 712, 714 and a drain 718. The makeup gas inlets 712, 714 are typically fluidically coupled to a common gas source, though different gases could be used if desired. While not required, the makeup gas inlets 712, 714 are shown as being positioned adjacent to an inlet end 711, though they could instead be positioned centrally or toward an outlet end 713. The inner tube 720 is positioned adjacent to a nebulizer tip 705 and comprises two or more microchannels 722, 724 configured to provide a makeup gas flow to reduce or prevent droplets from back flowing and/or depositing on the inner tube 720. The configuration and positioning of the inner tube 720 provides laminar flow at areas 740, 742 which acts to shield inner surfaces of the outer chamber 710 from any droplet deposition. The tangential gas flow provided by way of gas introduction into the spray chamber 700 through the inlets 712, 714 acts to select particles (or analyte molecules) of a certain size range. The microchannels 722, 724 in the inner tube 720 also are designed to permit the gas flows from the makeup gas inlets 712, 714 to shield the surfaces of the inner tube 720 from droplet deposition. In certain examples, the microchannels 722, 724 can be configured in a similar manner, e.g., have the same size and/or diameter, whereas in other configurations the microchannels 722, 724 may be sized or arranged differently. In some instances, at least two, three, four, five or more separate microchannels can be present in the inner tube 720. The exact size, form and shape of the microchannels may vary and each microchannel need not have the same size, form or shape. In some examples, different diameter microchannels may exist at different radial planes along a longitudinal axis L1 of the inner tube to provide a desired shielding effect. MS programmable elements 771, 772 are shown as being present and can be used to assist in keeping the particles off the surfaces of the outer tube 710 by providing an electric field into the outer tube 710 to direct the particles toward the outlet 713. While two MS programmable elements are shown, fewer than two or more than two MS programmable elements may be present if desired. In certain examples, the inner tube 720 is shown as having a generally increasing internal diameter along the longitudinal axis of the outer chamber 710, though as noted herein this dimensional change is not required. Some portion of the inner tube 710 may be “flat” or generally parallel with the longitudinal axis L1 to enhance the laminar flow, or in an alternative configuration, some portion of the inner tube 720 may generally be parallel to the surface of the outer tube 710, at least for some length, to enhance laminar flow. The inner diameter of the outer chamber increases from the inlet end 711 toward the outlet end 713 up to a point and then decreases toward the outlet end 713 such that the inner diameter of the outer chamber 710 is smaller at the outlet end 713 than at the inlet end 711. If desired, the inner diameter of the outer chamber 710 may remain constant from the inlet end 711 toward the outlet end 713 or may increase from the inlet end 711 toward the outlet end 713.

While nebulizers and spray chambers with MS programmable elements are described for illustration purposes, other sample introduction devices such as needles, inlets, injectors or other suitable devices which can provide a liquid or gas to an ionize source, may also comprise a MS programmable element.

Ion Sources

The programmable MS elements described herein can be used in various components present in an ion source including inductively coupled plasma (ICP) ion sources and ion sources other than inductively coupled plasma ion sources. Various illustration of ICP and non-ICP source components are described in more detail below.

ICP Source Components

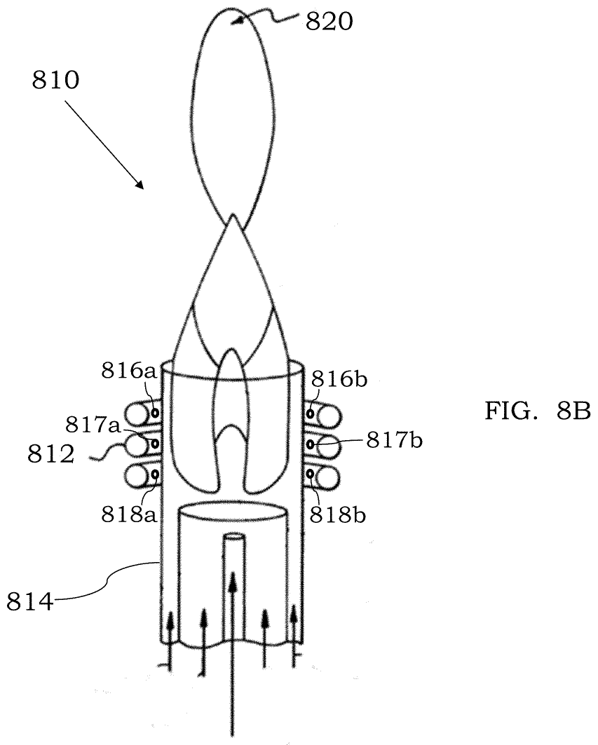

Various illustrations of ICP ion source components are discussed below. A generalized schematic of ICP ion source is shown in FIG. 8A. The ICP ion source 800 comprises an induction device 802 (and optionally a capacitive device (not shown)), and a generator 804 that can be electrically coupled to the induction device 802. The generator 804 can provide radio frequencies and/or a radio frequency voltage to the induction device 802 to provide radio frequency energy into a torch 806. A plasma gas can be provided into the torch 806 and ignited in the presence of the provided radio frequency energy from the induction device 802 to sustain a plasma within the torch 806. An optional interface 808 may be present at a terminal end of the torch 806 to permit collection of ions 809 and other species exiting the torch 806 and/or to block some portion of the ions 809 and/or the plasma from being provided to downstream components.

Referring to FIG. 8B, in one configuration of an ICP source 810, an induction device 812 may comprise at least one MS programmable element. The ICP source 810 comprises a torch 814 in combination with an induction coil 812. The induction coil 812 is typically electrically coupled to a radio frequency generator (not shown) to provide radio frequency energy into the torch 814 and sustain an inductively coupled plasma 820. A sample introduction device as described herein can be used to spray sample into the plasma 820 to ionize and/or atomize species in the sample. Metal species (or organic species) in the sample can be ionized or atomized and detected using optical techniques or mass spectrometry techniques or other suitable techniques. MS programmable elements 816a, 816b, 817a, 817b and 818a, 818b are shown as being present on surfaces of the induction coil 812. The MS programmable elements 816a, 816b, 817a, 817b and 818a, 818b can be electrically coupled to an RF generator (which can be the same or different than the RF generator electrically coupled to the coil 812) to independently provide RF energy into the torch 814. Each MS programmable element 816a, 816b, 817a, 817b and 818a, 818b could function independently of the other MS programmable elements or MS programmable elements present in a common radial plane, e.g., MS programmable elements 816a, 816b, may function together to provide RF energy into the torch 814.

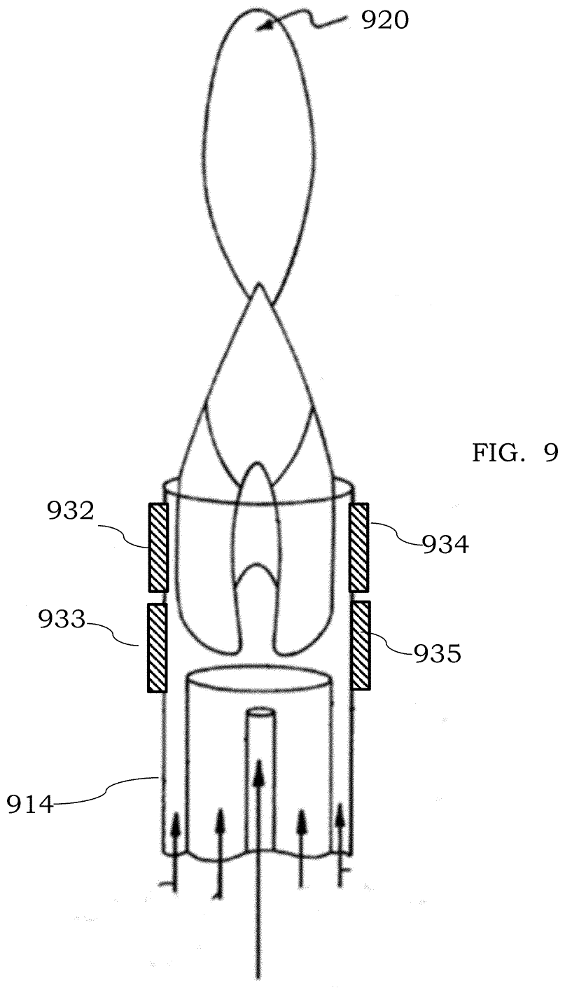

In certain embodiments, the MS programmable elements described herein could be used in place of an induction coil to provide RF energy into a torch. One illustration is shown in FIG. 9 where MS programmable elements 932, 933, 934 and 935 are disposed directly on the torch 914. For example, the elements 932-935 could be vapor deposited, printed, or otherwise added to a surface of the torch 914 and used to provide RF energy into the torch 914. In some embodiments, cooling apertures may be present in the MS programmable elements 932-935 to permit air to flow through them and reduce the likelihood of melting of the MS programmable elements 932-935. While not shown, an inductively coupled ion source could comprise an induction coil with one or more MS programmable elements and a torch with one or more MS programmable elements. Each of the MSPE's 932-935 could be deposited as thin conductive films to permit heat exchange and permit application of low powers, e.g., 200-300 Watts, to sustain a plasma in the torch 914.

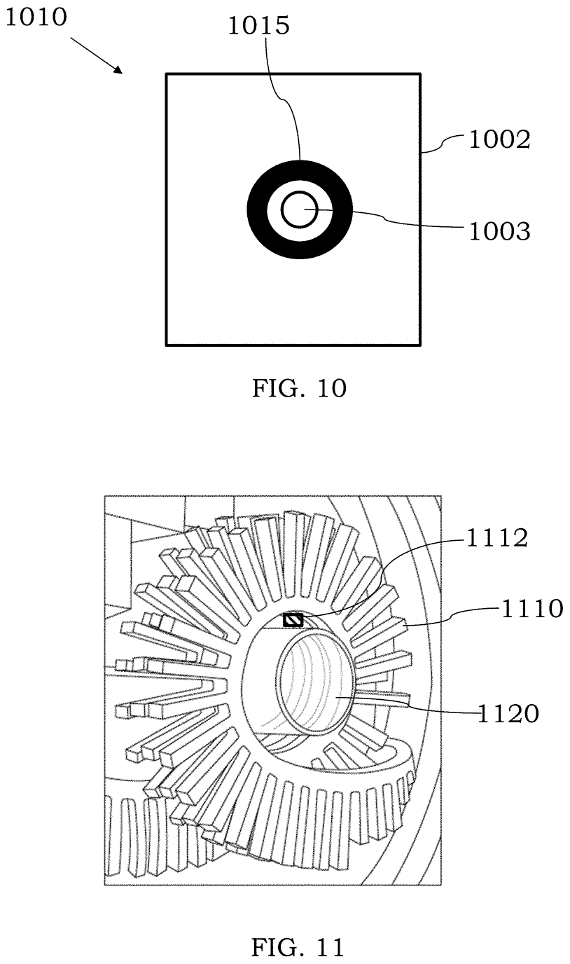

In some embodiments where an ICP source is used, an interface may be positioned adjacent to an exit of the torch to shield downstream components from the hot plasma and/or to terminate the plasma itself. One illustration of an interface is shown in FIG. 10. The interface 1010 comprises a generally planar substrate 1002 with an opening or aperture 1003 that is configured to receive ions from the ICP and provide them to a downstream component such as, for example, a sampling interface, skimmer cone, ion optics, a mass analyzer, etc. The interface 1010 is shown as comprising a MS programmable element 1015 configured as a ring electrode. A voltage can be provided to the element 1015 to assist in focusing the ion beam, rejecting or repelling ions of a certain charge and/or to otherwise sample only a center portion of an ion beam exiting the plasma. While a circular opening and circular ring electrode are shown in FIG. 10, these shapes are not required. Where a MS programmable element is present on an interface, a MS programmable element may also be present on one or more of an induction coil (or other induction device), a torch or both.

In certain embodiments, an induction coil may comprise a radial fin which may comprise a programmable MS element disposed on the radial fin. Referring to FIG. 11, an induction coil 1110 is shown that comprises a plurality of radial fins and a MS programmable element 1112 positioned adjacent to a torch 1120. The MS programmable element 1112 could instead be positioned anywhere on the induction coil 1110 and more than a single MS programmable element may also be present. The MS programmable element 1112 can be configured to provide a separate field or energy into the torch 1120 and is generally electrically decoupled from the remainder of the finned induction coil 1110.

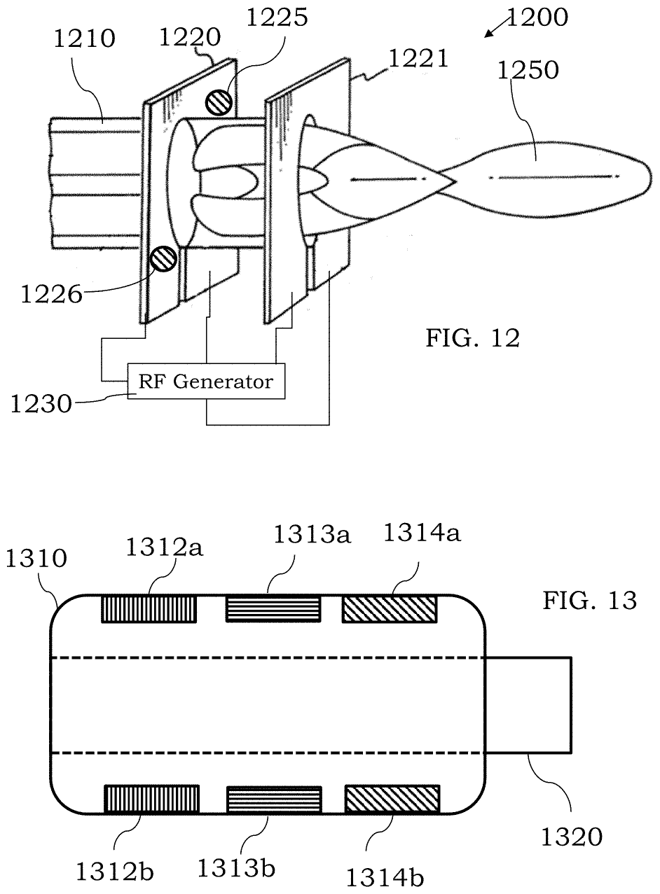

Referring now to FIG. 12, one illustration of an ICP source 1200 is shown that comprises plate electrodes 1220, 1221, at least one of which comprises MS programmable elements 1225, 1226. A first plate electrode 1220 and a second plate electrode 1221 are shown as comprising an aperture that can receive a torch 1210. For example, the torch 1210 can be placed within some region of an induction device comprising plate electrodes 1220, 1221. A plasma or other ionization/atomization source 1250 such as, for example, an inductively coupled plasma can be sustained using the torch 1210 and inductive energy from the plates 1220, 1221 and optionally energy from the elements 1225, 1226. A radio frequency generator 1230 is shown as electrically coupled to each of the plates 1220, 1221. If desired, only a single plate electrode could be used instead. A sample introduction device can be used to spray sample into the plasma 1250 to ionize and/or atomize species in the sample. Metal species (or organic species) in the sample can be ionized or atomized and detected using other components fluidically coupled to the ion source 1200.

Referring to FIG. 13, a cylindrical induction device 1310 is shown that comprises cylindrical MS programmable elements shown as sections 1312a, 1312b, 1313a, 1313b, 1314a and 1314b. Sections 1312a and 1312b form part of a ring induction device with a central aperture configured to receive a torch 1320. Sections 1313a and 1313b also form part of a ring induction device with a central aperture configured to receive the torch 1320. Sections 1314a and 1342b form part of a ring induction device with a central aperture configured to receive the torch 1320. Each of the sections can function independently or together to sustain an inductively coupled plasma in the torch 1320.

The illustrative configurations for the induction devices shown in FIGS. 8B-13, and other suitable induction devices comprising a MS programmable element, can be used in any of the ICP sources shown in FIGS. 8B-13 or other suitable ICP ion sources. The induction devices and/or torches used in the various ICP ion source may be conventional devices, e.g., Fassel torches, or other torches such as those, described, for example, in U.S. Pat. Nos. 7,511,246, 8,633,416,8,786,394,8,829,386, 9,433,702, 9,565,757 or similar devices.

Non-ICP Source Components

The MS programmable elements described herein can also be used in ion sources other than inductively coupled plasma ion sources. Illustrative sources other than inductively coupled plasma ion sources include, but are not limited to, electron ionization sources, chemical ionization sources, field ionization sources, photoionization sources, desorption ionization sources, spray ionization sources, thermal ionization sources and other ion sources which lack an inductively coupled plasma.

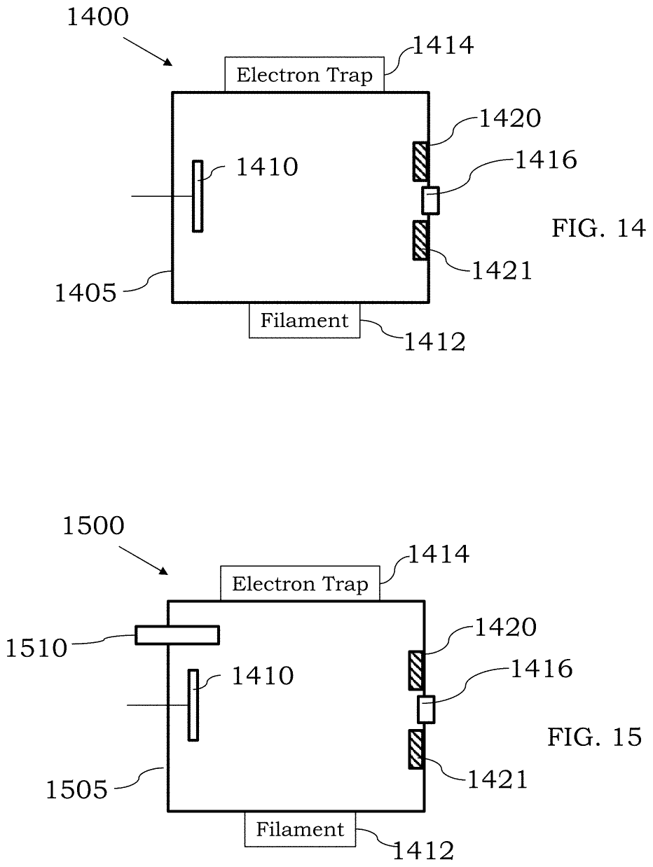

Referring to FIG. 14, an illustration of an electron ionization (EI) source comprising a MS programmable element is shown. The EI source 1400 comprises an ion repeller 1410, a filament 1412, an electron trap 1414 and an outlet 1416. A potential can be applied between the source block 1405 and the filament 1412 to provide electrons from the filament 1412 into the source block 1405, e.g., electrons that can travel toward the electron trap 1414. As sample is introduced into the source block 1405, it can collide with the electrons and become ionized. In this configuration, two MS programmable elements 1420, 1421 are shown as being positioned adjacent to an outlet 1416. The elements 1420, 1421 can be used to direct ions into the outlet 1416 and reduce an amount of ions being deposited on the interior surfaces of the source block 1405.

Referring to FIG. 15, an illustration of a chemical ionization (CI) source comprising a MS programmable element is shown. The CI source shares many of the same components of an EI source as described in reference to FIG. 14. The CI source 1500 also comprises a gas inlet configured to receive an ionization gas such as, for example, methane, ammonia, water, air or isobutane. CI sources work in a similar manner as EI but use ionized gas to promote formation of analyte ions. The MS programmable elements 1420, 1421 can be used to direct ions produced from chemical ionization processes into the outlet 1416 and reduce an amount of ions being deposited on the interior surfaces of the source block 1405.

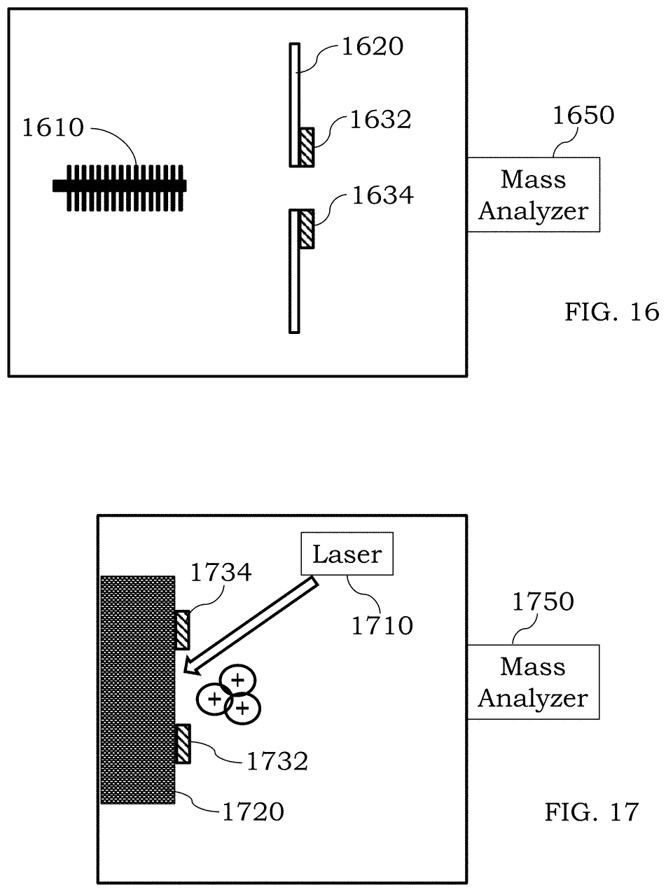

Referring to FIG. 16, an illustration of a field ionization source is shown that comprises a MS programmable element. The source 1600 comprises an emitter 1610 which typically has a high potential (20 kV) applied to it to provide an electric field that can ionize gaseous molecules. The gaseous molecules can be provided to a downstream mass analyzer 1650 through a lens 1620 comprising MS programmable elements 1632, 1634 disposed on a surface.

In some embodiments, the ion source maybe configured as a desorption ionization source. Illustrative desorption ionization sources include, but are not limited to, fast atom bombardment sources, secondary ion desorption sources, laser desorption sources, plasma desorption sources, and thermal desorption sources. Referring to FIG. 17, a laser desorption source is shown that comprises a laser light source 1710 that can be incident on a matrix 1720 comprising a sample. MS programmable elements 1732, 1734 can be disposed on, e.g., added, printed, etc., on the matrix to assist in guiding ions produced by the incident laser light away from the matrix 1720 and toward a downstream mass analyzer 1750. The MS programmable elements 1732, 1734 can, for example, be printed onto the matrix 1720 prior to use and may take many different shapes and forms.

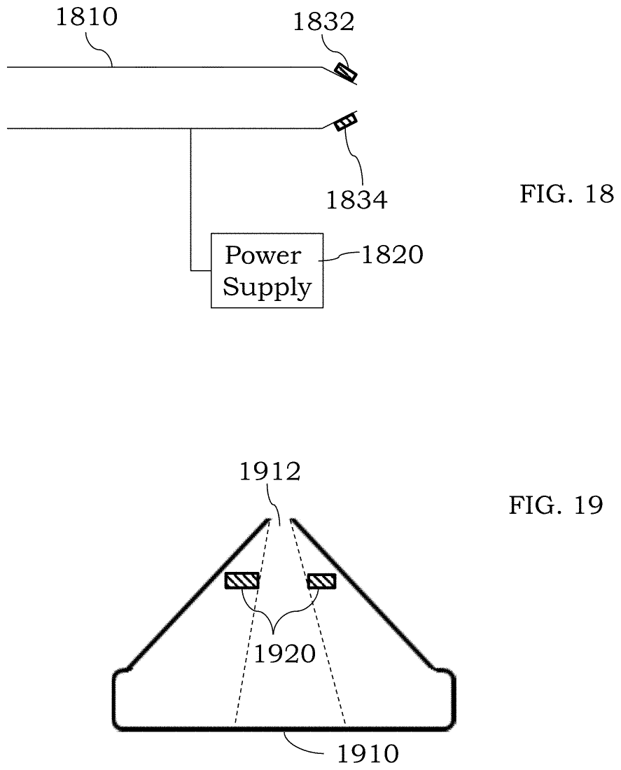

In some examples, a spray ionization source, e.g., an electrospray, thermospray or other spray ionization sources, may comprise one or more MS programmable elements. Referring to FIG. 18, an electrospray ionization (ESI) source is shown. The ESI source may comprise a capillary 1810 that can receive a sample and one or more gases. A voltage can be provided to the capillary 1810 from a power supply 1820 to charge the droplets that exit the capillary 1810. MS programmable elements 1832, 1834 are shown as being disposed on the surface of the capillary 1810 and are electrically decoupled from the capillary 1810. The voltage provided to the capillary 1810 and the gas flows act to provide an aerosol of the sample that can ionize in the gas phase. The MS programmable elements 1832, 1834 can assist in formation of the aerosol and/or direct the charged aerosol out of the capillary 1810.

While certain ion sources with MS programmable elements other than ICP sources have been described, additional suitable ion sources comprising MS programmable elements will be selected by the person of ordinary skill in the art, given the benefit of this description.

Interfaces

The MS programmable elements described herein may be present on various interfaces including sampling cones, skimmer cones and the like. While not wishing to be bound by any one configuration, the interfaces generally act to permit passage of only a portion of an entering ion beam to a downstream analyzer. In general, an interface comprises a housing and an opening that permits ions or other species to pass through. Some species may be incident on a surface of the interface and not be provided to downstream components of the system.

Referring to FIG. 19, a view of a sampling cone 1900 is shown that comprises a distal aperture 1910 in a tapered member body through which a spray or beam can pass through. While not required, a sampling cone is often used in combination with a skimmer cone. The sampling cone 1900 may comprise an exit orifice 1912 and a MS programmable element 1920, which in this configuration takes the form of a circular or ring electrode surrounding the inner cone. The MS programmable element 1920 can be used to guide or direct ions into the orifice 1912 to increase the efficiency in which ions are provided to a downstream component. While not shown, a skimmer cone can be configured in a similar manner as the sampling cone shown in FIG. 19.

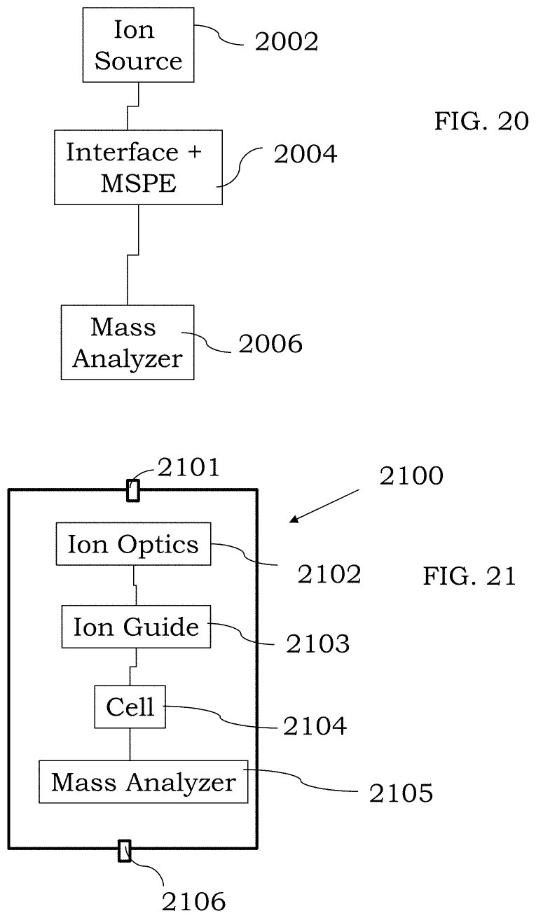

Referring to FIG. 20, an interface 2004 comprising the MS programmable element (MSPE) is typically positioned between an ion source 2002 and a mass analyzer 2006 though an interface could also be present between components of a mass analyzer or between a mass analyzer and a detector or between a sample introduction device and an ion source.

The interfaces that comprise a MS programmable element may take many different shapes and geometries and be planar, non-planar, conical, symmetric or asymmetric as desired.

Ion Optics and Mass Analyzers

In certain configurations, the MS programmable elements described herein can be used in one or more ion optics or components of a mass analyzer. While the exact components present in the ion optics and mass analyzer may vary depending on the type of analyte to be detected, one illustration of certain ion optics fluidically coupled to a mass analyzer is shown in FIG. 21. The exact configuration selected for any particular system may depend, for example, on the desired dynamic range, the desired analysis speed, the desired transmission rate, the desired accuracy, the desired resolution and/or other factors. In general, certain configurations of ion optics can act to reduce divergence of an ion beam to decrease the overall beam width that may enter into a downstream component. Referring to FIG. 21, a system 2100 generally comprises an inlet 2101 fluidically coupled to one or more ion optics 2102, an optional ion guide or deflector 2103, an optional collision cell 2104 (or a collision/reaction cell), a mass analyzer 2105, and an outlet 2106. While not shown, one or more mechanical and/or turbomolecular pumps may be fluidically coupled to any one or more of the components of FIG. 21 such that the components operate at reduced pressure, e.g., a pressure less than atmospheric pressure. If desired, a pressure gradient may exist from the inlet 2101 to the outlet 2106 to enhance flow of ions through the system 2100. Any one or more of the components 2102-2106 shown in FIG. 21 may comprise a MS programmable element.

In some examples, the ion optics 2102 comprises at least one MS programmable element. In other examples, the ion guide 2103 comprises at least one MS programmable element. In further examples, the cell 2104 comprises at least one MS programmable element. In additional examples, the mass analyzer 2105 comprises at least one MS programmable element. In other embodiments, the ion optics 2102 and at least one of the other components 2103, 2104, and 2105 comprises at least one MS programmable element. In other examples, the ion optics 2102 and at least two of the other components 2103, 2104, and 2105 comprises at least one MS programmable element. In further examples, the ion optics 2102 and all three of the other components 2103, 2104, and 2105 comprises at least one MS programmable element. In certain embodiments, the ion guide 2103 and at least one of the other components 2102, 2104, and 2105 comprises at least one MS programmable element. In other examples, the ion guide 2103 and at least two of the other components 2102, 2104, and 2105 comprises at least one MS programmable element. In further examples, the ion guide 2103 and all three of the other components 2102, 2104, and 2105 comprises at least one MS programmable element. In certain examples, the cell 2104 and at least one of the other components 2102, 2103, and 2105 comprises at least one MS programmable element. In other examples, the cell 2104 and at least two of the other components 2102, 2103, and 2105 comprises at least one MS programmable element. In further examples, the cell 2104 and all three of the other components 2102, 2103, and 2105 comprises at least one MS programmable element. In other examples, the mass analyzer 2105 and at least one of the other components 2102, 2103, and 2104 comprises at least one MS programmable element. In other examples, the mass analyzer 2105 and at least two of the other components 2102, 2103, and 2104 comprises at least one MS programmable element. In further examples, the mass analyzer 2105 and all three of the other components 2102, 2103, and 2104 comprises at least one MS programmable element.

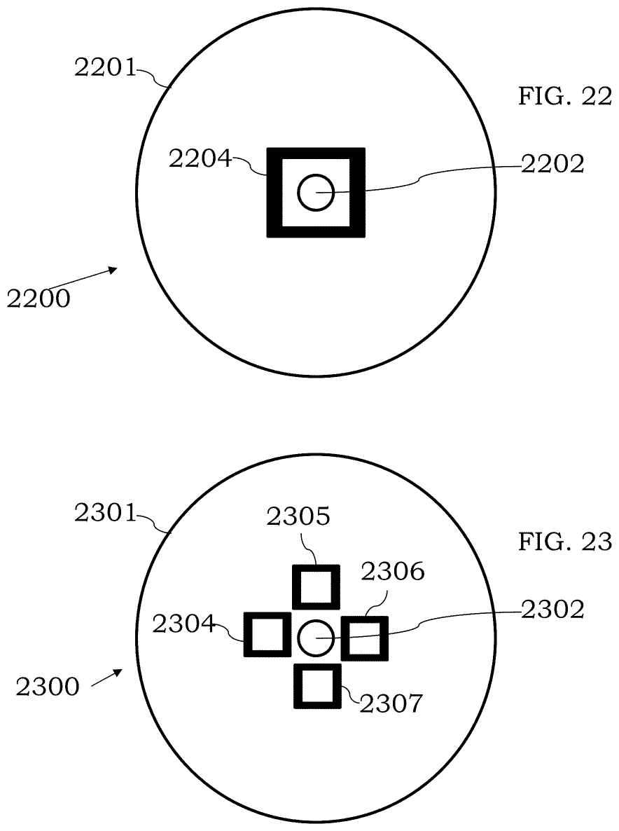

In certain examples, the ion optics may comprise one or more lenses as shown in FIG. 22. A single lens is shown for illustration in FIG. 22, but if desired a lens stack comprising two or more separate lenses may also be present. The lens 2200 generally comprises a planar substrate 2201 and at least one MS programmable element 2204 disposed on the planar substrate 2201. The MS programmable element 2204 is electrically decoupled from the planar substrate 2201 to permit a voltage to be provided to the element 2204 independent of any voltage provided to the substrate 2201. As noted herein, the element 2204 can be electrically decoupled from the substrate 2201 by using an insulating material between the element 2204 and the substrate 2201, using signal cancellation techniques or other means. If desired, the substrate 2201 of the lens 2200 may itself be programmable. The MS programmable element 2204 is shown as a square electrode positioned around an orifice 2202 in the lens 2200 though other shapes could be used instead. The MS programmable element 2204 can be used to direct ions toward the orifice 2202 in the lens 2200.

In some embodiments, more than a single MS programmable element can be present on a surface of a lens. Referring to FIG. 23, a lens 2300 comprises a substrate 2301, an orifice 2302 and MS programmable elements 2304, 2305, 2306 and 2307 positioned around the orifice 2302. Each of the elements 2304, 2305, 2306 and 2307 is shown as having the same shape and size though this configuration is not required and the elements 2304-2307 could have different shapes, heights and sizes. The MS programmable elements 2304-2307 are electrically decoupled from the planar substrate 2301 to permit a voltage to be provided to each of the elements 2304-2307 independent of any voltage provided to the substrate 2301. As noted herein, the elements 2304-2307 can be electrically decoupled from the substrate 2301 by using an insulating material between the elements 2304-2307 and the substrate 2301, using signal cancellation techniques or other means. If desired, the substrate 2301 of the lens 2300 may itself be programmable. The MS programmable elements 2304-2307 can be used to direct ions toward the orifice 2302 in the lens 2300. Alternatively, the MS programmable element 2304-2307 can be used to repel ions away from the orifice 2302.

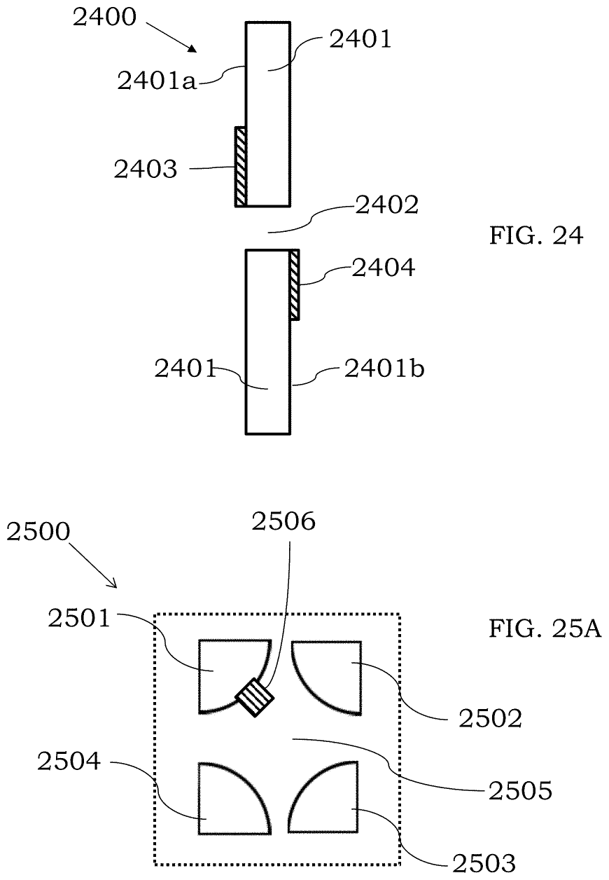

Another configuration of a lens is shown in the side view of FIG. 24 with MS programmable elements being disposed on opposite surfaces of a lens 2400. The lens 2400 comprises a substrate 2401 with an orifice 2402, a first MS programmable element 2403 disposed on one surface 2401a of the substrate 2401 and a second MS programmable element 2404 disposed on an opposite surface 2401b of the substrate 2401. The MS programmable elements 2403, 2404 are electrically decoupled from the planar substrate 2401 to permit a voltage to be provided to each of the elements 2403, 2404 independent of any voltage provided to the substrate 2401. As noted herein, the elements 2403, 2404 can be electrically decoupled from the substrate 2401 by using an insulating material between the elements 2403, 2404 and the substrate 2401, using signal cancellation techniques or other means. If desired, the substrate 2401 of the lens 2400 may itself be programmable. The MS programmable elements 2403, 2404 can be used to direct ions toward the orifice 2402 in the lens 2400. Alternatively, the MS programmable element 2403 can be used to direct ions toward the orifice 2402, and the MS programmable element 2404 can be used to repel ions away from the lens 2400 once they pass through the orifice 2402. If desired, the MSPE's 2403, 2404 could be disposed on the same surface or side of the substrate 2401.

Other lens configurations with one or more MS programmable elements can also be produced by the skilled person in the art using the information provided in this description. The exact number of MS programmable elements present on a lens may be one, two, three, four or more, and different MS elements can be positioned around each other or positioned separately from each other.

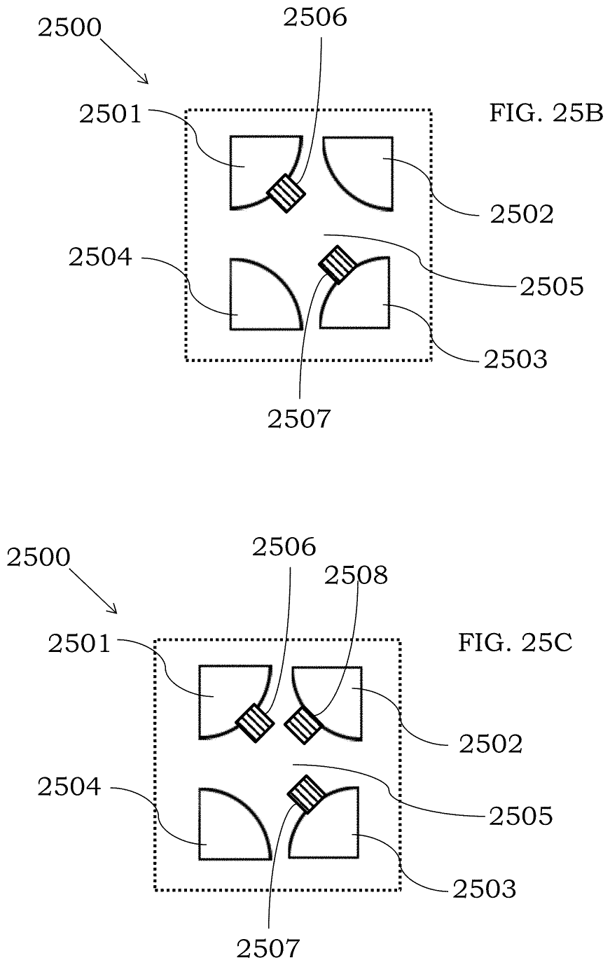

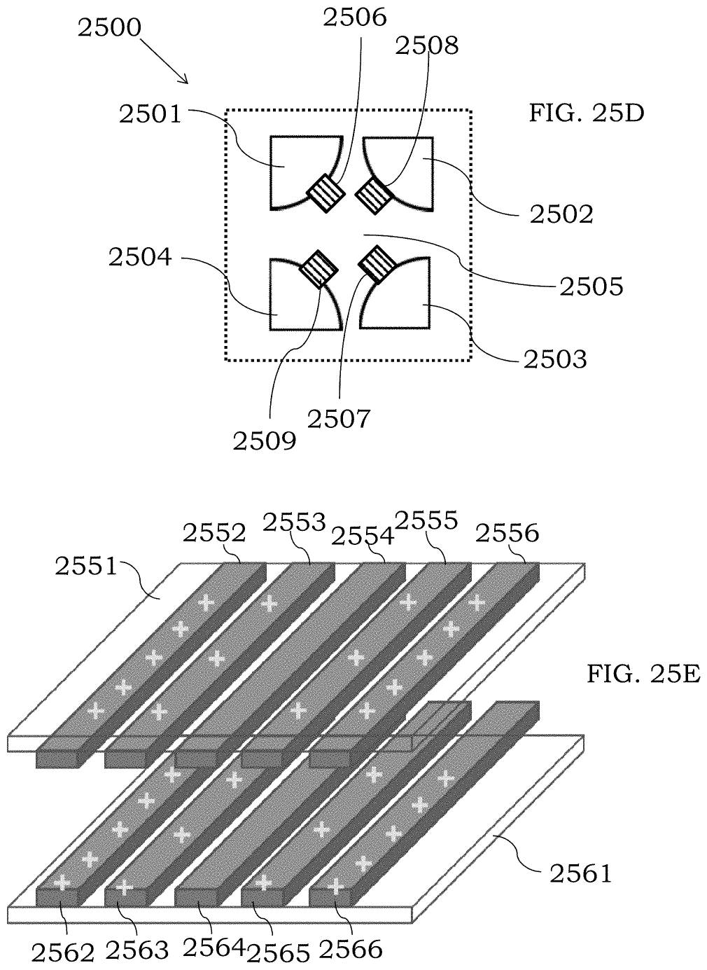

In some embodiments, the MS programmable elements described herein can be used in an ion guide or ion deflector. Without being bound by any one configuration, an ion guide or deflector generally is configured to focus or guide certain ions in one, two or more dimensions. In some examples, the ion guide may bend an incoming ion beam a desired number of degrees to assist in removal of photons and/or neutral species. Where an ion guide comprises a MS programmable element, the MS programmable element can be configured as an electrode that can function independently of the pole itself. For example, a first electric field may be provided by the pole and a second electric field can be provided by the MS programmable element to tune or alter the overall electric fields within the ion guide. One illustration of an ion guide 2500 is shown in FIG. 25A that comprises poles 2501, 2502, 2503 and 2504 to provide a quadrupolar ion guide. A MS programmable element 2506 is shown as being disposed on the pole 2501 and is electrically decoupled from the pole 2501 to permit the MS programmable element 2506 to function independently of the pole 2501. The presence of the MS programmable element 2506 also permits the pole 2501 to comprise or be made of a non-conductive material, since an electric field to guide ions can be provided by the MS programmable element 2506. The exact shape and positioning of the MS programmable element 2506 may vary and illustrative shapes can include square, circular, elliptical, conical, parabolic or other shapes. The MS programmable element 2506 can be positioned anywhere along the inner surface of the pole 2501 that is adjacent to an ion space 2505 formed by positioning of the poles 2501, 2502, 2503 and 2504. If desired, the MS programmable element 2505, the pole 2501 or both may comprise a programmable substrate that can receive a stimulus to alter the overall shape and/or properties of the substrate. In use of the ion guide 2500, ions can enter into the space 2505 and be guided or bent a desired number of degrees, e.g., 45 degrees, 60 degrees, 90 degrees, etc. The MS programmable element 2506 can be used to alter the particular angle that the beam is bent.

The exact number of MS programmable elements present in an ion guide may vary. Referring now to FIG. 25B, a quadrupolar ion guide where two MS programmable elements 2506, 2507 are present is shown. Referring to FIG. 25C, a quadrupolar ion guide where three MS programmable elements 2506, 2507, 2508 are present is shown. Referring to FIG. 25D, a quadrupolar ion guide where for MS programmable elements 2506, 2507, 2508, 2509 are present is shown. In addition, more than one MS programmable element can be present on any one pole of an ion guide, e.g., an array of MSPE's can be present on one, two, three or four poles of a quadrupolar ion guide.

In certain embodiments, the MS programmable elements present in an ion guide can be arranged at different heights or positions on a surface of the pole of an ion guide or may be present as an array of different programmable elements. In addition, while FIGS. 25A-25D show quadrupole ion guides as illustrations, dipoles, hexapoles, octopoles, decapoles, dodecapoles and other multi-pole ion guides instead may comprise one or more MS programmable elements. For example and referring to FIG. 25E, a dipole ion guide is shown comprising a first substrate 2551 and a second substrate 2561. The first substrate 2551 comprises a plurality of MS programmable elements 2552-2556 each of which can be electrically decoupled from the substrate 2551 and each of which is configured as an electrode. The second substrate 2561 comprises a plurality of MS programmable elements 2562-2566 each of which can be electrically decoupled from the substrate 2561 and each of which is configured as an electrode. In some instances and as described in more detail below, the center top and bottom electrodes (2554, 2564, respectively) can be provided with differential RF voltages. The outer electrodes can be gradually biased to be more positive to function as a potential wall (to trap the positive ions) within the center RF-powered electrodes. In some examples, one or more ion guides can be used in an ion multiplexer or ion switch to trap and/or select/guide ions from different ions sources to a common ion output. Alternatively, an ion guide can be used to receive ions from a single ion source and output ions two or more downstream components, e.g., two or more downstream detectors or mass analyzers. In certain embodiments, each ion guide in an ion multiplexer may be a dipole ion guide or one ion guide may be a dipole ion guide and another ion guide may be different than a dipole ion guide. Illustrations of an ion multiplexer comprising an ion guide are described below.

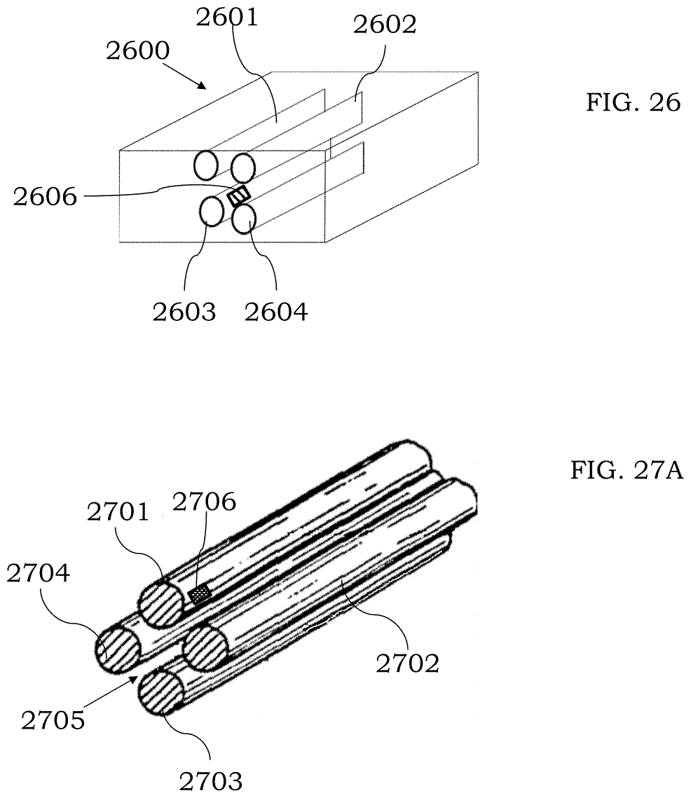

In certain embodiments, the MS programmable elements described herein can be present in a collision or collision/reaction cell. An illustration of a collision or collision reaction cell is shown in FIG. 26. FIG. 26 shows one example of a collision cell 2600 comprising a quadrupolar rod set 2601, 2602, 2603 and 2604. The rod 2603 comprises a MS programmable element 2606, which can be electrically decoupled from the rod 2603 and can be used to guide ions within the cell 2600 or can alter the electric field provided by the rods 2601, 2602, 2603, 2604. The collision cell 2600 can be configured as a collision/reaction cell as described, for example, in commonly assigned U.S. Pat. Nos. 8,426,804, 8,884,217 and 9,190,253. While FIG. 26 shows a quadrupolar collision or collision/reaction cells as illustrations, dipoles, hexapoles, octopoles, decapoles, dodecapoles and other multi-poles may be present in a collision or collision/reaction cell that comprises one or more MS programmable elements. In addition, two, three, four or more MS programmable elements can be present in the collision cell 2600 with any one or more of the rods 2601, 2602, 2603, 2604 comprising one, two, three or more MS programmable elements or the MS programmable elements can be present on separate rods.

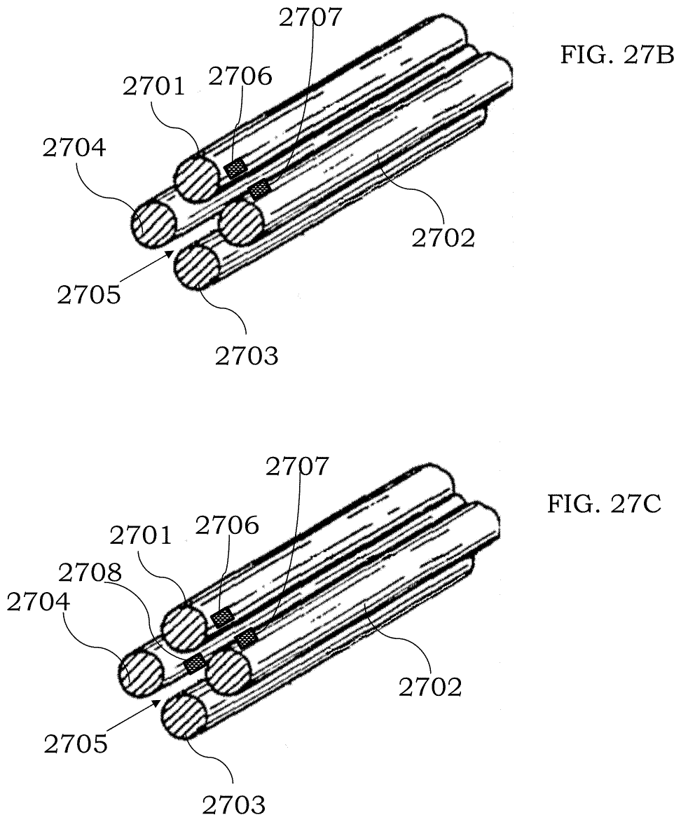

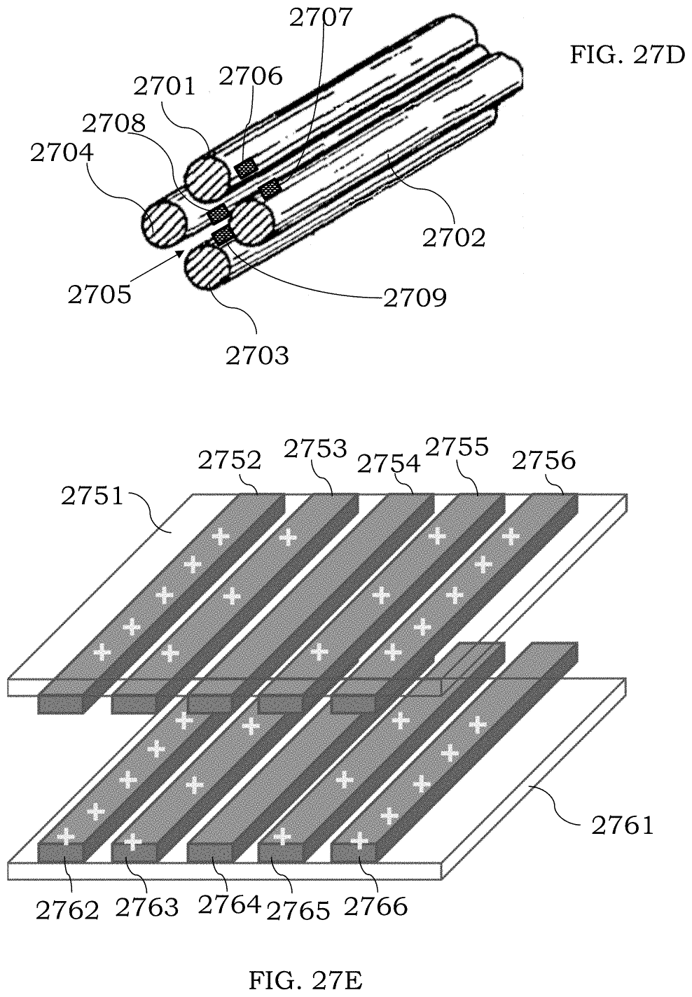

In certain configurations, the MS programmable elements described herein may be present in a mass analyzer. The phrase “mass analyzer” is used in a broad sense and intended to refer to a device that can separate ions, atoms and/or molecules according to differences in mass-to-charge ratios. In one example, a mass analyzer may take the form of a quadrupolar rod set as shown in FIG. 27A. The quadrupolar rod set comprises rods 2701, 2702, 2703 and 2704. Rod 2701 is shown as comprising a MS programmable element 2706 electrically decoupled from the rod 2701 so the MS programmable element 2706 can function independently of the rod 2701. While not shown, one or more ion optics are typically positioned upstream of the rods 2701, 2702, 2703, 2704 and a detector (or another mass analyzer) is positioned downstream of the rods 2701, 2702, 2703 and 2704. In one configuration of the rods 2701, 2702, 2703 and 2704, rods 2701, 2703 are electrically coupled to each other and rods 2702, 2704 are electrically coupled to each other, and a radio frequency (RF) voltage (typically with a DC offset voltage) can be provided between one pair of rods and the other pair of rods. Ions enter into the space 2705 between the rods 2701, 2702, 2703, and 2704 and travel in a longitudinal direction down the rods 2701, 2702, 2703 and 2704. For any particular voltage provided to the rods, only ions of a certain mass-to-charge (m/z) ratio will pass through and exit the rods and be provided to a detector or other component. The other ions collide with the rods and are removed from any ions which exit the quadrupolar rod set. Application of a different RF voltage to the rods 2701, 2702, 2703 and 2704 can permit selection of ions with a different m/z. The shape of the rods may vary and illustrative shapes include cylindrical shapes, hyperbolic shapes, etc. Where a MS programmable element 2706 is present on a surface of the rod 2701, the added electric field from the MS programmable element 2706 can provide a different field in the space 2705 than would exist in the absence of the MS programmable element. The MS programmable element 2706 can permit fine tuning or adjustment of the field at different areas between the rods 2701, 2702, 2703 and 2704 to clean up or alter any field defects or imperfections. The exact voltage provided to the MS programmable element 2706 may vary and includes, DC voltages, AC voltages and RF voltages. In addition, the overall shape, length, height, etc. of the MS programmable element may vary as desired. Further, more than a single MS programmable element may be present on a surface of the rod 2701, e.g., two, three, four or an array of MS programmable elements may be present on the rod 2701. Alternatively, a MS programmable element can be present on different rods as shown in FIGS. 27B-27D with MS programmable elements 2707, 2708 and 2709 being present in the different figures.

While FIGS. 27A-27D show quadrupolar mass analyzers as illustrations, dipole hexapole, octopole, decapole, dodecapole and other multi-pole analyzers may be present in a multi-pole analyzer that comprises one or more MS programmable elements. For example and referring to FIG. 27E, a dipole mass analyzer is shown comprising substrates 2751 and 2752 with substrate 2751 comprising MS programmable elements 2752-2756 each configured as an electrode. Substrate 2761 comprises MS programmable elements 2762-2766 each configured as an electrode. If the center top and bottom electrodes 2754, 2764 are driven by both differential RF and DC voltages from a power source, the structure shown in FIG. 27E can function as a dipole mass analyzer.

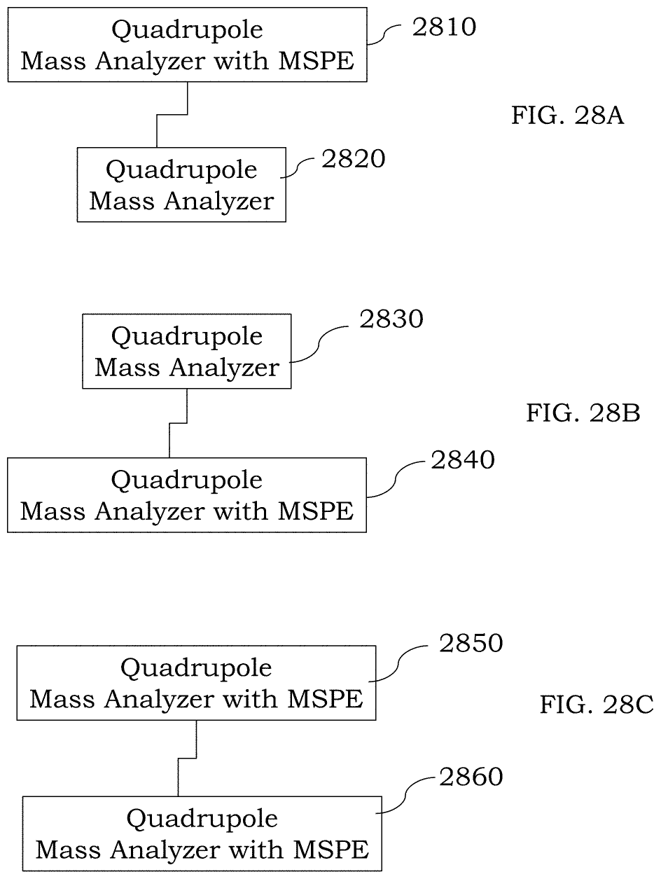

In certain configurations, a mass analyzer may comprise two separate quadrupole mass analyzers arranged in tandem. If desired, intervening components, e.g., ion traps, etc. may be present between the quadrupole mass analyzers or the quadrupole mass analyzers may be directly coupled to each other. Various configurations of double or two quadrupolar analyzers fluidically coupled to each other are shown in FIGS. 28A-28C. Referring to FIG. 28A, a dual quadrupole mass analyzer comprises a first quadrupole 2810 with a MS programmable element and a second quadrupole 2820 fluidically coupled to the first quadrupole 2810. The first quadrupole 2810 can receive ions from an ion source or components between an ion source and the quadrupole 2810. Alternatively, a dual quadrupole mass analyzer may comprise a first quadrupole 2830 fluidically coupled to a second quadrupole 2840 with a MS programmable element as shown in FIG. 28B. The first quadrupole 2830 can receive ions from an ion source or components between an ion source and the quadrupole 2830. In addition, in some configurations, a dual quadrupole mass analyzer may comprise a first quadrupole 2850 with a MS programmable element fluidically coupled to a second quadrupole 2860 with a MS programmable element as shown in FIG. 28C. The first quadrupole 2850 can receive ions from an ion source or components between an ion source and the quadrupole 2850. While FIGS. 28A-28C show two quadrupolar mass analyzers as illustrations, dipolar, hexapolar, octopolar, decapolar, dodecapolar and other multi-pole analyzers may be present in any one or both of two fluidically coupled multi-pole analyzers that comprises one or more MS programmable elements.

In certain configurations, a mass analyzer may comprise three separate quadrupoles arranged in series. If desired, intervening components, e.g., ion traps, etc. may be present between the three quadrupole mass analyzers or the three quadrupole mass analyzers may be directly coupled to each other without any intervening components.

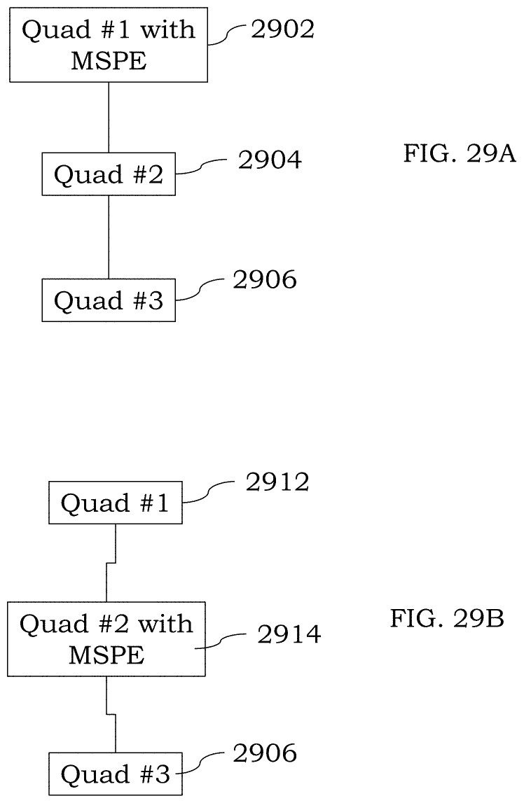

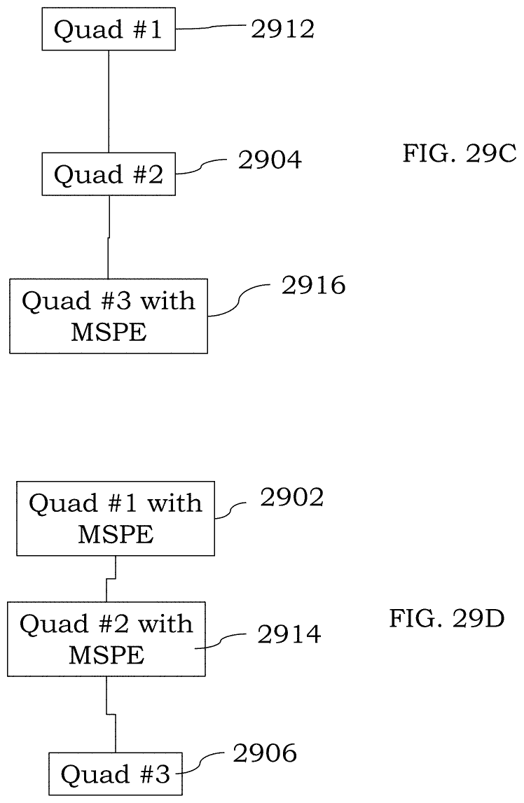

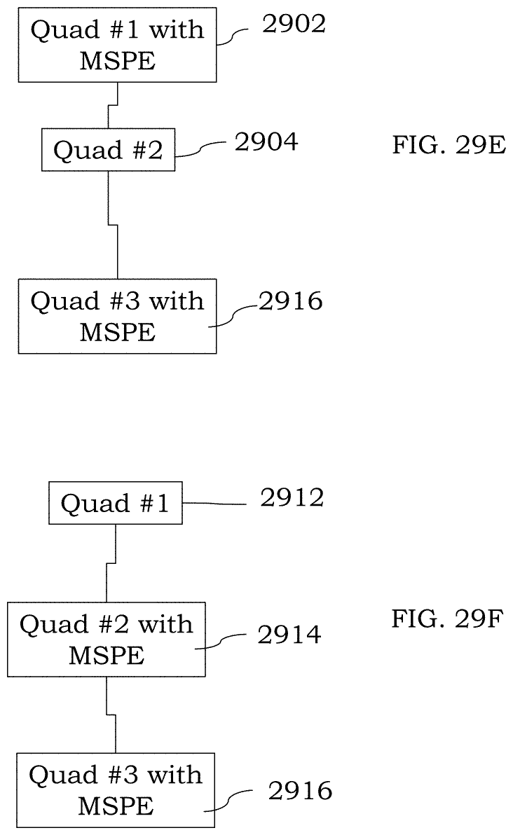

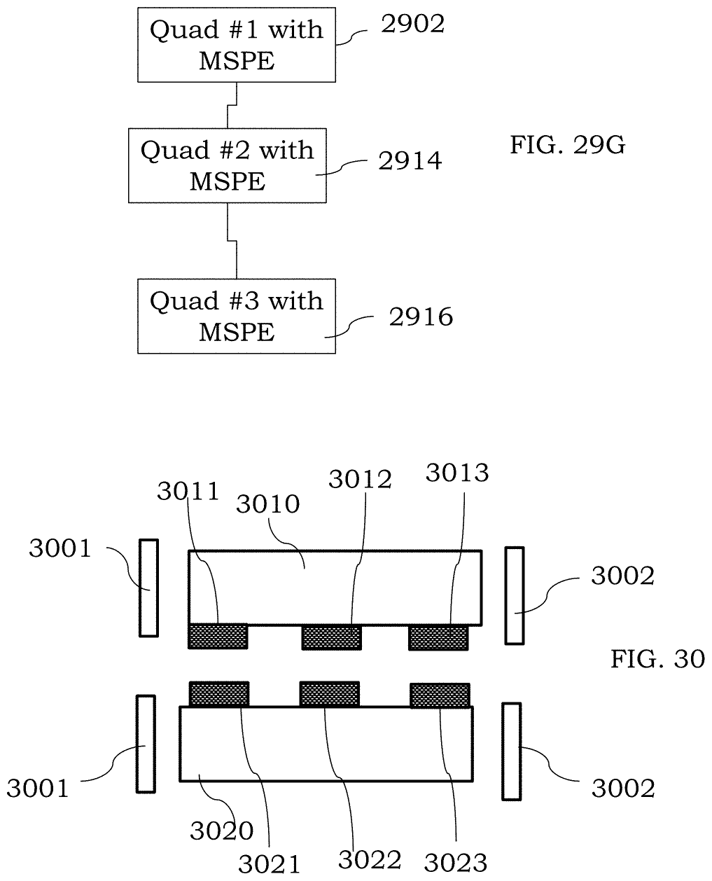

In some examples, various configurations of three or triple quadrupolar analyzers fluidically coupled to each other are shown in FIGS. 29A-29G. Referring to FIG. 29A, a first quadrupole 2902 comprises a MS programmable element and quadrupoles 2904, 2906 lack any MS programmable elements. The first quadrupole 2902 can receive ions from an ion source or components between an ion source and the quadrupole 2902. Referring to FIG. 29B, a second quadrupole 2914 comprises a MS programmable element and quadrupoles 2912, 2906 lack any MS programmable elements. The first quadrupole 2912 can receive ions from an ion source or components between an ion source and the quadrupole 2912. Referring to FIG. 29C, a third quadrupole 2916 comprises a MS programmable element and quadrupoles 2912, 2904 lack any MS programmable elements. The first quadrupole 2912 can receive ions from an ion source or components between an ion source and the quadrupole 2912. Referring to FIG. 29D, a first quadrupole 2902 and a second quadrupole 2914 each comprises a MS programmable element and quadrupole 2906 lacks any MS programmable elements. The first quadrupole 2902 can receive ions from an ion source or components between an ion source and the quadrupole 2902. Referring to FIG. 29E, a first quadrupole 2902 and a third quadrupole 2916 each comprises a MS programmable element and quadrupole 2904 lacks any MS programmable elements. The first quadrupole 2902 can receive ions from an ion source or components between an ion source and the quadrupole 2902. Referring to FIG. 29F, a second quadrupole 2914 and a third quadrupole 2916 each comprises a MS programmable element and quadrupole 2912 lacks any MS programmable elements. The first quadrupole 2912 can receive ions from an ion source or components between an ion source and the quadrupole 2912. Referring to FIG. 29G, a first quadrupole 2902, a second quadrupole 2914 and a third quadrupole 2916 each comprises a MS programmable element. The first quadrupole 2902 can receive ions from an ion source or components between an ion source and the quadrupole 2902. While FIGS. 29A-29G show three quadrupolar mass analyzers as illustrations, dipolar, hexapolar, octopolar, decapolar, dodecapolar and other multi-pole analyzers maybe present in any one, two or three of three fluidically coupled multi-pole analyzers that comprises one or more MS programmable elements.

In certain embodiments, a mass analyzer comprising a MS programmable element may be configured as an ion trap including linear traps, orbitraps and/or cyclotrons. The ion trap may take many forms including two-dimensional ion traps, three-dimensional ion traps and static traps such as an ion cyclotron trap. In general, ion traps function to “store” ions in the trap and manipulate the ions using DC and/or RF electric fields. Where a MS programmable element is present, the electric field from the MS programmable element can also be used to control or manipulate the ions within the trap. One illustration of a linear ion trap is shown in FIG. 30. The ion trap 3000 comprises lenses 3001 and 3002, substrates 3010 and 3020 each of which can independently be configured as planar substrates or rods, and MS programmable elements 3011, 3012 and 3013 on the substrate 3010 and MS programmable elements 3021, 3022, and 3023 on the substrate 3020. The ion trap 3000 can use RF voltages to trap the ions radially and use DC barriers from either the lenses 3001, 3002 or DC barriers created by the elements 3011, 3013, 3021 and 3023 to confine the ions within the trap 3000. The illustration in FIG. 30 is provided merely to discuss one of many different trap configurations that may comprise one or more MS programmable elements.

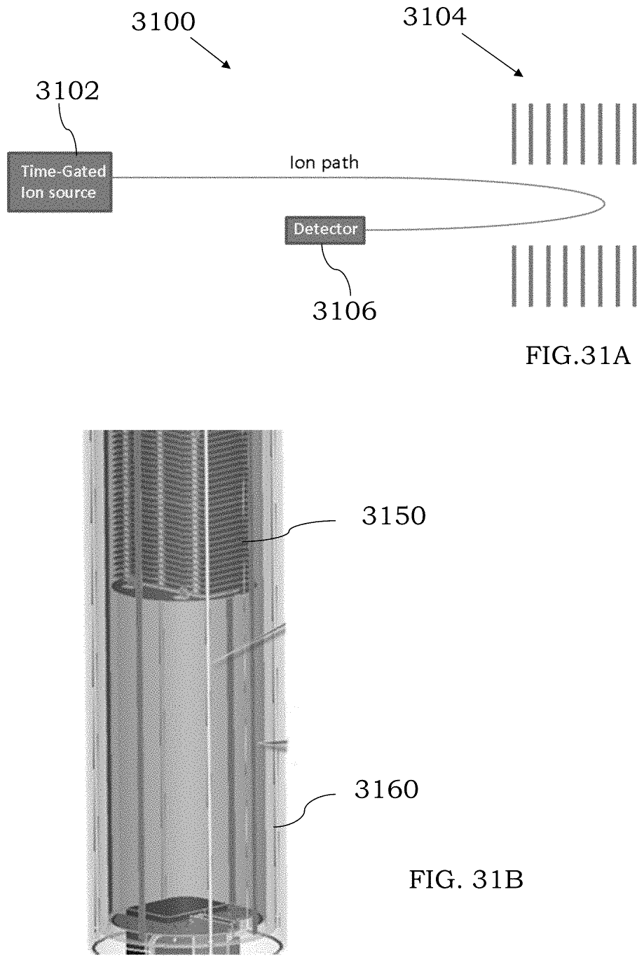

In some example, a mass analyzer comprising a MS programmable element may be configured as a time of flight device. Without being bound by any one configuration, a time of flight device measures the time it takes ions of different masses to travel from an ion source to a detector. Ions exiting an ion source can be provided to a reflectron assembly positioned within a flight tube. The reflectron assembly typically comprises a plurality of charged lenses any one or more of which may comprise a MS programmable element as described herein. For example and referring to FIG. 31A, a generalized time of flight device 3100 is shown that comprises a time-gated ion source 3102, a lens stack 3104 and a detector 3106. Any one of more of the lenses 3106 may comprise a MS programmable element as described herein. Referring now to FIG. 31B, a reflectron 3150 is shown that is positioned in a flight tube 3160. One or more (or all) of the lenses of the reflectron 3150 may comprise a MS programmable element on one or more surfaces.

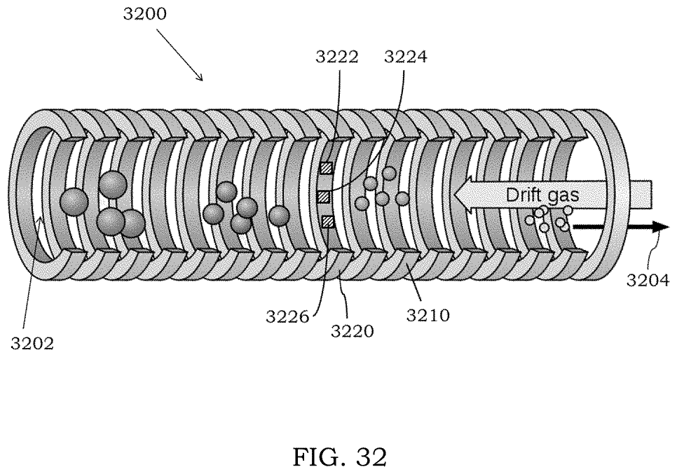

In some examples, the MSPE's described herein can be used in an ion mobility mass spectrometer (IMMS) system or some components thereof. Referring to FIG. 32, a drift tube 3200 is shown that comprises a plurality of focusing rings such as, for example, focusing rings 3210 and 3220. In general, the IMMS system can measure how long it takes for ions to traverse a selected length in a uniform electric field through a selected atmosphere. An electric field generally is provided from an inlet 3202 to an outlet 3204 (shown as the darkened arrow on the right of the figure) of the drift tube 3200. In this illustration, MSPE's 3222, 3224 and 3246 are shown as being present on the focusing ring 3220 and are typically electrically decoupled from the focusing ring 3220 so an independent voltage can be provided to each of the MSPE's 3222, 3224 and 3226. Insulating materials, signal cancellation or other means can be used to provide such electrical decoupling. A drift gas can be introduced into the tube 3200, and a gating mechanism may be used to introduce ions into the tube 3200. The ions in the drift tube are driven through the tube 3200 using the electric fields from the focusing rings and/or the MSPE's 3222, 3224 and 3226 and interact with neutral drift molecules in the atmosphere within the drift tube 3200. The ions separate based on ion mobility and can exit the drift tube 3200 at an outlet 3204 and be detected or counted by a detector (not shown) fluidically coupled to the drift tube 3200. Faster ions (higher mobility) arrive at the detector first. The exact number of MSPE's present on any one focusing ring of a drift tube can be fewer than three or more than three. In some embodiments, two or more different focusing rings of the drift tube may comprise one or more respective MSPE's. In other examples, each focusing ring of the drift tube may comprise one or more respective MSPE's. The pressure within the drift tube 3200 can be varied to provide a desired resolution. In some instances, the MSPE's can be used to provide asymmetric electric fields within the drift tube 3200 to provide some ion filtering by the drift tube 3200. The drift gas can be introduced anti-parallel, parallel, perpendicular or at other angles to the flow of ions within the drift tube 3200. Illustrative drift gases include, for example, helium, carbon dioxide, nitrogen and argon.

The person of ordinary skill in the art, given the benefit of this disclosure, will be able to design other mass analyzers comprising one or more MS programmable elements including, but not limited to, scanning mass analyzers or other mass analyzers. For example, in certain embodiments, a mass analyzer comprising a MS programmable element may be configured a scanning analyzer or a scanning sector analyzer, e.g. a magnetic sector analyzer. Without wishing to be bound by any one configuration, a magnetic scanning sector analyzer generally uses electromagnetic fields to separate ions according to the mass-to-charge ratios and uses a slit to select which mass-to-charge ratio is provided to a detector. One or more MS programmable elements can be present in a magnetic sector portion of the magnetic sector analyzer to further tune or adjust the ion trajectories within the sector analyzer. Alternatively, or in addition, a MS programmable element may be present in an electric sector of a scanning sector analyzer where a double focusing magnetic sector analyzer is used.

Detectors and Detector Components

In certain configurations, the MS programmable elements described herein may be present in one or more detectors that can be used with a mass analyzer to detect ions. Illustrative detectors include, but are not limited to, electron multipliers, Faraday cups, multi-channel plates or even solid state detectors, e.g., those which use metal-oxide-semiconductor (MOS) capacitors, complimentary metal-oxide-semiconductor (CMOS) transistor, or a metal-oxide-semiconductor field effect transistors (MOSFET) or other solid state devices that can convert incident ions to electrical signals, or detector arrays, e.g., charge-coupled device array cameras or detectors.

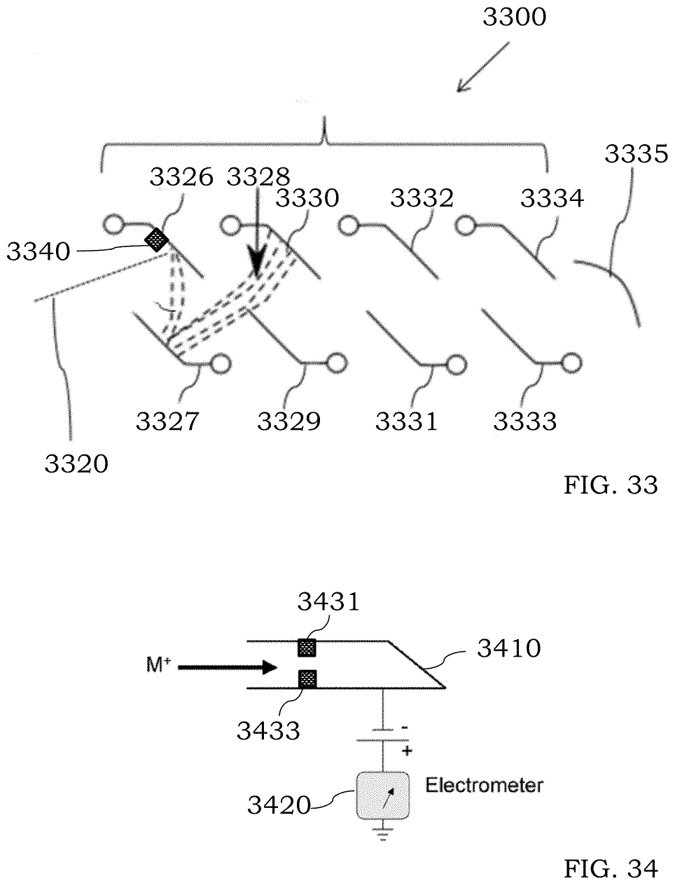

A simplified illustration of an electron multiplier is shown in FIG. 33. The electron multiplier 3300 comprises an optional collector (or anode) 3335 and a plurality of dynodes 3326-3333 upstream of the collector 3335. While not shown, the components of the EM detector 3300 would typically be positioned within a tube or housing (under vacuum) and may also include a focusing lenses or other components to provide the ion beam 3320 to the first dynode 3326 at a suitable angle. Where a focusing lens is present, the focusing lens may comprise a MSPE if desired. In use of the EM detector 3300, an ion beam 3320 is incident on the first dynode 3326, which converts the ion signal into an electrical signal shown as beam 3322 by way of the photoelectric effect. In some embodiments, the dynode 3326 (and dynodes 3327-3334) can include a thin film of material on an incident surface that can receive ions and cause a corresponding ejection of electrons from the surface. The energy from the ion beam 3320 is converted by the dynode 3326 into an electrical signal by emission of electrons. The exact number of electrons ejected per ion depends, at least in part, on the work function of the material and the energy of the incident ion. The secondary electrons emitted by the dynode 3326 are emitted in the general direction of downstream dynode 3327. For example, a voltage-divider circuit, or other suitable circuitry, can be used to provide a more positive voltage for each downstream dynode. The potential difference between the dynode 3326 and the dynode 3327 causes electrons ejected from the dynode 3326 to be accelerated toward the dynode 3327. The exact level of acceleration depends, at least in part, on the gain used. Dynode 3327 is typically held at a more positive voltage than dynode 3326, e.g., 100 to 200 Volts more positive, to cause acceleration of electrons emitted by dynode 3326 toward dynode 3327. As electrons are emitted from the dynode 3327, they are accelerated toward downstream dynode 3328 as shown by beams 3340. A cascade mechanism is provided where each successive dynode stage emits more electrons than the number of electrons emitted by an upstream dynode. The resulting amplified signal can be provided to the optional collector 3335, which typically outputs the current to an external circuit through one or more electrical couplers of the EM detector 3300. The current measured at the collector 3335 can be used to determine the amount of ions that arrive per second, the amount of a particular ion, e.g., a particular ion with a selected mass-to-charge ratio, that is present in the sample or other attributes of the ions. If desired, the measured current can be used to quantitate the concentration or amount of ions using conventional standard curve techniques. In general, the detected current depends on the number of electrons ejected from the dynode 3326, which is proportional to the number of incident ions and the gain of the EM device 3300. Gain is typically defined as the number of electrons collected at the collector 3335 relative to the number of electrons ejected from the dynode 3326. For example, if 5 electrons are emitted at each dynode, and the device 3300 includes 8 total dynodes, then the gain is 5⁸ or about 390,000. The gain is dependent on the voltage applied to the device 3300. For example, if the voltage is increased, the potential differences between dynodes are increased, which results in an increase in incident energy of electrons striking a particular dynode stage. In some examples, one or more of the dynodes 3326-3335 may comprise a MS programmable element as described herein. For illustration purposes, one MS programmable element 3340 is shown as being present on the first dynode 3326. The MS programmable element 3340 can be used to guide incoming ions (or emitted electrons) toward a particular site or area on the dynodes. This area can be periodically changed to extend the lifetime of the EM dynodes. Alternatively, an electric field provided by the MS programmable element 3340 can be used to defocus ions (or emitted electrons) and spread them out over a wider area on the surface of the dynodes, e.g., promote divergence of the beam. While not shown, a MSPE could also be present between any one or more of the dynodes 3326-3334 if desired.

In another illustration, a Faraday Cup detector may comprise one or more MS programmable elements. Referring to FIG. 34, a Faraday cup 3410 is shown that can catch ions in a vacuum and measure the resulting current to count or determine the number of ions hitting the cup. The cup 3410 is electrically coupled to an electrometer 3420 to measure the ions. MS programmable elements 3431, 3433 are shown as being present in the cup 3410 and can provide an electric field to guide the ions or can even be used to reject ions having a kinetic energy below a desired value. The elements 3431, 3433 are typically electrically decoupled from the cup 3410 so that a separate voltage can be provided to the elements 3431, 3433. The exact number and shapes of the MS programmable elements in a Faraday cup may vary.

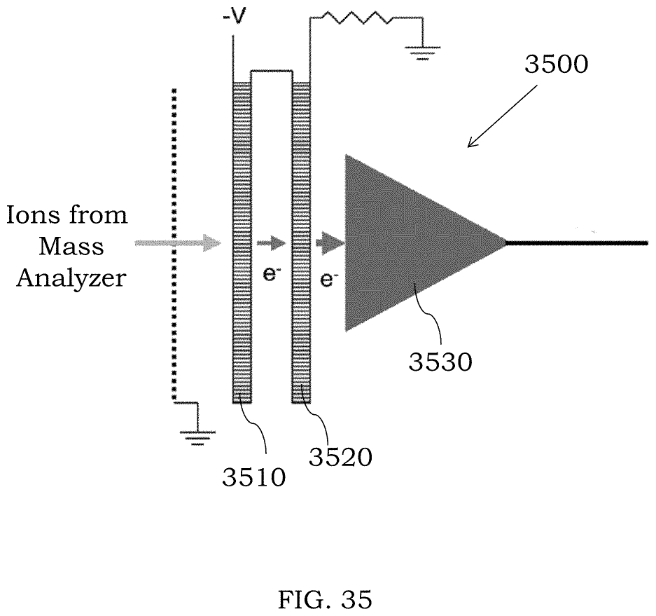

In other configurations, a MS programmable element may be present on a microchannel plate (MCP) detector. Referring to FIG. 35, a dual microchannel plate detector 3500 is shown comprising microchannel plates 3510, 3520 and an anode 3530. The plates 3510, 3520 can function to amplify incoming ions by converting the ions into a cloud of electrons. By applying a strong electric field across the MCP, each individual microchannel becomes a continuous-dynode electron multiplier. One or more MS programmable elements may be present or used with the plate 3510 or the plate 3520 (or both) to tune or alter the electric field experienced by the plates 3510, 3520. Electrons exit the channels of the plates 3510, 3520 on the opposite side of the plate where they are collected on the anode 3530. If desired, each of the plates 3510, 3520 may comprise its own MS programmable element. In some examples, one or more channels present on the plates 3510, 3520 may comprise a MS programmable element. If desired, each channel of a multi-channel plate detector may comprise a respective MS programmable element. The MCP detector could also be configured as a Chevron MCP, a Z-stack MCP or other suitable ion detectors comprising one or more multi-channel plates.

Systems Including MS Programmable Elements

Various instruments and systems can be produced using the components described herein. In a typical system, a sample comprising one or more analytes (which may be known or unknown) is introduced into the system and the analyte(s) identity and/or amount is measured by the system.

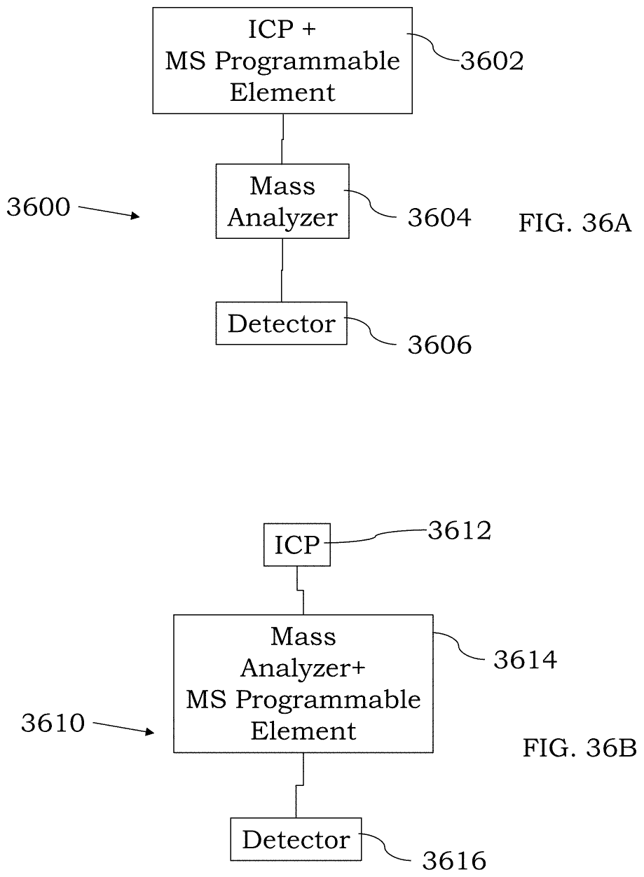

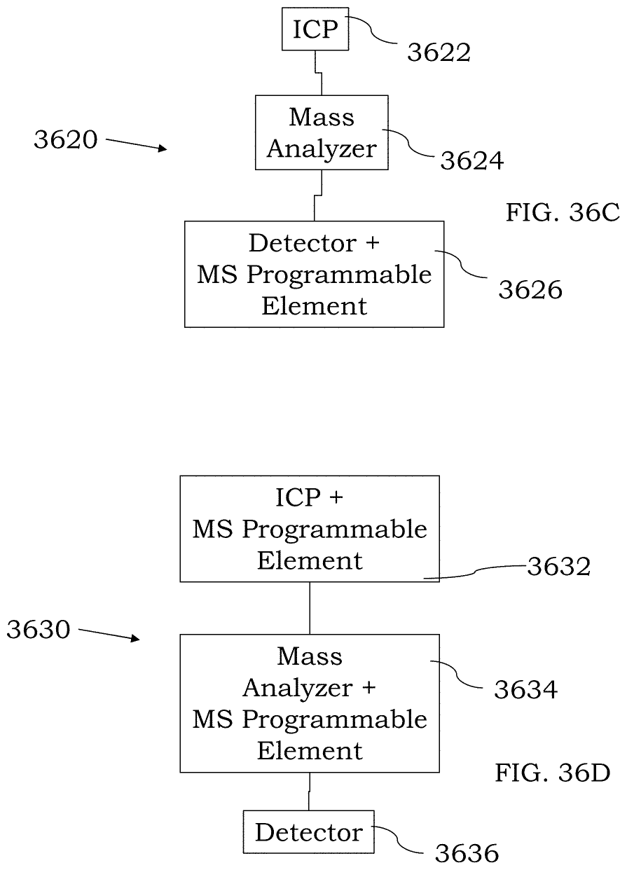

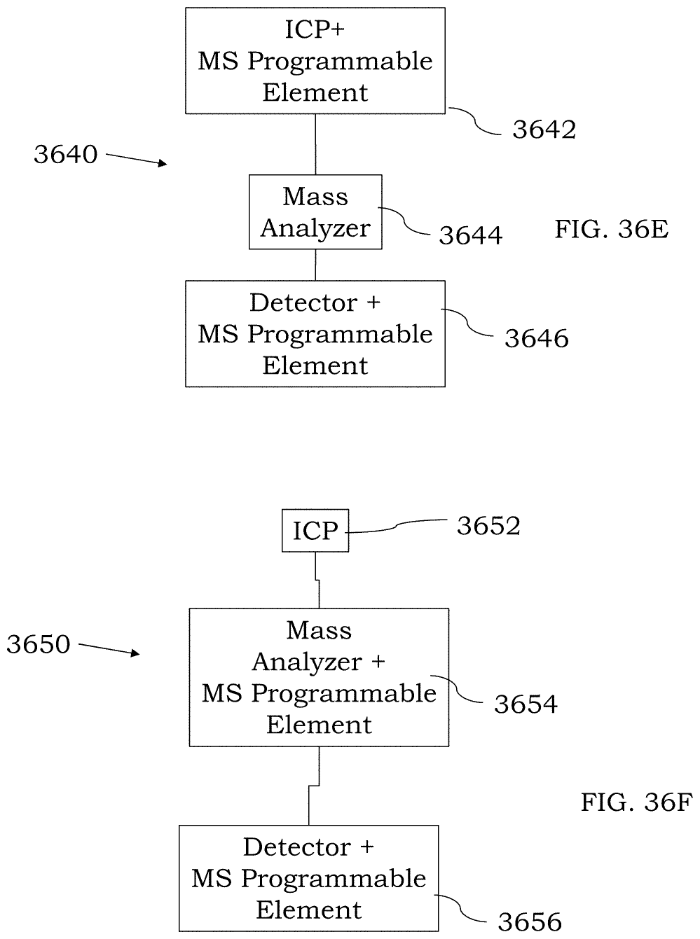

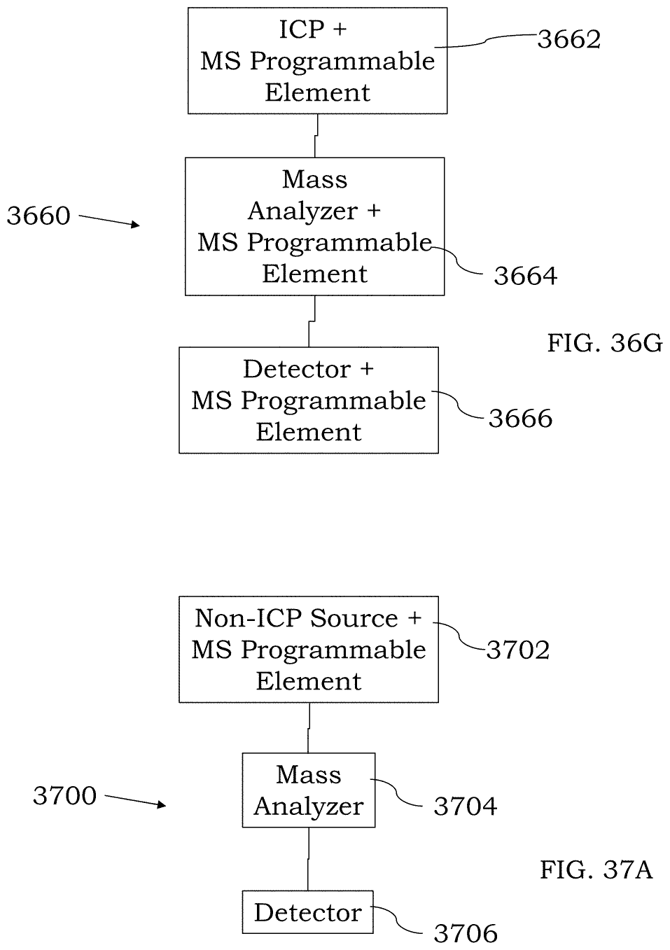

Referring to FIG. 36A, a system 3600 is shown that comprises an inductively coupled plasma ion source 3602 comprising a MS programmable element, a mass analyzer 3604 and a detector 3606. In an alternative configuration, a system 3610 may comprise an inductively coupled plasma ion source 3612, a mass analyzer 3614 comprising a MS programmable element and a detector 3616 (see FIG. 36B). In another configuration, a system 3620 may comprise an inductively coupled plasma ion source 3622, a mass analyzer 3624 and a detector 3626 comprising a MS programmable element (see FIG. 36C). In an additional configuration, a system 3630 may comprise an inductively coupled plasma ion source 3632 comprising a MS programmable element, a mass analyzer 3634 comprising a MS programmable element and a detector 3636 (see FIG. 36D). In another configuration, a system 3640 may comprise an inductively coupled plasma ion source 3642 comprising a MS programmable element, a mass analyzer 3644 and a detector 3646 comprising a MS programmable element (see FIG. 36E). In another configuration, a system 3650 may comprise an inductively coupled plasma ion source 3652, a mass analyzer 3654 comprising a MS programmable element and a detector 3656 comprising a MS programmable element (see FIG. 36F). In additional configurations a system 3660 may comprise an inductively coupled plasma ion source 3662 comprising a MS programmable element, a mass analyzer 3664 comprising a MS programmable element and a detector 3666 comprising a MS programmable element (see FIG. 36G).

In certain examples, the MS programmable element of the ICP sources shown in FIGS. 36A-36G may be present on an induction device, a torch or other components of the ICP source. While not shown in FIGS. 36A-36G, sample introduction devices, interfaces, ion optics, ion guides, collision cells, collision reaction cells and other components may be present between any one or more of the components shown in FIGS. 36A-36G or within these components. In some examples, the mass analyzer of FIGS. 36A-36G may be configured as one or more of a quadrupolar mass analyzer, a tandem quadrupole mass analyzer, a triple quadrupole mass analyzer, an ion trap, a scanning sector mass analyzer, a time of flight device or other suitable mass analyzers. The detector shown in FIGS. 36A-36G may take many forms including an electron multiplier, a multi-channel plate, a Faraday cup, a solid state detector or other suitable detectors that can be used to detect ions.

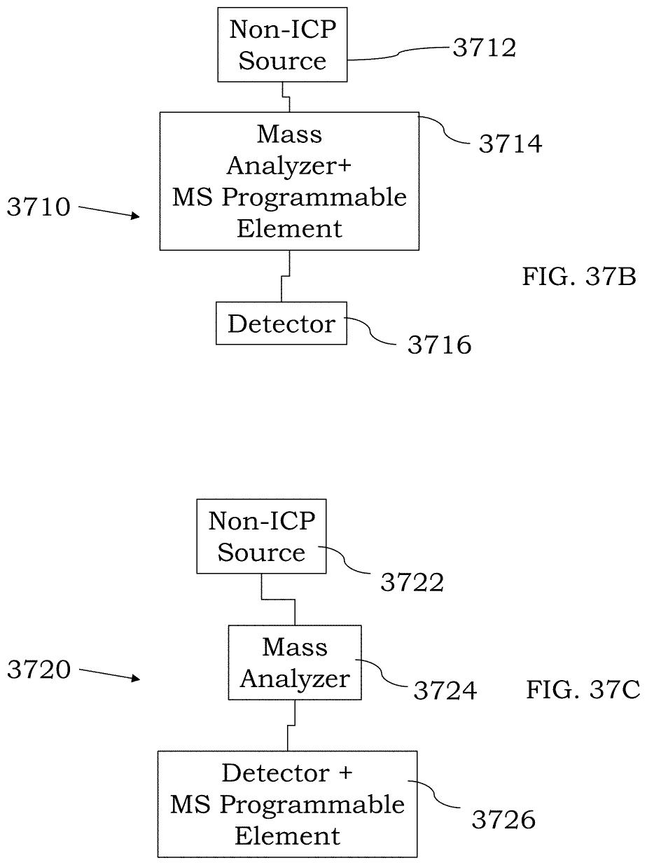

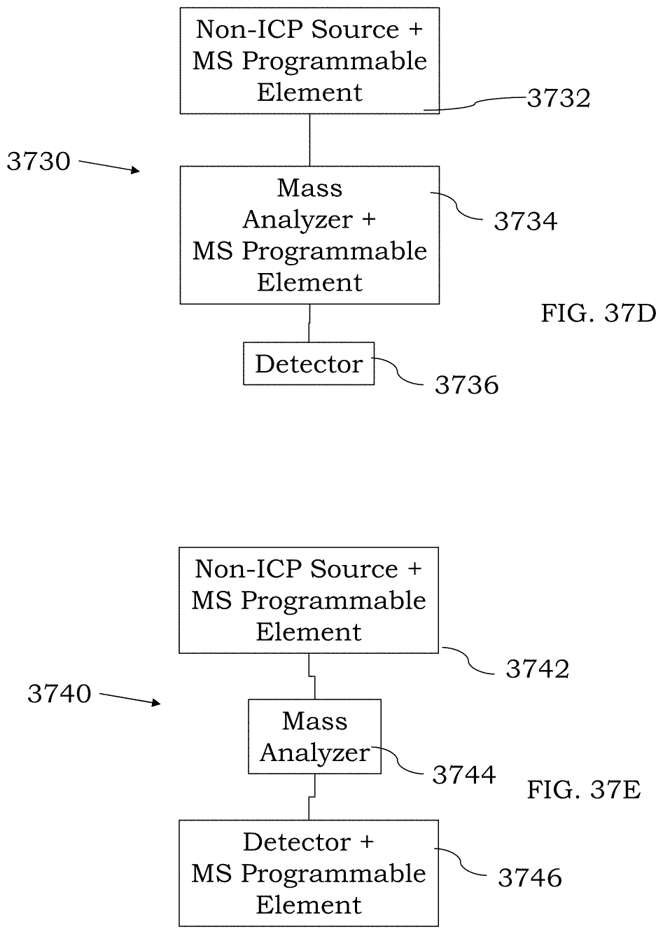

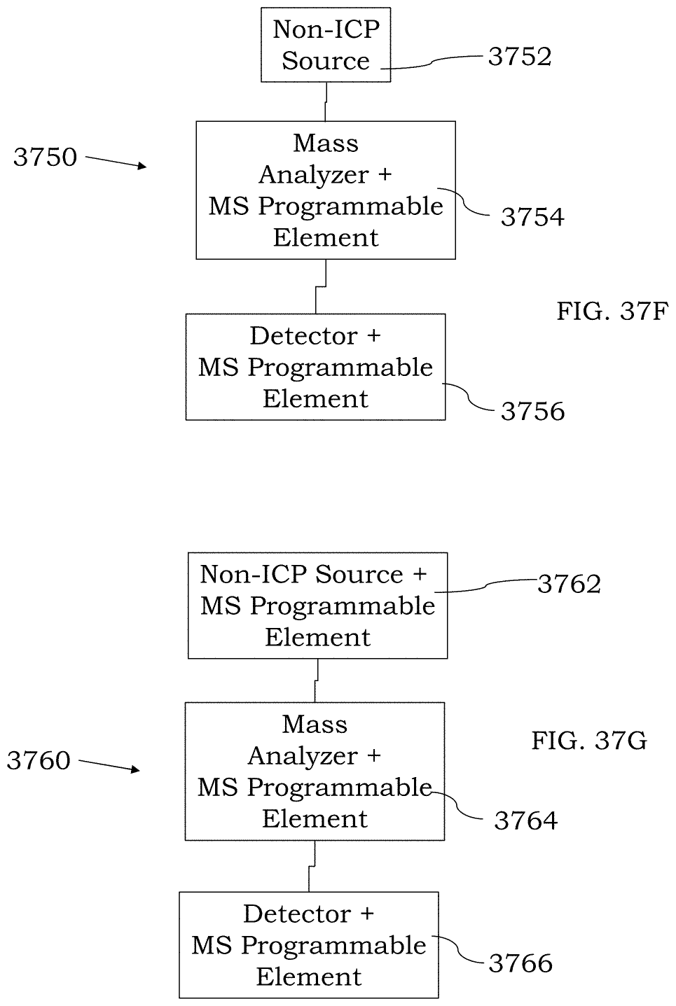

Various non-ICP instruments and systems can also be produced using the components described herein. Referring to FIG. 37A, a system 3700 is shown that comprises an ion source 3702 (other than an inductively coupled plasma ion source) comprising a MS programmable element 3702, a mass analyzer 3604 and a detector 3706. In an alternative configuration, a system 3710 may comprise an ion source 3712 (other than an inductively coupled plasma ion source) 3712, a mass analyzer 3714 comprising a MS programmable element and a detector 3716 (see FIG. 37B). In another configuration, a system 3720 may comprise an ion source 3722 (other than an inductively coupled plasma ion source), a mass analyzer 3724 and a detector 3726 comprising a MS programmable element (see FIG. 37C). In an additional configuration, a system 3730 may comprise an ion source 3732 (other than an inductively coupled plasma ion source) comprising a MS programmable element, a mass analyzer 3734 comprising a MS programmable element and a detector 3736 (see FIG. 37D). In another configuration, a system 3740 may comprise an ion source 3742 (other than an inductively coupled plasma ion source) comprising a MS programmable element, a mass analyzer 3744 and a detector 3746 comprising a MS programmable element (see FIG. 37E). In another configuration, a system 3750 may comprise an ion source 3532 (other than an inductively coupled plasma ion source), a mass analyzer 3754 comprising a MS programmable element and a detector 3756 comprising a MS programmable element (see FIG. 37F). In additional configurations a system 3760 may comprise an ion source 3762 (other than an inductively coupled plasma ion source) comprising a MS programmable element, a mass analyzer 3764 comprising a MS programmable element and a detector 3766 comprising a MS programmable element (see FIG. 37G).

In some embodiments, the MS programmable element of the non-ICP sources shown in FIGS. 37A-37G may be present on any surface of the non-ICP ion sources. Illustrative ion non-ICP sources that can be used in the systems shown in FIGS. 37A-37G include, but are not limited to, electron ionization sources, chemical ionization sources, photoionization sources, desorption ionization sources, spray ionization sources, thermal ionization sources and other non-ICP ion sources. While not shown in FIGS. 37A-37G, sample introduction devices, interfaces, ion optics, ion guides, collision cells, collision reaction cells and other components may be present between any one or more of the components shown in FIGS. 37A-37G or within these components. In some examples, the mass analyzer of FIGS. 37A-37G may be configured as one or more of a quadrupolar mass analyzer, a tandem quadrupole mass analyzer, a triple quadrupole mass analyzer, an ion trap, a scanning sector mass analyzer, a time of flight device or other suitable mass analyzers. The detector shown in FIGS. 37A-37G may take many forms including an electron multiplier, a multi-channel plate, a Faraday cup, a solid state detector or other suitable detectors that can be used to detect ions.

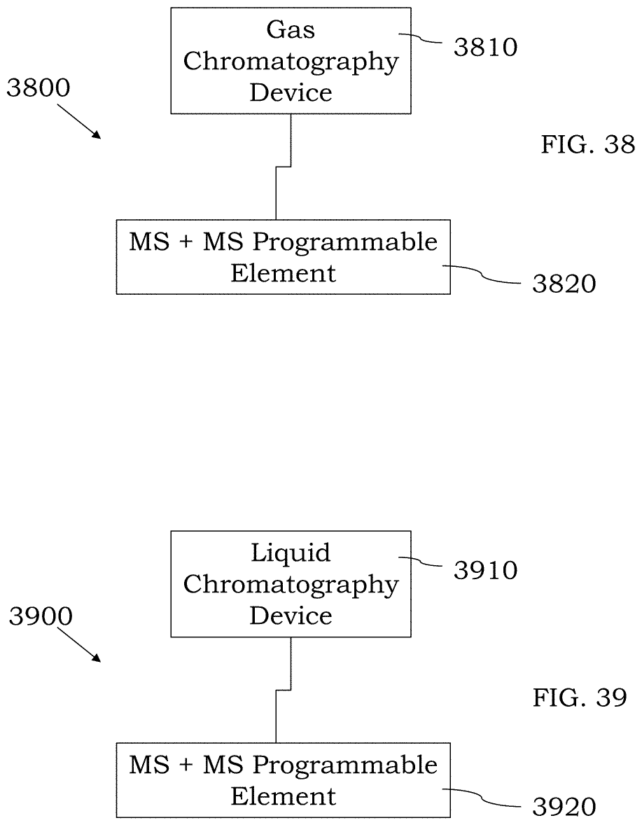

In certain embodiments, the systems described herein can be hyphenated or otherwise fluidically coupled in some manner to another system. Referring to FIG. 38, a gas chromatography (GC) device 3810 is shown coupled to a mass spectrometer 3820 comprising one or more MS programmable elements. In another configuration, a liquid chromatography (LC) device 3910 can be fluidically coupled to a mass spectrometer 3820 comprising one or more MS programmable elements (see FIG. 39). The GC and LC devices can take many forms including separation systems, cartridges, chips and the like.

While various mass spectrometer systems comprising a MS programmable element and mass spectrometer systems components comprising a MS programmable element are described above, additional components such as injectors, pumps, microprocessors, computer systems, controllers, control boards, housings and other electrical and mechanical components may also be present in the various systems and/or components described herein.

In certain embodiments, the MS programmable elements and other components of the mass spectrometer systems described herein can be controlled using one or more processors. In certain examples, the processor can be part of the system or instrument or present in an associated device, e.g., computer, laptop, mobile device, etc. used with the instrument. For example, the processor can be used to control the provided voltages to the MS programmable elements, poles, rods, etc., can control the mass analyzer and/or can be used by the detector. Such processes may be performed automatically by the processor without the need for user intervention or a user may enter parameters through a user interface. In certain configurations, the processor may be present in one or more computer systems and/or common hardware circuitry including, for example, a microprocessor and/or suitable software for operating the system, e.g., to control the MS programmable elements, sample introduction device, ion sources, mass analyzer, detector, etc. In some examples, any one of the stages of the system may comprise its own respective processor, operating system and other elements to permit detection of various analytes. The processor can be integral to the systems or may be present on one or more accessory boards, printed circuit boards or computers electrically coupled to the components of the system. The processor is typically electrically coupled to one or more memory units to receive data from the other components of the system and permit adjustment of the various system parameters as needed or desired. The processor may be part of a general-purpose computer such as those based on Unix, Intel PENTIUM-type processor, Motorola PowerPC, Sun UltraSPARC, Hewlett-Packard PA-RISC processors, or any other type of processor. One or more of any type computer system may be used according to various embodiments of the technology. Further, the system may be connected to a single computer or may be distributed among a plurality of computers attached by a communications network. It should be appreciated that other functions, including network communication, can be performed and the technology is not limited to having any particular function or set of functions. Various aspects may be implemented as specialized software executing in a general-purpose computer system. The computer system may include a processor connected to one or more memory devices, such as a disk drive, memory, or other device for storing data. Memory is typically used for storing MS programmable element parameters, programs, calibration curves, analyte peaks, and data values during operation of the systems. Components of the computer system may be coupled by an interconnection device, which may include one or more buses (e.g., between components that are integrated within a same machine) and/or a network (e.g., between components that reside on separate discrete machines). The interconnection device provides for communications (e.g., signals, data, instructions) to be exchanged between components of the system. The computer system typically can receive and/or issue commands within a processing time, e.g., a few milliseconds, a few microseconds or less, to permit rapid control of the system. For example, computer control can be implemented to control sample introduction, MSPE voltages, voltages provided to components of the mass analyzer, detector parameters, etc. The processor typically is electrically coupled to a power source which can, for example, be a direct current source, an alternating current source, a battery, a fuel cell or other power sources or combinations of power sources. The power source can be shared by the other components of the system or various components may comprise their own respective ion source. The system may also include one or more input devices, for example, a keyboard, mouse, trackball, microphone, touch screen, manual switch (e.g., override switch) and one or more output devices, for example, a printing device, display screen, speaker. In addition, the system may contain one or more communication interfaces that connect the computer system to a communication network (in addition or as an alternative to the interconnection device). The system may also include suitable circuitry to convert signals received from the various electrical devices present in the systems. Such circuitry can be present on a printed circuit board or may be present on a separate board or device that is electrically coupled to the printed circuit board through a suitable interface, e.g., a serial ATA interface, ISA interface, PCI interface or the like or through one or more wireless interfaces, e.g., Bluetooth, Wi-Fi, Near Field Communication or other wireless protocols and/or interfaces.

In certain embodiments, the storage system used in the systems described herein typically includes a computer readable and writeable nonvolatile recording medium in which codes of software can be stored that can be used by a program to be executed by the processor or information stored on or in the medium to be processed by the program. The medium may, for example, be a hard disk, solid state drive or flash memory. The program or instructions to be executed by the processor may be located locally or remotely and can be retrieved by the processor by way of an interconnection mechanism, a communication network or other means as desired. Typically, in operation, the processor causes data to be read from the nonvolatile recording medium into another memory that allows for faster access to the information by the processor than does the medium. This memory is typically a volatile, random access memory such as a dynamic random access memory (DRAM) or static memory (SRAM). It may be located in the storage system or in the memory system. The processor generally manipulates the data within the integrated circuit memory and then copies the data to the medium after processing is completed. A variety of mechanisms are known for managing data movement between the medium and the integrated circuit memory element and the technology is not limited thereto. The technology is also not limited to a particular memory system or storage system. In certain embodiments, the system may also include specially-programmed, special-purpose hardware, for example, an application-specific integrated circuit (ASIC) or a field programmable gate array (FPGA). Aspects of the technology may be implemented in software, hardware or firmware, or any combination thereof. Further, such methods, acts, systems, system elements and components thereof may be implemented as part of the systems described above or as an independent component. Although specific systems are described by way of example as one type of system upon which various aspects of the technology may be practiced, it should be appreciated that aspects are not limited to being implemented on the described system. Various aspects may be practiced on one or more systems having a different architecture or components. The system may comprise a general-purpose computer system that is programmable using a high-level computer programming language. The systems may be also implemented using specially programmed, special purpose hardware.

In the systems, the processor is typically a commercially available processor such as the well-known Pentium class processors available from the Intel Corporation. Many other processors are also commercially available. Such a processor usually executes an operating system which may be, for example, the Windows 95, Windows 98, Windows NT, Windows 2000 (Windows ME), Windows XP, Windows Vista, Windows 7, Windows 8 or Windows 10 operating systems available from the Microsoft Corporation, MAC OS X, e.g., Snow Leopard, Lion, Mountain Lion or other versions available from Apple, the Solaris operating system available from Sun Microsystems, or UNIX or Linux operating systems available from various sources. Many other operating systems may be used, and in certain embodiments a simple set of commands or instructions may function as the operating system. Further, the processor can be designed as a quantum processor designed to perform one or more functions using one or more qubits.

In certain examples, the processor and operating system may together define a platform for which application programs in high-level programming languages may be written. It should be understood that the technology is not limited to a particular system platform, processor, operating system, or network. Also, it should be apparent to those skilled in the art, given the benefit of this disclosure, that the present technology is not limited to a specific programming language or computer system. Further, it should be appreciated that other appropriate programming languages and other appropriate systems could also be used. In certain examples, the hardware or software can be configured to implement cognitive architecture, neural networks or other suitable implementations. If desired, one or more portions of the computer system may be distributed across one or more computer systems coupled to a communications network. These computer systems also may be general-purpose computer systems. For example, various aspects may be distributed among one or more computer systems configured to provide a service (e.g., servers) to one or more client computers, or to perform an overall task as part of a distributed system. Various aspects may be performed on a client-server or multi-tier system that includes components distributed among one or more server systems that perform various functions according to various embodiments. These components may be executable, intermediate (e.g., IL) or interpreted (e.g., Java) code which communicate over a communication network (e.g., the Internet) using a communication protocol (e.g., TCP/IP). It should also be appreciated that the technology is not limited to executing on any particular system or group of systems. Also, it should be appreciated that the technology is not limited to any particular distributed architecture, network, or communication protocol.

In some instances, various embodiments may be programmed using an object-oriented programming language, such as, for example, SQL, SmallTalk, Basic, Java, Javascript, PHP, C++, Ada, Python, iOS/Swift, Ruby on Rails or C# (C-Sharp). Other object-oriented programming languages may also be used. Alternatively, functional, scripting, and/or logical programming languages may be used. Various configurations may be implemented in a non-programmed environment (e.g., documents created in HTML, XML or other format that, when viewed in a window of a browser program, render aspects of a graphical-user interface (GUI) or perform other functions). Certain configurations may be implemented as programmed or non-programmed elements, or any combination thereof. In some instances, the systems may comprise a remote interface such as those present on a mobile device, tablet, laptop computer or other portable devices which can communicate through a wired or wireless interface and permit operation of the systems remotely as desired.

In certain examples, the processor may also comprise or have access to a database of information about molecules, their fragmentation patterns, and the like, which can include molecular weights, mass-to-charge ratios and other common information. The instructions stored in the memory can execute a software module or control routine for the system, which in effect can provide a controllable model of the system. The processor can use information accessed from the database together with one or software modules executed in the processor to determine control parameters or values for different components of the systems, e.g., different MSPE voltages, different mass analyzer parameters, etc. Using input interfaces to receive control instructions and output interfaces linked to different system components in the system, the processor can perform active control over the system. For example, the processor can control the detector, sample introduction devices, ionization sources, electrodes, mass analyzer, MSPE's and other components of the system.

Certain specific examples are described to illustrate better some of the aspects and features of the technology described herein.

### Example 1

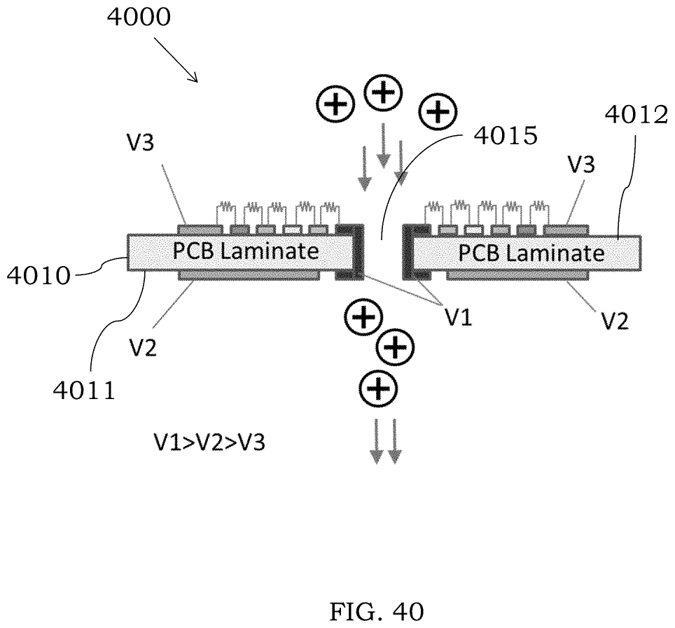

Referring to FIG. 40, a lens comprising programmable elements is shown. The lens 4000 is configured as a printed circuit board laminate 4010 with an aperture 4015. A plurality of MS programmable elements, each configured as electrodes, can be disposed on one or more surfaces of the laminate 4010 and electrically coupled to a power source, e.g., a common power source or each electrode could electrically couple to its own power source. In one configuration, the electrodes adjacent to the aperture 4015 can be electrically coupled to a first power source (to provide a voltage V1), the electrode(s) on a surface 4011 can be electrically coupled to a second power source (to provide a voltage V2), and the electrodes on a surface 4012 can be electrically coupled to a third power source (to provide a voltage V3). Alternatively a resistor network may be present between the various electrodes so a common power source can be used but different voltages are provided to different electrodes on different surfaces. In some examples, resistors can be present and electrically coupled to adjacent electrodes to provide different voltages to different electrodes and provide a customized surface potential to act like a “bullseye” to focus and confine the ions. In this illustration, when the inner ring voltage V1 is biased with a more positive voltage, the +Ve electric field provided from these inner ring electrodes can act to push or guide the ion beam towards the center aperture opening 4015. This directing by the provided electric field can also act to reduce beam divergence or focus the beam to a more narrow diameter. Potential wells can be different between input side and output side of the lens. The various individual electrodes can be driven with RF signals and/or DC signals if they are shaped as planar quadrupoles, hexapoles, or octopoles.

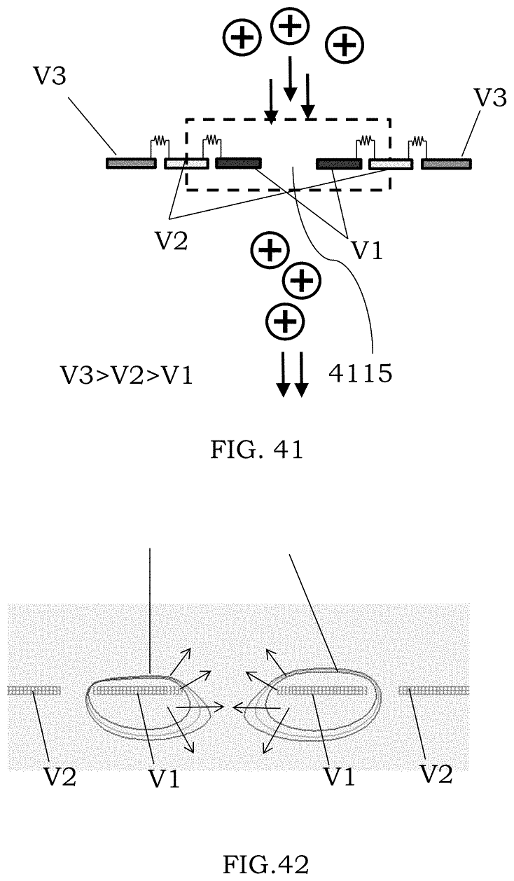

A pictorial representation of the various electric fields that can be produced for one particular voltage configuration of a device illustrated in FIG. 41 is shown in FIG. 42. Depending on the exact difference in the voltages V2 and V1 in FIG. 42, the produced electric field can act to push the ions toward the center of the opening 4115 or away from the center of the opening 4115. This pushing can reduce beam divergence or increase beam divergence depending on the particular voltages that are applied to the various electrodes.

### Example 2

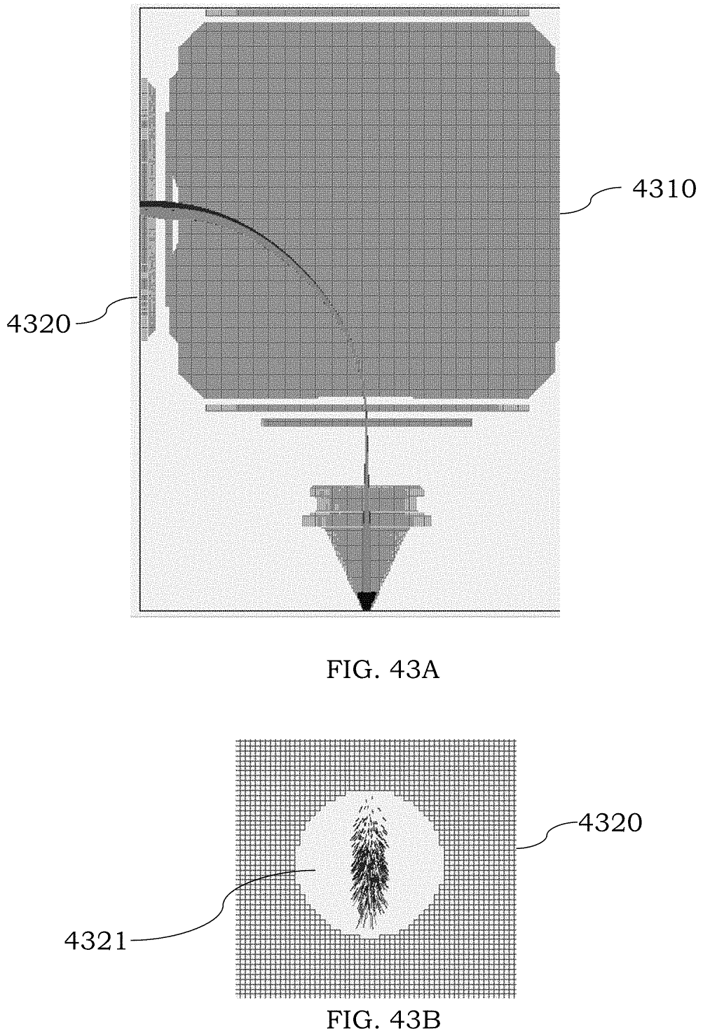

Referring to FIGS. 43A and 43B, a simulation is shown where an ion beam enters into a conventional quadrupole deflector 4310 with a lens 4320 positioned at an entrance of the quadrupole deflector. The quadrupole deflector 4310 is configured to guide the beam in an orthogonal direction from an entry angle. The entering ion beam is relatively wide, which causes a portion of the beam to be blocked by the lens 4320 before it can even enter into the quadrupole deflector. To overcome this issue, the opening of the lens could be widened, but widening of the opening 4321 of the metal lens 4320 will not help to increase sensitivity, because the ions will need to enter the quadrupole mass analyzer, which has a smaller aperture opening diameter than the metal lens.

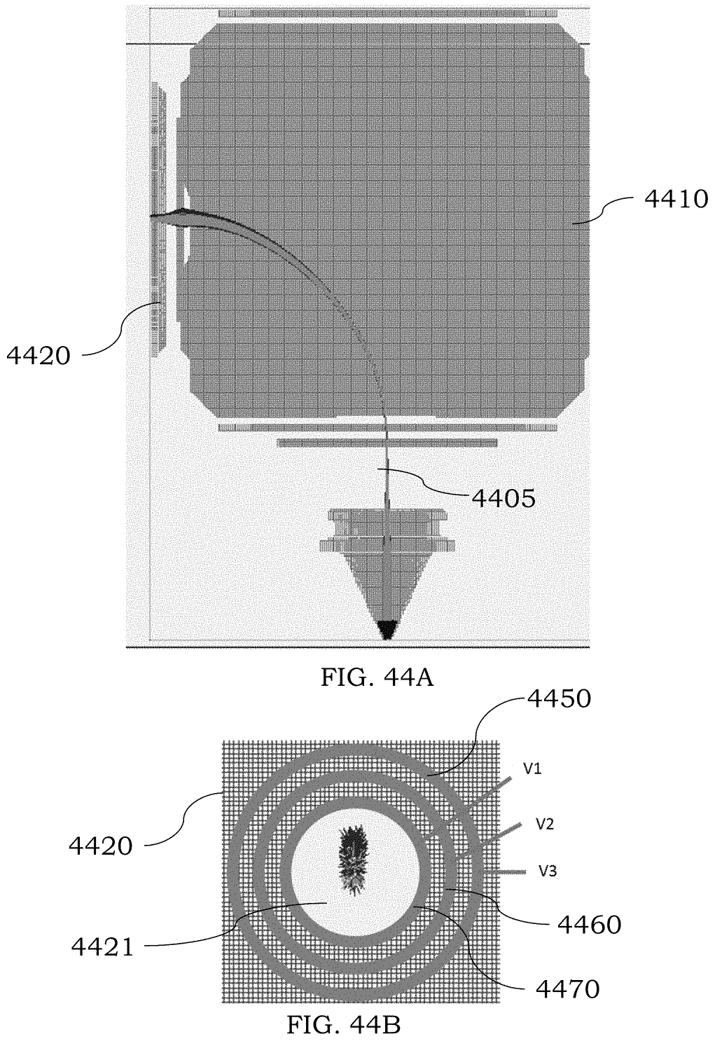

Referring now to FIGS. 44A and 44B, a second configuration is shown where the lens comprises three ring electrodes 4450, 4460, 4470 disposed on a surface of the lens 4420. In this configuration a voltage V1 provided to the inner ring electrode 4470 can be greater than a voltage V2 provided to the ring electrode 4460. The voltage V2 can be greater than a voltage V3 provided to the outer ring electrode 4450. A positive voltage can be provided as V1, and a negative voltage can be provided as V2 to provide an electric field within the space 4421 of the lens 4420. The relative positive voltage V1 and negative voltage V2 can provide an electric field that aims positive ions toward the aperture opening 4421. The less divergent beam can improve signal intensity and overall sensitivity.

### Example 3

Several experiments were performed using a conventional lens as shown in FIG. 43B and a lens comprising ring electrodes similar to the one shown in FIG. 44B to measure the sensitivity of several elements. The instrument used was a triple quadrupole ICP-MS.

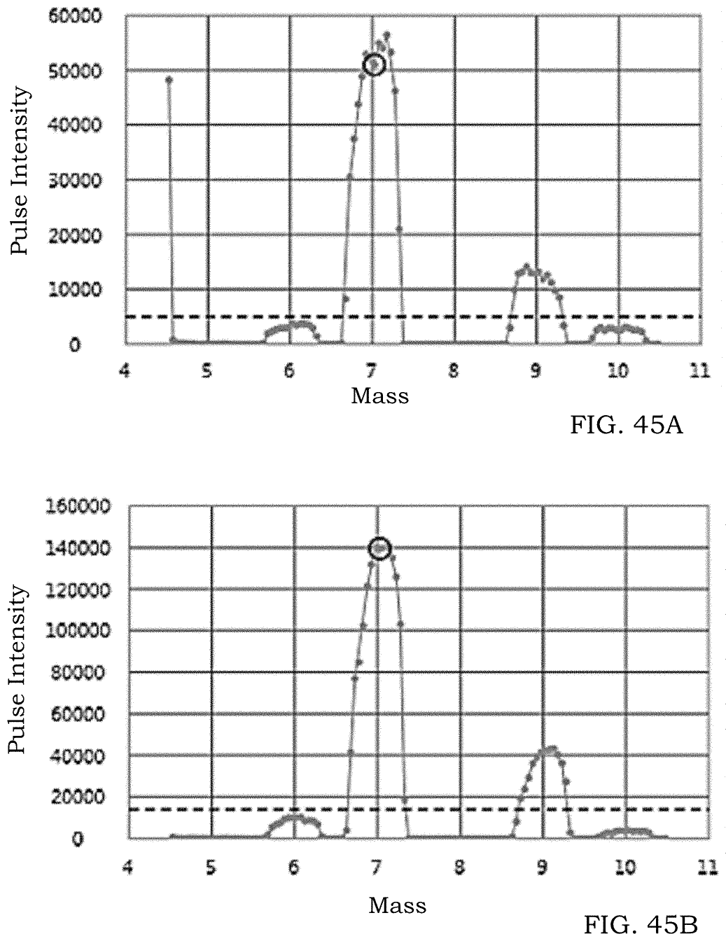

FIGS. 45A and 45B show the results for a 1 ppb solution of lithium (amu=˜7) with the conventional lens (FIG. 45A) and the ring electrode lens (FIG. 45B).

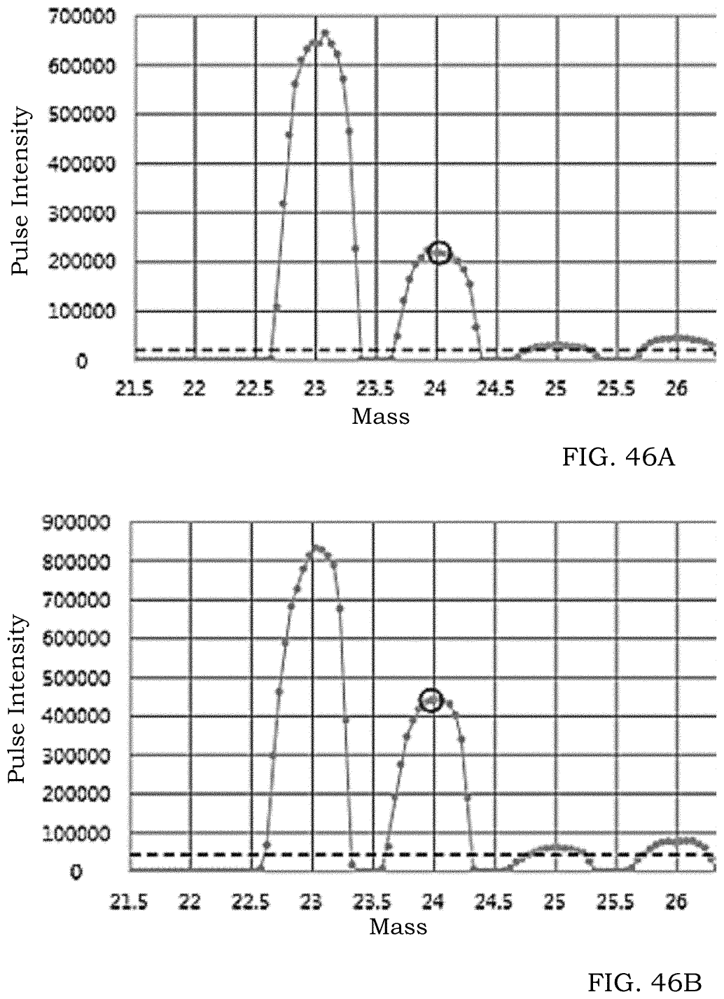

FIGS. 46A and 46B show the results for a 1 ppb solution of magnesium (amu=˜24) with the conventional lens (FIG. 46A) and the ring electrode lens (FIG. 46B).

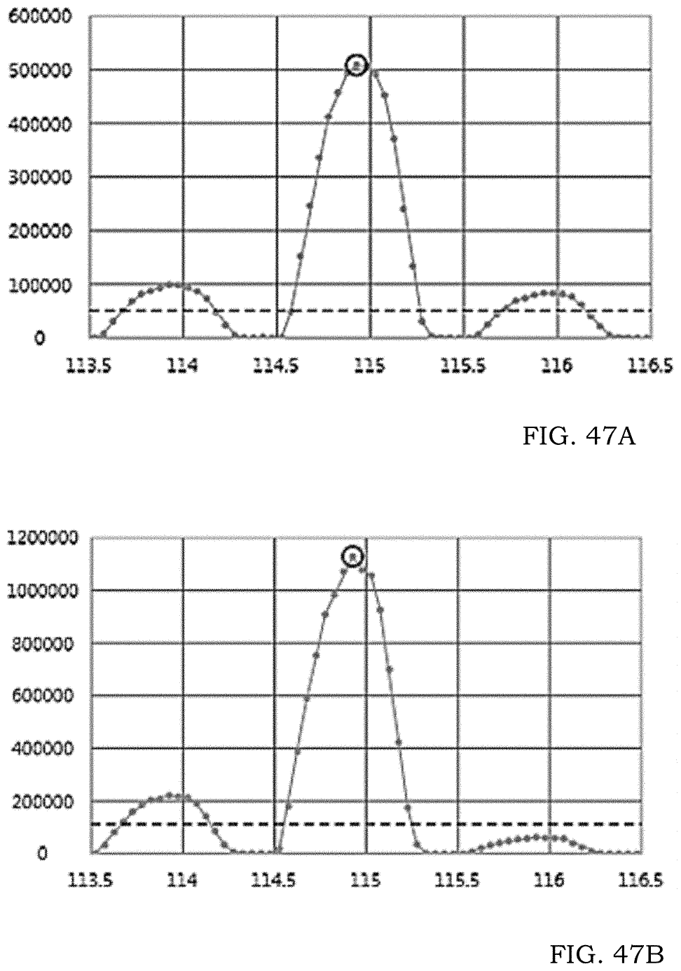

FIGS. 47A and 47B shows the results for a 1 ppb solution of indium (amu=˜115) with the conventional lens (FIG. 47A) and the ring electrode lens (FIG. 47B).

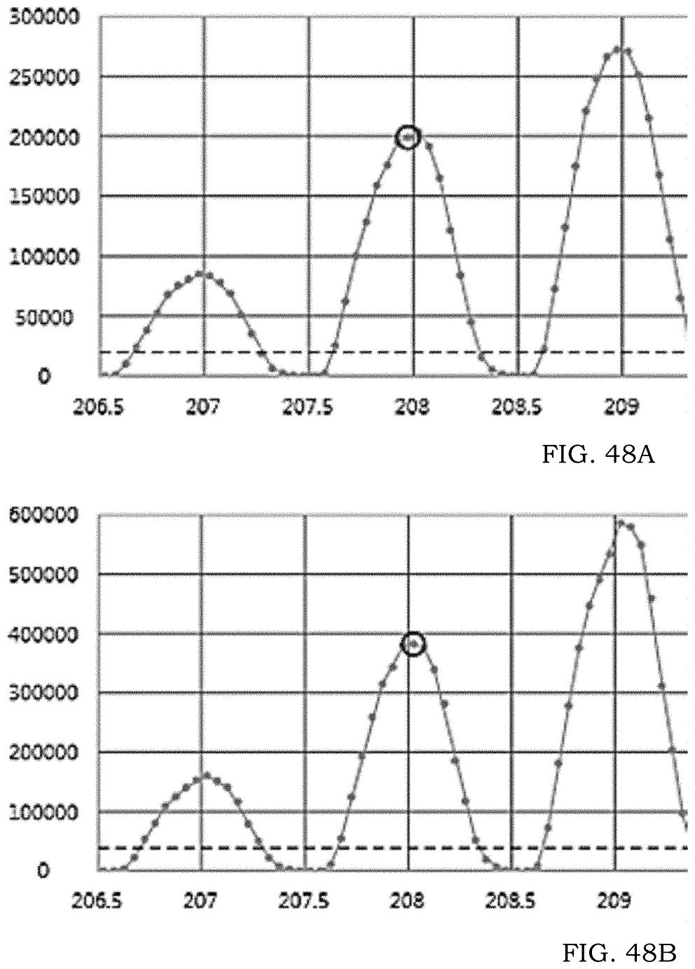

FIGS. 48A and 48B shows the results for a 1 ppb solution of lead (amu=˜208) with the conventional lens (FIG. 48A) and the ring electrode lens (FIG. 48B).

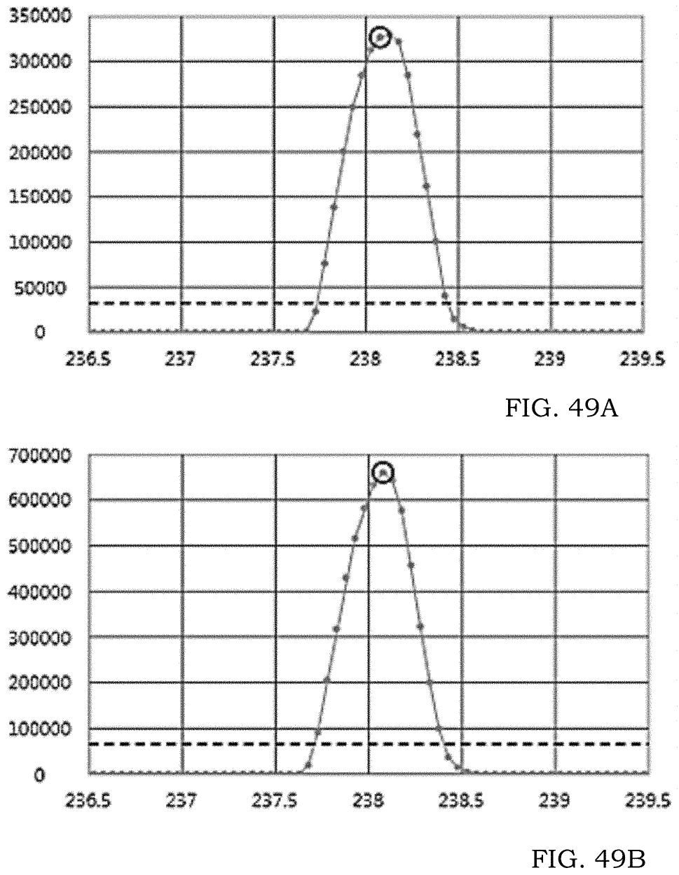

FIGS. 49A and 49B shows the results for uranium (amu=˜238) with the conventional lens (FIG. 49A) and the ring electrode lens (FIG. 49B).

As can be seen in each of FIGS. 45A-49B, the presence of MS programmable elements on the lens increased the sensitivity for each of the measured elements.

### Example 4

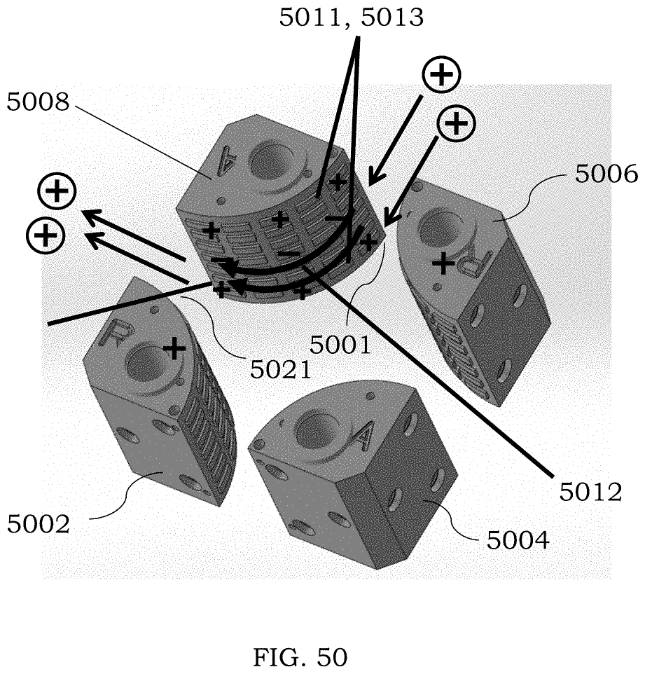

A quadrupole ion deflector can be produced that comprises one or more MS programmable elements. Referring to FIG. 50, poles 5002, 5004, 5006 and 5008 are each shown as comprising a plurality of MS programmable elements (grouped as elements 5011, 5012, 5013 and each configured as an electrode) disposed on their inner surfaces in an array pattern. MSPE's in the group 5011 are generally arranged in the same radial plane of the pole 5008. Similarly, the MSPE's grouped as 5012 are arranged in a similar radial plane, and the MSPE's grouped as 5013 are arranged in a similar radial plane. The MSPE's grouped as 5012 are positioned between the radial planes where MSPE's 5011, 5013 are positioned. In this example, the outer MS programmable elements 5011, 5013 are more positive than the inner MS programmable elements 5012. The inner programmable elements 5012 can form a potential well to confine the ion beam (or certain ions therein). The MS programmable elements closer to the ion exit 5021 may comprise more negative voltages compared to a voltage of the MS programmable elements near an entrance 5001. This configuration permits shaping of the ion beam by the ion deflector. Each of the poles 5002, 5004, 5006 and 5008 may be conductive or non-conductive and/or may comprise an insulating material between the poles and the MS programmable elements (where the poles 5002, 5004, 5006 and 5008 are conductive) to electrically decouple the poles from the MS programmable elements.

### Example 5

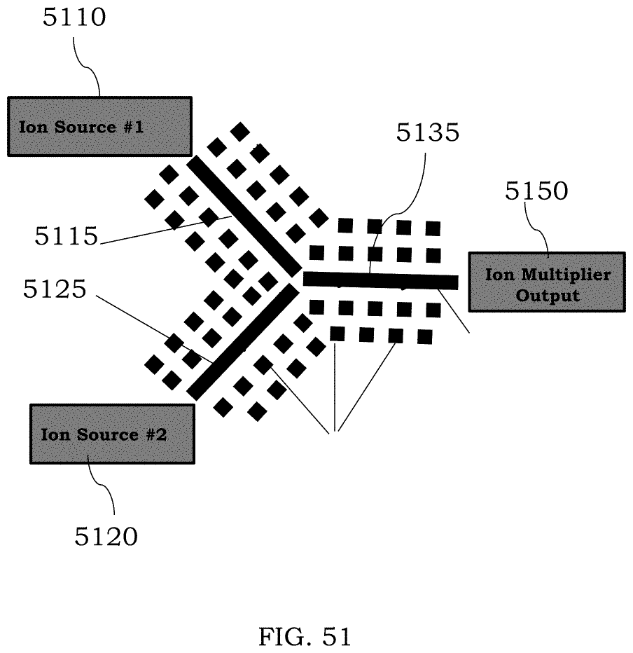

An ion multiplexer can be produced that comprises one or more MS programmable elements. Referring to FIG. 51, a compact planar ion multiplexer can be produced that comprises a planar dipole ion guide similar to the one shown in FIG. 25E. The multiplexer may comprise a first ion guide 5115 and a second ion guide 5125. The first ion guide 5115 can be fluidically coupled to a first ion source 5110, and the second ion guide 5025 can be fluidically coupled to a second ion source 5120. A third ion guide 5135 can be fluidically coupled to each of the guides 5115, 5125, and the ion guides 5115, 5125, and 5135 can together be used to select different ions from the different ion sources 5110, 5120 and provide the selected ions to an output 5150, e.g., to a mass analyzer, detector, etc. Different ions from the different sources 5110, 5120 can be selected and provided as the output 5150.

### Example 6

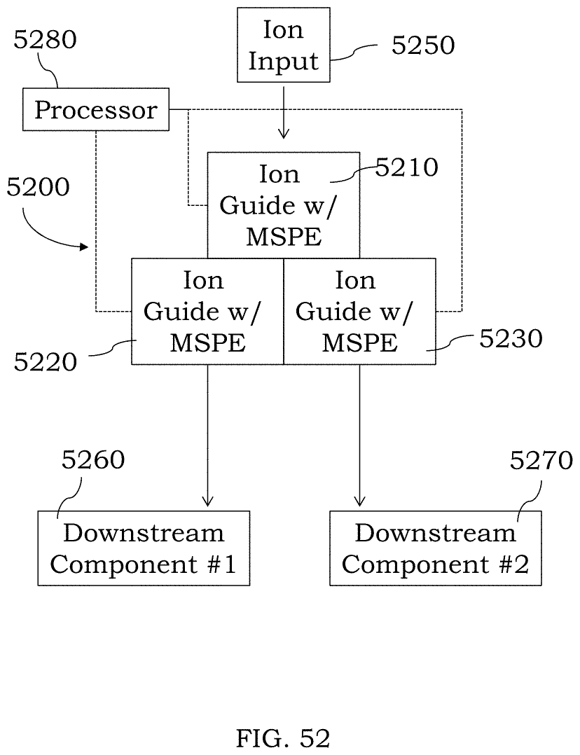

An illustration is shown in FIG. 52 of an ion switch comprising a plurality of ion guides. The switch 5200 comprises a first ion guide 5210 comprising a plurality of MSPE's, a second ion guide 5220 comprising a plurality of MSPE's, and a third ion guide comprising a plurality of MSPE's. The switch 5200 is fluidically coupled to an ion input 5250, and may output ions received from the ion input 5250 to one or more downstream components 5260, 5270. In some examples, each of the downstream components 5260, 5270 can be a mass analyzer, which may be the same or may be different. In other examples, each of the downstream components 5260, 5270 can be a detector which can be the same or can be different. In some configurations, one of the downstream components 5260, 5270 can be a time of flight device, and the other of the downstream components 5260, 5270 can be a mass analyzer, a detector or a time of flight device. Other combinations of downstream components are also possible. A processor 5280 can be electrically coupled to the ion guides 5210, 5220, 5230 (and optionally other components) to control the trapping and/or release of ions as desired.

### Example 7

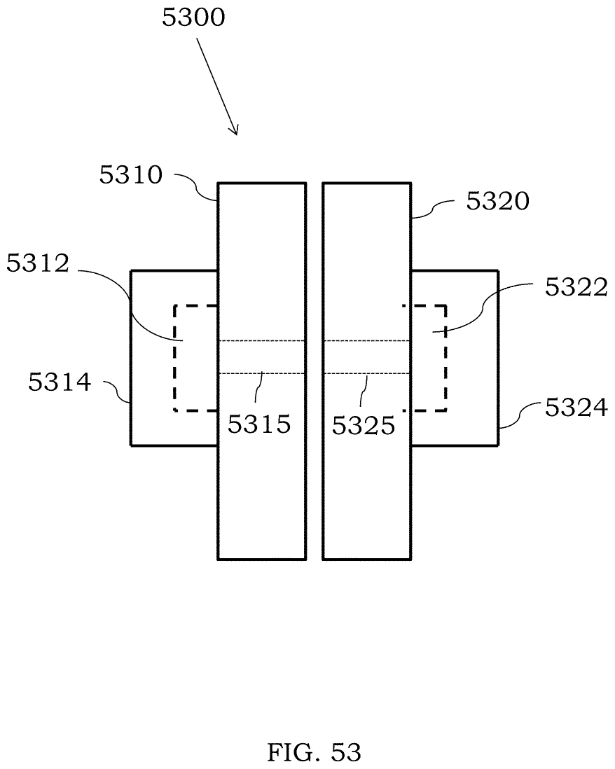

An illustration of a lens stack 5300 is shown in FIG. 53 and comprises a first lens 5310 and a second lens 5320. The first lens 5310 comprises MSPE's 5312, 5314 each arranged as a ring electrode, and the second lens 5320 comprises MSPE's 5322, 5324 each arranged as a ring electrode. The ring electrodes 5312, 5322 are shown as being positioned within the ring electrodes 5314, 5324, respectively, since the electrodes 5314, 5324 are taller than the electrodes 5312, 5322. The lens 5310 can act to pull ions toward a central aperture 5315 of the lens 5310 and provides the ions to a central aperture 5325 of the lens 5320. Voltages can be provided to the MSPE's 5312, 5314 to pull ions toward a center portion of the aperture 5315. Voltages can be provided to the MSPE's 5322, 5324 to maintain the ions in a narrower beam or can be used to promote divergence or spreading of the ion beam exiting the central aperture 5325. If desired, three, four or more lenses can be present in a lens stack. While the MSPE's 5312, 5314 and the MSPE's 5322, 5324 generally face away from each other, they could be facing toward each other if desired.

In a different configuration using the lens stack 5300, the lens 53100 can be used to provide an “electric fence” to stack ions up along the lens 5310 before permitting them to enter into the aperture 5315. This effect can permit concentration of ions using the electrodes 5312, 5314 of the lens before permitting passage of the ions into the aperture 5315.

### Example 8

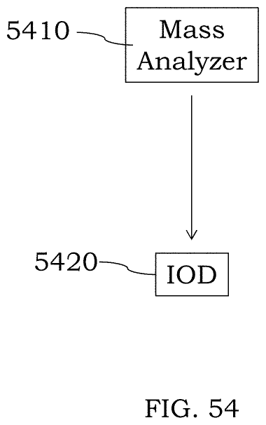

An “ion-on-demand” (IOD) system can be produced using the MSPE's described herein. In one configuration of an IOD, a dipole ion trap can be used to hold ions of a particular type until they are needed. One configuration is shown in FIG. 54 where an IOD system 5420 is positioned downstream of a fluidically coupled mass analyzer 5410. The mass analyzer 5410 can be used to select ions with a certain mass-to-charge ratio, and these selected ions can be provided to a dipole ion trap, comprising MSPE's, that is present in the IOD system 5420. The IOD system 5420 can store the ions until they are needed for a downstream operation, e.g., instrument calibration, ion implantation, etc. Ions can then be output from the IOD system by altering the voltages of the MSPE's to push the ions out of the dipole ion trap. Control of the IOD system is typically performed using a processor.

In other configurations of an IOD system, the IOD system could be positioned upstream of the mass analyzer 5410 to hold ions of a certain type or from a certain source until those ions need to be selected and/or analyzed using the mass analyzer 5410.

When introducing elements of the examples disclosed herein, the articles “a,” “an,” “the” and “said” are intended to mean that there are one or more of the elements. The terms “comprising,” “including” and “having” are intended to be open-ended and mean that there may be additional elements other than the listed elements. It will be recognized by the person of ordinary skill in the art, given the benefit of this disclosure, that various components of the examples can be interchanged or substituted with various components in other examples.

Although certain aspects, examples and embodiments have been described above, it will be recognized by the person of ordinary skill in the art, given the benefit of this disclosure, that additions, substitutions, modifications, and alterations of the disclosed illustrative aspects, examples and embodiments are possible.

1. A mass spectrometer component comprising a substrate and at least one programmable electrode disposed on the substrate, wherein the at least one programmable electrode is electrically decoupled from the substrate, and wherein the at least one programmable electrode is configured to provide an electric field within a space that is configured to receive an ion.

2. The mass spectrometer component of claim 1, wherein the substrate of the mass spectrometer component is configured as a skimmer cone and the skimmer cone comprises the at least one programmable electrode disposed on a surface of the skimmer cone.

3. The mass spectrometer component of claim 1, wherein the substrate of the mass spectrometer component is configured as a sampling cone and the sampling cone comprises the at least one programmable electrode disposed on a surface of the sampling cone.

4. The mass spectrometer component of claim 1, wherein the substrate of the mass spectrometer component is configured as one ion pole of an ion deflector and the one pole comprises the at least one programmable electrode disposed on a surface of the ion pole.

5. The mass spectrometer component of claim 1, wherein the substrate of the mass spectrometer component is configured as a lens and the lens comprises the at least one programmable electrode disposed on a surface of the lens.

6. The mass spectrometer component of claim 1, wherein the substrate of a mass spectrometer component is configured as a rod of a collision-reaction cell and the rod comprises the at least one programmable electrode disposed on a surface of the rod.

7. The mass spectrometer component of claim 1, wherein the substrate of the mass spectrometer component is configured as a mass analyzer comprising at least one rod set, wherein one rod of the at least one rod set comprises the at least one programmable electrode disposed on a surface of the one rod.

8. The mass spectrometer component of claim 1, wherein the substrate of the mass spectrometer component is configured as a lens of a time of flight analyzer and the lens comprises the at least one programmable electrode disposed of a surface of the lens.

9. The mass spectrometer component of claim 1, wherein the substrate of the mass spectrometer component is configured as an ion trap and the ion trap comprises the at least one programmable electrode disposed on a surface of the ion trap.

10. The mass spectrometer component of claim 1, wherein the substrate of the mass spectrometer component is configured as an induction device and the induction device comprises the at least one programmable electrode disposed on a surface of the induction device.

11. The mass spectrometer component of claim 1, wherein the substrate of the mass spectrometer component is configured as a torch and the torch comprises the at least one programmable electrode disposed on a surface of the torch.

12. The mass spectrometer component of claim 1, wherein the substrate of the mass spectrometer component is configured as an injector and the injector comprises the at least one programmable electrode disposed on an outer surface of the injector.

13. The mass spectrometer component of claim 1, wherein the substrate of the mass spectrometer component is configured as a nebulizer or a spray chamber, and the nebulizer or spray chamber comprises the at least one programmable electrode disposed on a surface of the nebulizer or the spray chamber.

14. The mass spectrometer component of claim 1, wherein the substrate of the mass spectrometer component is configured as a drift tube comprising the at least one programmable electrode disposed on a surface of a focusing ring of the drift tube.

15. The mass spectrometer component of claim 1, wherein the substrate of the mass spectrometer component is configured as a planar ion guide comprising the at least one programmable electrode.

16. The mass spectrometer component of claim 1, further comprising an additional programmable electrode disposed on the substrate and electrically decoupled from the substrate, wherein the at least one programmable electrode and the additional programmable electrode are together configured to provide an electric field within the space that is configured to receive the ion.

17. The mass spectrometer component of claim 16, wherein the substrate of the mass spectrometer component is configured as a skimmer, and the skimmer cone comprises the at least one programmable electrode and the additional programmable electrode each disposed on a surface of the skimmer cone.

18. The mass spectrometer component of claim 16, wherein the substrate of the mass spectrometer component is configured as a sampling cone, and the sampling cone comprises the at least one programmable electrode and the additional programmable electrode each disposed on a surface of the sampling cone.

19. The mass spectrometer component of claim 16, wherein the substrate of the mass spectrometer component is configured as one pole of an ion deflector, and the one pole comprises the at least one programmable electrode and the additional programmable electrode each disposed on a surface of the one pole.

20. The mass spectrometer component of claim 16, wherein the substrate of the mass spectrometer component is configured as a lens, and the lens comprises the at least one programmable electrode and the additional programmable electrode each disposed on a surface of the lens.

21.-203. (canceled)
